(19) United States
(12) Patent Application Publication
(10) Pub. No.: US 2012/0050578 A1
(43) Pub. Date: Mar. 1, 2012

(54) CAMERA BODY, IMAGING DEVICE, METHOD FOR CONTROLLING CAMERA BODY, PROGRAM, AND STORAGE MEDIUM STORING PROGRAM

(75) Inventors: Taizo AOKI, Hyogo (JP); Wataru OKAMOTO, Osaka (JP); Yuki UEDA, Osaka (JP); Ken ISHIDA, Osaka (JP)

(73) Assignee: Panasonic Corporation, Osaka (JP)

(21) Appl. No.: 13/088,425

(22) Filed: Apr. 18, 2011

(30) Foreign Application Priority Data
Aug. 31, 2010 (JP) 2010-195124
Sep. 17, 2010 (JP) 2010-209466

(51) Int. Cl. H04N 5/262; G03B 17/00

(52) U.S. Cl. 348/240.2; 396/529; 348/E05.055

(57) ABSTRACT

A camera body is provided that includes a body mount, an identification information acquisition section, a camera-side determination section, and a function restrictor. The body mount is configured to support an interchangeable lens unit. The identification information acquisition section is configured to acquire lens identification information from the interchangeable lens unit. The lens identification information indicates whether the interchangeable lens unit is compatible with three-dimensional imaging. The camera-side determination section is configured to determine whether the interchangeable lens unit is compatible with three-dimensional imaging based on the lens identification information acquired by the identification information acquisition section. The function restrictor is configured to restrict in three-dimensional imaging the use of one or more imaging functions used in two-dimensional imaging when the camera-side determination section has determined that the interchangeable lens unit is compatible with three-dimensional imaging.

### CROSS-REFERENCE TO RELATED APPLICATIONS

This application claims priority under 35 U.S.C. §119 to Japanese Patent Application No. 2010-195124, filed on Aug. 31, 2010, and Japanese Patent Application No. 2010-209466, filed on Sep. 17, 2010. The entire disclosures of Japanese Patent Applications No. 2010-195124 and No. 2010-209466 are hereby incorporated herein by reference.

### BACKGROUND

1. Technical Field

The technology disclosed herein relates to an imaging device and a camera body to which an interchangeable lens unit can be mounted. The technology disclosed herein also relates to a method for controlling a camera body, a program, and a storage medium for storing the program.

2. Background Information

An example of a known imaging device is an interchangeable lens type of digital camera. An interchangeable lens digital camera comprises an interchangeable lens unit and a camera body. This camera body has an imaging element such as a charge coupled device (CCD) image sensor or a complementary metal oxide semiconductor (CMOS) image sensor. The imaging element converts an optical image formed by the interchangeable lens unit into an image signal. This allows image data about a subject to be acquired.

Development of so-called three-dimensional displays has been underway for some years now. This has been accompanied by the development of digital cameras that produce what is known as stereo image data (image data for three-dimensional display use, including a left-eye image and a right-eye image).

However, a three-dimensional imaging-use optical system (hereinafter also referred to as a three-dimensional optical system) has to be used to produce a stereo image having parallax.

In view of this, development has been underway into an interchangeable lens unit equipped with a three-dimensional optical system. A three-dimensional optical system has, for example, a left-eye optical system and a right-eye optical system. A left-eye optical image is formed by the left-eye optical system and a right-eye optical image is formed by the right-eye optical system on the imaging element. The left- and right-eye optical images are disposed next to each other on the left and right on the imaging element, and a stereo image is produced on the basis of these two optical images (see, for example, Japanese Laid-Open Patent Application H7-274214).

However, since there is parallax between the left-eye image and the right-eye image included in the stereo image, if the image processing and display processing performed in two-dimensional imaging are also performed in three-dimensional imaging, the production of a suitable stereo image or obtaining a suitable 3D view may be hindered.

### SUMMARY

One object of the technology disclosed herein is to provide a camera body and an imaging device that are better suited to three-dimensional imaging.

In accordance with one aspect of the technology disclosed herein, a camera body is provided that includes a body mount, an identification information acquisition section, a camera-side determination section, and a function restrictor. The body mount is configured to support an interchangeable lens unit. The identification information acquisition section is configured to acquire lens identification information from the interchangeable lens unit. The lens identification information indicates whether the interchangeable lens unit is compatible with three-dimensional imaging. The camera-side determination section is configured to determine whether the interchangeable lens unit is compatible with three-dimensional imaging based on the lens identification information acquired by the identification information acquisition section. The function restrictor is configured to restrict in three-dimensional imaging the use of one or more imaging functions used in two-dimensional imaging when the camera-side determination section has determined that the interchangeable lens unit is compatible with three-dimensional imaging.

In accordance with another aspect of the technology disclosed herein, a program is provided that causes a camera body to perform the process of acquiring lens identification information from an interchangeable lens unit mounted to the camera body using an identification information acquisition section. The lens identification information indicates whether the interchangeable lens unit is compatible with three-dimensional imaging. The program also causes the camera body to perform the process of determining whether the interchangeable lens unit is compatible with three-dimensional imaging, using both a camera-side determination section and the lens identification information acquired by the identification information acquisition section. The program further causes the camera body to perform the process of restricting in three-dimensional imaging the use of one or more imaging functions used in two-dimensional imaging via a function restrictor when the camera-side determination section has determined that the interchangeable lens unit is compatible with three-dimensional imaging.

These and other objects, features, aspects and advantages of the technology disclosed herein will become apparent to those skilled in the art from the following detailed description, which, taken in conjunction with the annexed drawings, discloses embodiments of the present invention.

### BRIEF DESCRIPTION OF DRAWINGS

Referring now to the attached drawings which form a part of this original disclosure:

FIG. 1 is an oblique view of a digital camera 1 (first embodiment);

FIG. 2 is an oblique view of a camera body 100 (first embodiment);

FIG. 3 is a rear view of a camera body 100 (first embodiment);

FIG. 4 is a simplified block diagram of a digital camera 1 (first embodiment);

FIG. 5 is a simplified block diagram of an interchangeable lens unit 200 (first embodiment);

FIG. 6 is a simplified block diagram of a camera body 100 (first embodiment);

FIG. 7A is an example of the configuration of lens identification information F1, FIG. 7B is an example of the configuration of lens characteristic information F2, and FIG. 7C is an example of the configuration of lens state information F3;

FIG. 8A is a time chart for a camera body and an interchangeable lens unit when the camera body is not compatible with three-dimensional imaging, and FIG. 8B is a time chart for a camera body and an interchangeable lens unit when the camera body and interchangeable lens unit are compatible with three-dimensional imaging;

FIG. 9 is a diagram illustrating various parameters (first embodiment);

FIG. 10 is a diagram illustrating various parameters (first embodiment);

FIG. 11A is a diagram of the configuration of first menu information, and FIG. 11B is a diagram of the configuration of second menu information;

FIG. 12A is an example of a menu screen for two-dimensional imaging, and FIG. 12B is an example of a menu screen for three-dimensional imaging;

FIG. 13A is an example of a menu screen for two-dimensional imaging, and FIG. 13B is an example of a menu screen for three-dimensional imaging;

FIG. 14A is a diagram illustrating ordinary imaging, and FIG. 14B is a diagram illustrating a digital zoom function;

FIG. 15A is a diagram illustrating a tele conversion function, and FIG. 15B is a diagram illustrating a tele conversion function;

FIG. 16 is a flowchart of when the power is on (first embodiment);

FIG. 17 is a flowchart of when the power is on (first embodiment);

FIG. 18 is a flowchart of menu screen switching (first embodiment);

FIG. 19 is a flowchart of two-dimensional imaging (first embodiment);

FIG. 20 is a flowchart of three-dimensional imaging (first embodiment);

FIG. 21A is an example of a menu screen for two-dimensional imaging, and FIG. 21B is an example of a menu screen for three-dimensional imaging;

FIG. 22A is an example of a menu screen for two-dimensional imaging, and FIG. 22B is an example of a menu screen for three-dimensional imaging;

FIG. 23 is a rear view of a camera body 400 (second embodiment);

FIG. 24 is a simplified block diagram of a digital camera 1 (second embodiment);

FIG. 25 is a simplified block diagram of a camera body 400 (second embodiment);

FIG. 26A is a diagram of the configuration of first sequential capture menu information, and FIG. 26B is a diagram of the configuration of second sequential capture menu information;

FIG. 27A is a diagram of the configuration of first bracket menu information, and FIG. 27B is a diagram of the configuration of second bracket menu information;

FIG. 28A is an example of a menu screen for sequential capture mode in two-dimensional imaging, and FIG. 28B is an example of a menu screen for sequential capture mode in three-dimensional imaging;

FIG. 29A is an example of a menu screen for bracket imaging mode in two-dimensional imaging, and FIG. 28B is an example of a menu screen for bracket imaging mode in three-dimensional imaging;

FIG. 30 is a diagram illustrating an aspect bracket imaging function;

FIG. 31A shows the extraction region at an aspect ratio of 4:3, FIG. 31B shows the extraction region at an aspect ratio of 3:2, FIG. 31C shows the extraction region at an aspect ratio of 6:9, and FIG. 31D shows the extraction region at an aspect ratio of 1:1;

FIG. 32 is a flowchart of when the power is on (second embodiment);

FIG. 33 is a flowchart of when the power is on (second embodiment);

FIG. 34 is a flowchart of menu screen switching (super-high-speed sequential capture mode);

FIG. 35 is a flowchart of menu screen switching (aspect bracket imaging mode);

FIG. 36 is a flowchart of two-dimensional imaging (second embodiment);

FIG. 37 is a flowchart of three-dimensional imaging (second embodiment);

FIG. 38A is an example of a menu screen for two-dimensional imaging, and FIG. 38B is an example of a menu screen for three-dimensional imaging;

FIG. 39A is an example of a menu screen for two-dimensional imaging, and FIG. 39B is an example of a menu screen for three-dimensional imaging;

FIG. 40A is a warning display example, and FIG. 40B is a warning display example; and

FIG. 41 is a flowchart of menu screen switching (super-high-speed sequential capture mode).

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

### First Embodiment

### Configuration of Digital Camera

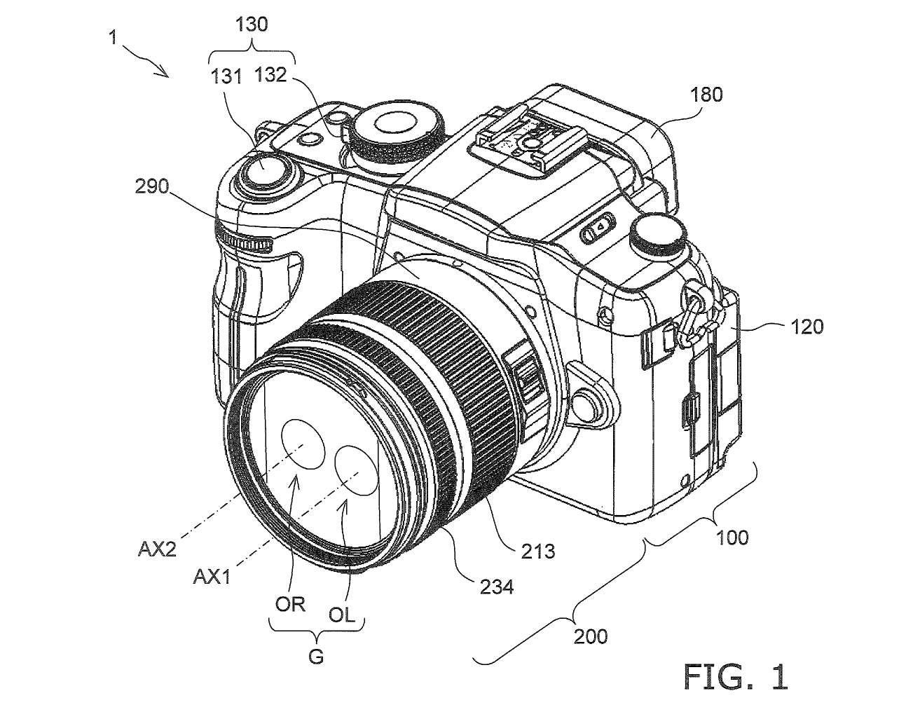

A digital camera 1 is an imaging device capable of three-dimensional imaging, and is an interchangeable lens type of digital camera. As shown in FIGS. 1 to 3, the digital camera 1 comprises an interchangeable lens unit 200 and a camera body 100 to which the interchangeable lens unit 200 can be mounted. The interchangeable lens unit 200 is a lens unit that is compatible with three-dimensional imaging, and forms optical images of a subject (a left-eye optical image and a right-eye optical image). The camera body 100 is compatible with both two- and three-dimensional imaging, and produces image data on the basis of the optical image formed by the interchangeable lens unit 200. In addition to the interchangeable lens unit 200 that is compatible with three-dimensional imaging, an interchangeable lens unit that is not compatible with three-dimensional imaging can also be attached to the camera body 100. That is, the camera body 100 is compatible with both two- and three-dimensional imaging.

For the sake of convenience in the following description, the subject side of the digital camera 1 will be referred to as “front,” the opposite side from the subject as “back” or “rear,” the vertical upper side in the normal orientation (landscape orientation) of the digital camera 1 as “upper,” and the vertical lower side as “lower.”

1: Interchangeable Lens Unit

The interchangeable lens unit 200 is a lens unit that is compatible with three-dimensional imaging. The interchangeable lens unit 200 in this embodiment makes use of a side-by-side imaging system with which two optical images are formed on a single imaging element by a pair of left and right optical systems.

As shown in FIGS. 1 to 4, the interchangeable lens unit 200 has a three-dimensional optical system G, a first drive unit 271, a second drive unit 272, a shake amount detecting sensor 275, and a lens controller 240. The interchangeable lens unit 200 further has a lens mount 250, a lens barrel 290, a zoom ring 213, and a focus ring 234. In the mounting of the interchangeable lens unit 200 to the camera body 100, the lens mount 250 is attached to a body mount 150 (discussed below) of the camera body 100. As shown in FIG. 1, the zoom ring 213 and the focus ring 234 are rotatably provided to the outer part of the lens barrel 290.

(1) Three-Dimensional Optical System G

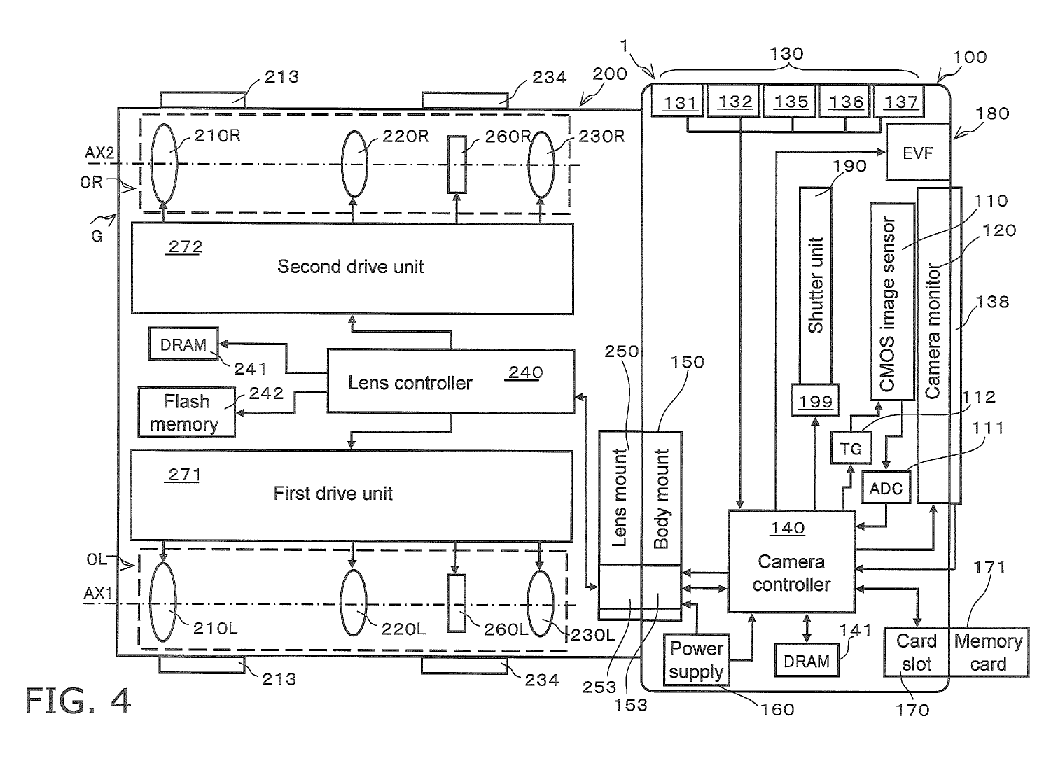

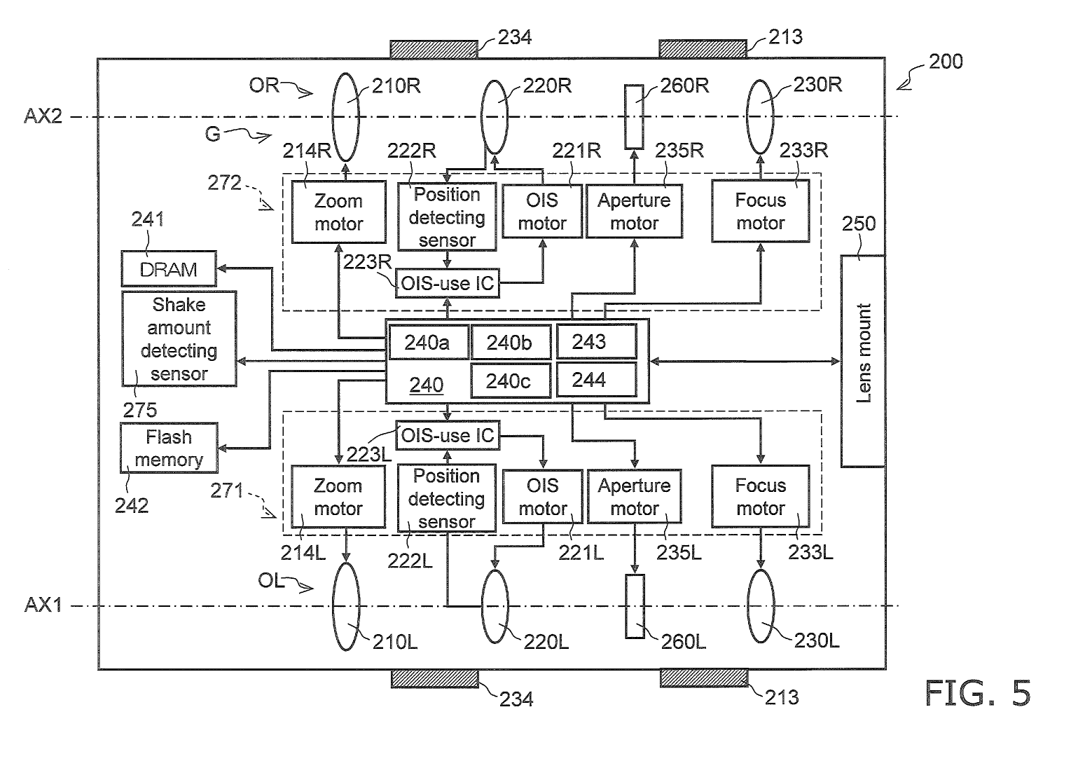

As shown in FIGS. 4 and 5, the three-dimensional optical system G is an optical system compatible with side-by-side imaging, and has a left-eye optical system OL and a right-eye optical system OR. The left-eye optical system OL and the right-eye optical system OR are disposed to the left and right of each other. Here, “left-eye optical system” refers to an optical system corresponding to a left-side perspective, and more specifically refers to an optical system in which the optical element disposed closest to the subject (the front side) is disposed on the left side facing the subject. Similarly, a “right-eye optical system” refers to an optical system corresponding to a right-side perspective, and more specifically refers to an optical system in which the optical element disposed closest to the subject (the front side) is disposed on the right side facing the subject.

The left-eye optical system OL is an optical system used to capture an image of a subject from a left-side perspective facing the subject, and includes a zoom lens 210L, an OIS lens 220L, an aperture unit 260L, and a focus lens 230L. The left-eye optical system OL has a first optical axis AX1, and is housed inside the lens barrel 290 in a state of being side by side with the right-eye optical system OR.

The zoom lens 210L is used to change the focal length of the left-eye optical system OL, and is disposed movably in a direction parallel with the first optical axis AX1. The zoom lens 210L is made up of one or more lenses. The zoom lens 210L is driven by a zoom motor 214L (discussed below) of the first drive unit 271. The focal length of the left-eye optical system OL can be adjusted by driving the zoom lens 210L in a direction parallel with the first optical axis AX1.

The OIS lens 220L is used to suppress displacement of the optical image formed by the left-eye optical system OL with respect to a CMOS image sensor 110 (discussed below). The OIS lens 220L is made up of one or more lenses. An OIS motor 221L drives the OIS lens 220L on the basis of a control signal sent from an OIS-use IC 223L so that the OIS lens 220L moves within a plane perpendicular to the first optical axis AX1. The OIS motor 221L can be, for example, a magnet (not shown) and a flat coil (not shown). The position of the OIS lens 220L is detected by a position detecting sensor 222L (discussed below) of the first drive unit 271.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the first optical axis AX1.

The aperture unit 260L adjusts the amount of light that passes through the left-eye optical system OL. The aperture unit 260L has a plurality of aperture vanes (not shown). The aperture vanes are driven by an aperture motor 235L (discussed below) of the first drive unit 271. A camera controller 140 (discussed below) controls the aperture motor 235L.

The focus lens 230L is used to adjust the subject distance (also called the object distance) of the left-eye optical system OL, and is disposed movably in a direction parallel to the first optical axis AX1. The focus lens 230L is driven by a focus motor 233L (discussed below) of the first drive unit 271. The focus lens 230L is made up of one or more lenses.

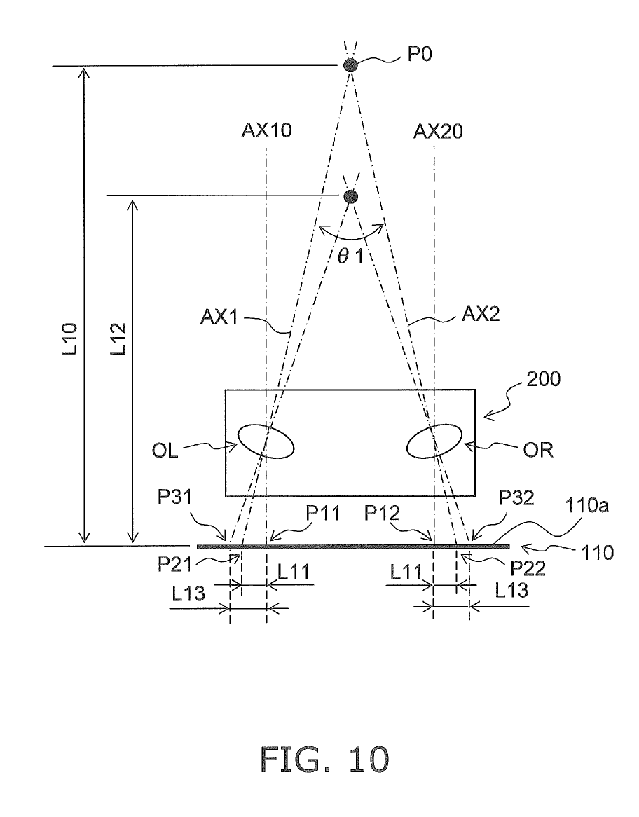

The right-eye optical system OR is an optical system used to capture an image of a subject from a right-side perspective facing the subject, and includes a zoom lens 210R, an OIS lens 220R, an aperture unit 260R, and a focus lens 230R. The right-eye optical system OR has a second optical axis AX2, and is housed inside the lens barrel 290 in a state of being side by side with the left-eye optical system OL. The spec of the right-eye optical system OR is the same as the spec of the left-eye optical system OL. The angle formed by the first optical axis AX1 and the second optical axis AX2 (angle of convergence) is referred to as the angle θ1 shown in FIG. 10.

The zoom lens 210R is used to change the focal length of the right-eye optical system OR, and is disposed movably in a direction parallel with the second optical axis AX2. The zoom lens 210R is made up of one or more lenses. The zoom lens 210R is driven by a zoom motor 214R (discussed below) of the second drive unit 272. The focal length of the right-eye optical system OR can be adjusted by driving the zoom lens 210R in a direction parallel with the second optical axis AX2. The drive of the zoom lens 210R is synchronized with the drive of the zoom lens 210L. Therefore, the focal length of the right-eye optical system OR is the same as the focal length of the left-eye optical system OL.

The OIS lens 220R is used to suppress displacement of the optical image foamed by the right-eye optical system OR with respect to the CMOS image sensor 110. The OIS lens 220R is made up of one or more lenses. An OIS motor 221R drives the OIS lens 220R on the basis of a control signal sent from an OIS-use IC 223R so that the OIS lens 220R moves within a plane perpendicular to the second optical axis AX2. The OIS motor 221R can be, for example, a magnet (not shown) and a flat coil (not shown). The position of the OIS lens 220R is detected by a position detecting sensor 222R (discussed below) of the second drive unit 272.

An optical system is employed as the blur correction system in this embodiment, but the blur correction system may instead be an electronic system in which image data produced by the CMOS image sensor 110 is subjected to correction processing, or a sensor shift system in which an imaging element such as the CMOS image sensor 110 is driven within a plane that is perpendicular to the second optical axis AX2.

The aperture unit 260R adjusts the amount of light that passes through the right-eye optical system OR. The aperture unit 260R has a plurality of aperture vanes (not shown). The aperture vanes are driven by an aperture motor 235R (discussed below) of the second drive unit 272. The camera controller 140 controls the aperture motor 235R. The drive of the aperture unit 260R is synchronized with the drive of the aperture unit 260L. Therefore, the aperture value of the right-eye optical system OR is the same as the aperture value of the left-eye optical system OL.

The focus lens 230R is used to adjust the subject distance (also called the object distance) of the right-eye optical system OR, and is disposed movably in a direction parallel to the second optical axis AX2. The focus lens 230R is driven by a focus motor 233R (discussed below) of the second drive unit 272. The focus lens 230R is made up of one or more lenses.

(2) First Drive Unit 271

The first drive unit 271 is provided to adjust the state of the left-eye optical system OL, and as shown in FIG. 5, has the zoom motor 214L, the OIS motor 221L, the position detecting sensor 222L, the OIS-use IC 223L, the aperture motor 235L, and the focus motor 233L.

The zoom motor 214L drives the zoom lens 210L. The zoom motor 214L is controlled by the lens controller 240.

The OIS motor 221L drives the OIS lens 220L. The position detecting sensor 222L is a sensor for detecting the position of the OIS lens 220L. The position detecting sensor 222L is a Hall element, for example, and is disposed near the magnet of the OIS motor 221L. The OIS-use IC 223L controls the OIS motor 221L on the basis of the detection result of the position detecting sensor 222L and the detection result of the shake amount detecting sensor 275. The OIS-use IC 223L acquires the detection result of the shake amount detecting sensor 275 from the lens controller 240. Also, the OIS-use IC 223L sends the lens controller 240 a signal indicating the position of the OIS lens 220L, at a specific period.

The aperture motor 235L drives the aperture unit 260L. The aperture motor 235L is controlled by the lens controller 240.

The focus motor 233L drives the focus lens 230L. The focus motor 233L is controlled by the lens controller 240. The lens controller 240 also controls the focus motor 233R, and synchronizes the focus motor 233L and the focus motor 233R. Consequently, the subject distance of the left-eye optical system OL is the same as the subject distance of the right-eye optical system OR. Examples of the focus motor 233L include a DC motor, a stepping motor, a servo motor, and an ultrasonic motor.

(3) Second Drive Unit 272

The second drive unit 272 is provided to adjust the state of the right-eye optical system OR, and as shown in FIG. 5, has the zoom motor 214R, the OIS motor 221R, the position detecting sensor 222R, the OIS-use IC 223R, the aperture motor 235R, and the focus motor 233R.

The zoom motor 214R drives the zoom lens 210R. The zoom motor 214R is controlled by the lens controller 240.

The OIS motor 221R drives the OIS lens 220R. The position detecting sensor 222R is a sensor for detecting the position of the OIS lens 220R. The position detecting sensor 222R is a Hall element, for example, and is disposed near the magnet of the OIS motor 221R. The OIS-use IC 223R controls the OIS motor 221R on the basis of the detection result of the position detecting sensor 222R and the detection result of the shake amount detecting sensor 275. The OIS-use IC 223R acquires the detection result of the shake amount detecting sensor 275 from the lens controller 240. Also, the OIS-use IC 223R sends the lens controller 240 a signal indicating the position of the OIS lens 220R, at a specific period.

The aperture motor 235R drives the aperture unit 260R. The aperture motor 235R is controlled by the lens controller 240.

The focus motor 233R drives the focus lens 230R. The focus motor 233R is controlled by the lens controller 240. The lens controller 240 synchronizes the focus motor 233L and the focus motor 233R. Consequently, the subject distance of the left-eye optical system OL is the same as the subject distance of the right-eye optical system OR. Examples of the focus motor 233R include a DC motor, a stepping motor, a servo motor, and an ultrasonic motor.

(4) Lens Controller 240

The lens controller 240 controls the various components of the interchangeable lens unit 200 (such as the first drive unit 271 and the second drive unit 272) on the basis of control signals sent from the camera controller 140. The lens controller 240 sends and receives signals to and from the camera controller 140 via the lens mount 250 and the body mount 150. During control, the lens controller 240 uses a DRAM 241 as a working memory.

The lens controller 240 has a CPU (central processing unit) 240a, a ROM (read only memory) 240b, and a RAM (random access memory) 240c, and can perform various functions by reading programs stored in the ROM 240b into the CPU 240a.

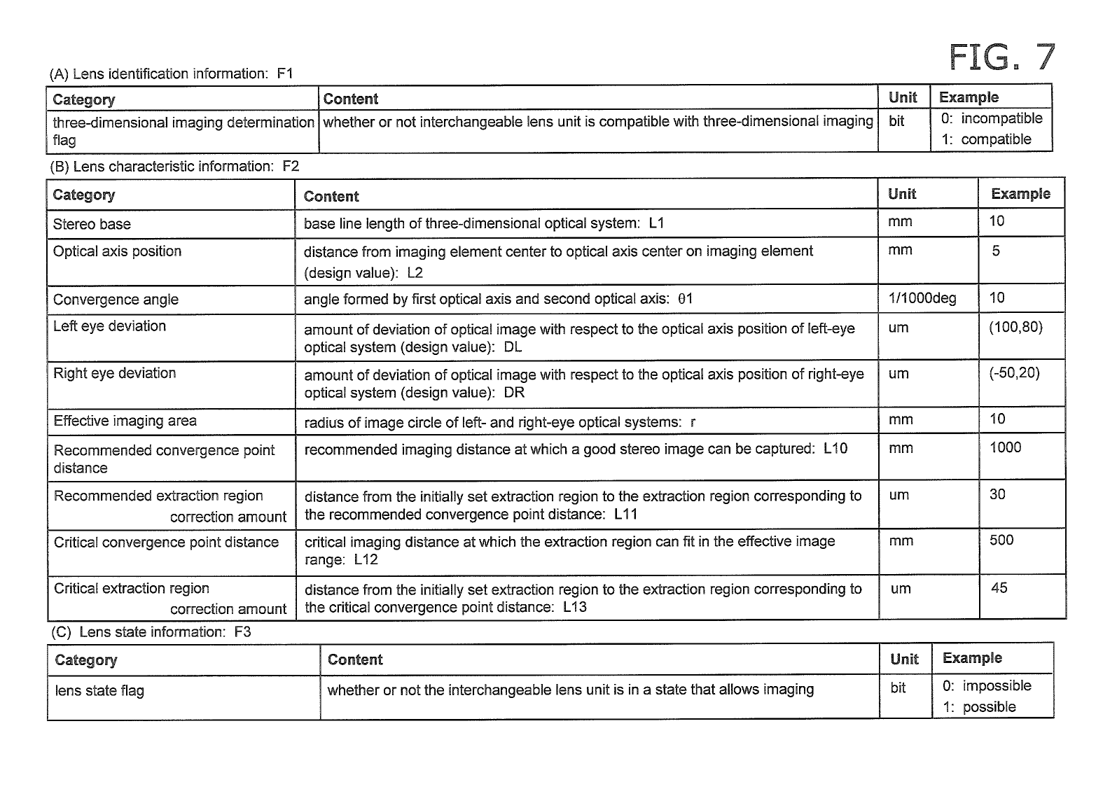

Also, a flash memory 242 (an example of a correction information storage section, and an example of an identification information storage section) stores parameters or programs used in control by the lens controller 240. For example, in the flash memory 242 are pre-stored lens identification information F1 (see FIG. 7A) indicating that the interchangeable lens unit 200 is compatible with three-dimensional imaging, and lens characteristic information F2 (see FIG. 7B) that includes flags and parameters indicating the characteristics of the three-dimensional optical system G. Lens state information F3 (see FIG. 7C) indicating whether or not the interchangeable lens unit 200 is in a state that allows imaging is held in the RAM 240c, for example.

The lens identification information F1, lens characteristic information F2, and lens state information F3 will now be described.

Lens Identification Information F1

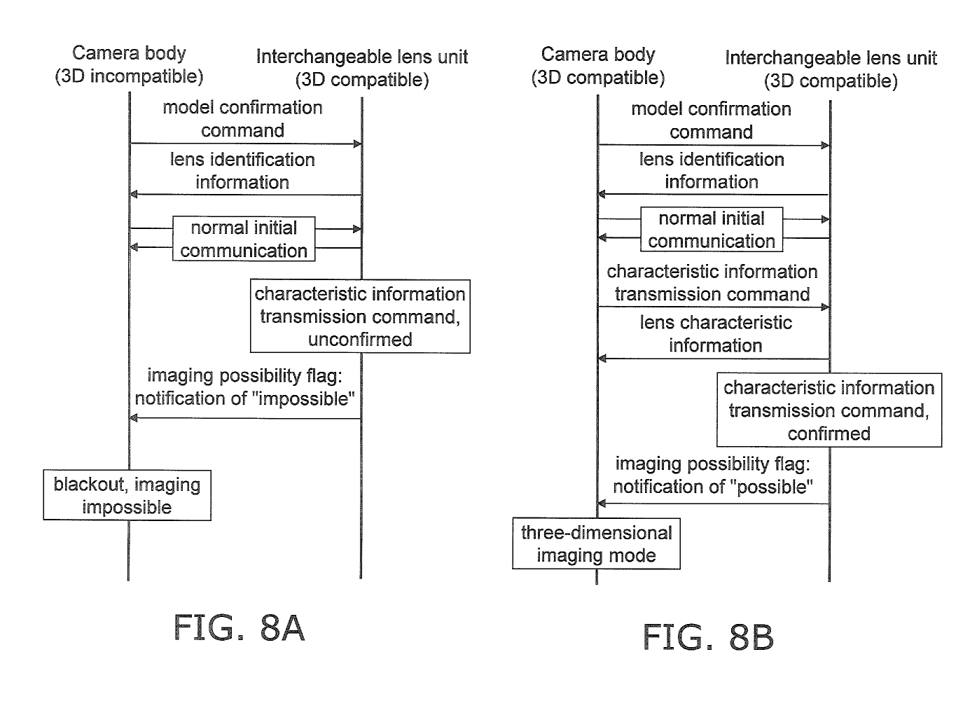

The lens identification information F1 is information indicating whether or not the interchangeable lens unit is compatible with three-dimensional imaging, and is stored ahead of time in the flash memory 242, for example. As shown in FIG. 7A, the lens identification information F1 is a three-dimensional imaging determination flag stored at a specific address in the flash memory 242. As shown in FIGS. 8A and 8B, a three-dimensional imaging determination flag is sent from the interchangeable lens unit to the camera body in the initial communication performed between the camera body and the interchangeable lens unit when the power is turned on or when the interchangeable lens unit is mounted to the camera body.

If a three-dimensional imaging determination flag has been raised, that interchangeable lens unit is compatible with three-dimensional imaging, but if a three-dimensional imaging determination flag has not been raised, that interchangeable lens unit is not compatible with three-dimensional imaging. A region not used for an ordinary interchangeable lens unit that is not compatible with three-dimensional imaging is used for the address of the three-dimensional imaging determination flag. Consequently, with an interchangeable lens unit that is not compatible with three-dimensional imaging, a state may result in which a three-dimensional imaging determination flag is not raised even though no setting of a three-dimensional imaging determination flag has been performed.

Lens Characteristic Information F2

The lens characteristic information F2 is data indicating the characteristics of the optical system of the interchangeable lens unit, and includes the following parameters and flags, as shown in FIG. 7B.

(A) Stereo Base

Stereo base L1 of the stereo optical system (G)

(B) Optical Axis Position

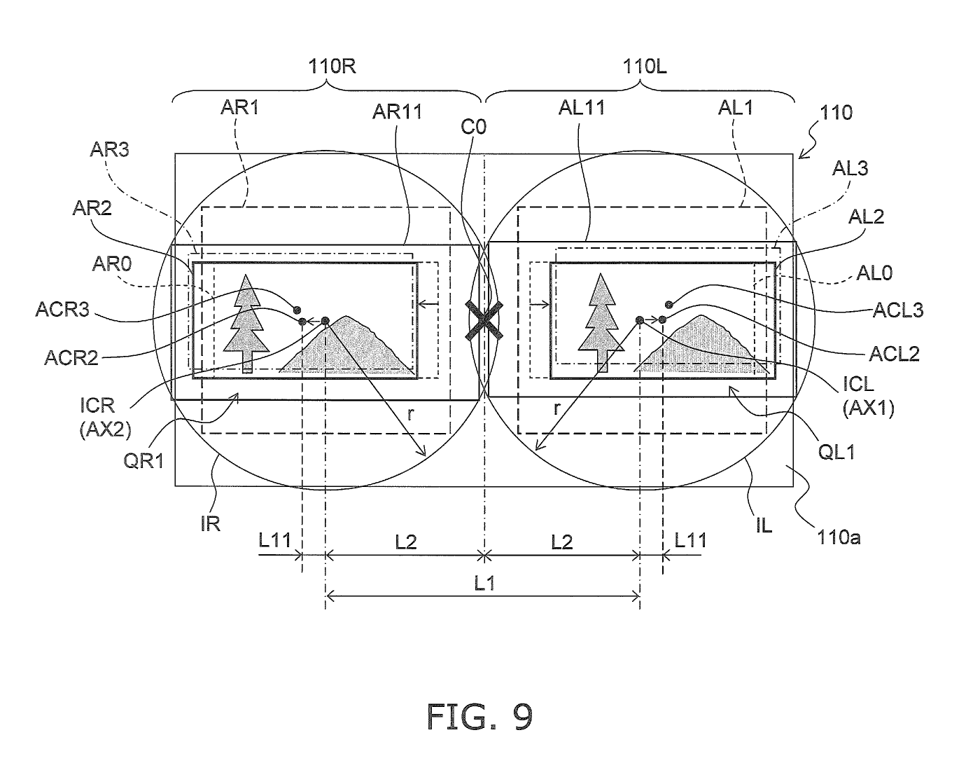

Distance L2 (design value) from the center C0 (see FIG. 9) of the imaging element (the CMOS image sensor 110) to the optical axis center (the center ICR of the image circle IR or the center ICL or the image circle IL shown in FIG. 9)

(C) Angle of Convergence

Angle θ1 formed by the first optical axis (AX1) and the second optical axis (AX2) (see FIG. 10)

(D) Amount of Left-Eye Deviation

Deviation amount DL (horizontal: DLx, vertical: DLy) of the left-eye optical image (QL1) with respect to the optical axis position (design value) of the left-eye optical system (OL) on the imaging element (the CMOS image sensor 110)

(E) Amount of Right-Eye Deviation

Deviation amount DR (horizontal: DRx, vertical: DRy) of the right-eye optical image (QR1) with respect to the optical axis position (design value) of the right-eye optical system (OR) on the imaging element (the CMOS image sensor 110)

(F) Effective Imaging Area

Radius r of the image circles (AL1, AR1) of the left-eye optical system (OL) and the right-eye optical system (OR) (see FIG. 8)

(G) Recommended Convergence Point Distance

Distance L10 from the subject (convergence point P0) to the light receiving face 110a of the CMOS image sensor 110, recommended in performing three-dimensional imaging with the interchangeable lens unit 200 (see FIG. 10)

(H) Extraction Position Correction Amount

Distance L11 from the points (P11 and P12) at which the first optical axis AX1 and the second optical axis AX2 reach the light receiving face 110a when the convergence angle θ1 is zero, to the points (P21 and P22) at which the first optical axis AX1 and the second optical axis AX2 reach the light receiving face 110a when the convergence angle θ1 corresponds to the recommended convergence point distance L1 (see FIG. 10) (Also referred to as the “distance on the imaging element from the reference image extraction position corresponding to when the convergence point distance is at infinity, to the recommended image extraction position corresponding to the recommended convergence point distance of the interchangeable lens unit.”)

(I) Limiting Convergence Point Distance

Limiting distance L12 from the subject to the light receiving face 110a when the extraction range of the left-eye optical image QL1 and the right-eye optical image QR1 are both within the effective imaging area in performing three-dimensional imaging with the interchangeable lens unit 200 (see FIG. 10).

(J) Extraction Position Limiting Correction Amount

Distance L13 from the points (P11 and P12) at which the first optical axis AX1 and the second optical axis AX2 reach the light receiving face 110a when the convergence angle θ1 is zero, to the points (P31 and P32) at which the first optical axis AX1 and the second optical axis AX2 reach the light receiving face 110a when the convergence angle θ1 corresponds to the limiting convergence point distance L12 (see FIG. 10)

Of the above parameters, the optical axis position, the left-eye deviation, and the right-eye deviation are parameters characteristic of a side-by-side imaging type of three-dimensional optical system.

The above parameters will now be described through reference to FIGS. 9 and 10. FIG. 9 is a diagram of the CMOS image sensor 110 as viewed from the subject side. The CMOS image sensor 110 has a light receiving face 110a (see FIGS. 9 and 10) that receives light that has passed through the interchangeable lens unit 200. An optical image of the subject is formed on the light receiving face 110a. As shown in FIG. 9, the light receiving face 110a has a first region 110L and a second region 110R disposed adjacent to the first region 110L. The surface area of the first region 110L is the same as the surface area of the second region 110R. As shown in FIG. 9, when viewed from the rear face side of the camera body 100 (a see-through view), the first region 110L accounts for the left half of the light receiving face 110a, and the second region 110R accounts for the right half of the light receiving face 110a. As shown in FIG. 9, when imaging is performed using the interchangeable lens unit 200, a left-eye optical image QL1 is formed in the first region 110L, and a right-eye optical image QR1 is formed in the second region 110R.

As shown in FIG. 9, the image circle IL of the left-eye optical system OL and the image circle IR of the right-eye optical system OR are defined for design purposes on the CMOS image sensor 110. The center ICL of the image circle IL (an example of a reference image extraction position) coincides with the designed position of the first optical axis AX10 of the left-eye optical system OL, and the center ICR of the image circle IR (an example of a reference image extraction position) coincides with the designed position of the second optical axis AX20 of the right-eye optical system OR. Here, the “designed position” corresponds to a case in which the first optical axis AX10 and the second optical axis AX20 have their convergence point at infinity. Therefore, the designed stereo base is the designed distance L1 between the first optical axis AX10 and the second optical axis AX20 on the CMOS image sensor 110. Also, the optical axis position is the designed distance L2 between the center C0 of the light receiving face 110a and the first optical axis AX10 (or the designed distance L2 between the center C0 and the second optical axis AX20).

As shown in FIG. 9, an extractable range AU and a horizontal imaging-use extractable range AL11 are set on the basis of the center ICL, and an extractable range AR1 and a horizontal imaging-use extractable range AR11 are set on the basis of the center ICR. Since the center ICL is set substantially at the center position of the first region 110L of the light receiving face 110a, wider extractable ranges AL1 and AL11 can be ensured within the image circle IL. Also, since the center ICR is set substantially at the center position of the second region 110R, wider extractable ranges AR1 and AR11 can be ensured within the image circle IR.

The extractable ranges AL0 and AR0 shown in FIG. 9 are regions serving as a reference in extracting left-eye image data and right-eye image data. The designed extractable range AL0 for left-eye image data is set using the center ICL of the image circle IL (or the first optical axis AX10) as a reference, and is positioned at the center of the extractable range AL1. Also, the designed extractable range AR0 for right-eye image data is set using the center ICR of the image circle IR (or the second optical axis AX20) as a reference, and is positioned at the center of the extractable range AR1.

However, since the optical axis centers ICL and ICR corresponding to a case in which the convergence point is at infinity, if the left-eye image data and right-eye image data are extracted using the extraction regions AL0 and AR0 as a reference, the position at which the subject is reproduced in 3D view will be the infinity position. Therefore, if the interchangeable lens unit 200 is for close-up imaging at this setting (such as when the distance from the imaging position to the subject is about 1 meter), there will be a problem in that the subject will jump out from the screen too much within the three-dimensional image in 3D view.

In view of this, with this camera body 100, the extraction region AR0 is shifted to the recommended extraction region AR3, and the extraction region AL0 to the recommended extraction region AL3, each by a distance L11, so that the distance from the user to the screen in 3D view will be the recommended convergence point distance L10 of the interchangeable lens unit 200. The correction processing of the extraction area using the extraction position correction amount L11 will be described below.

2: Configuration of Camera Body

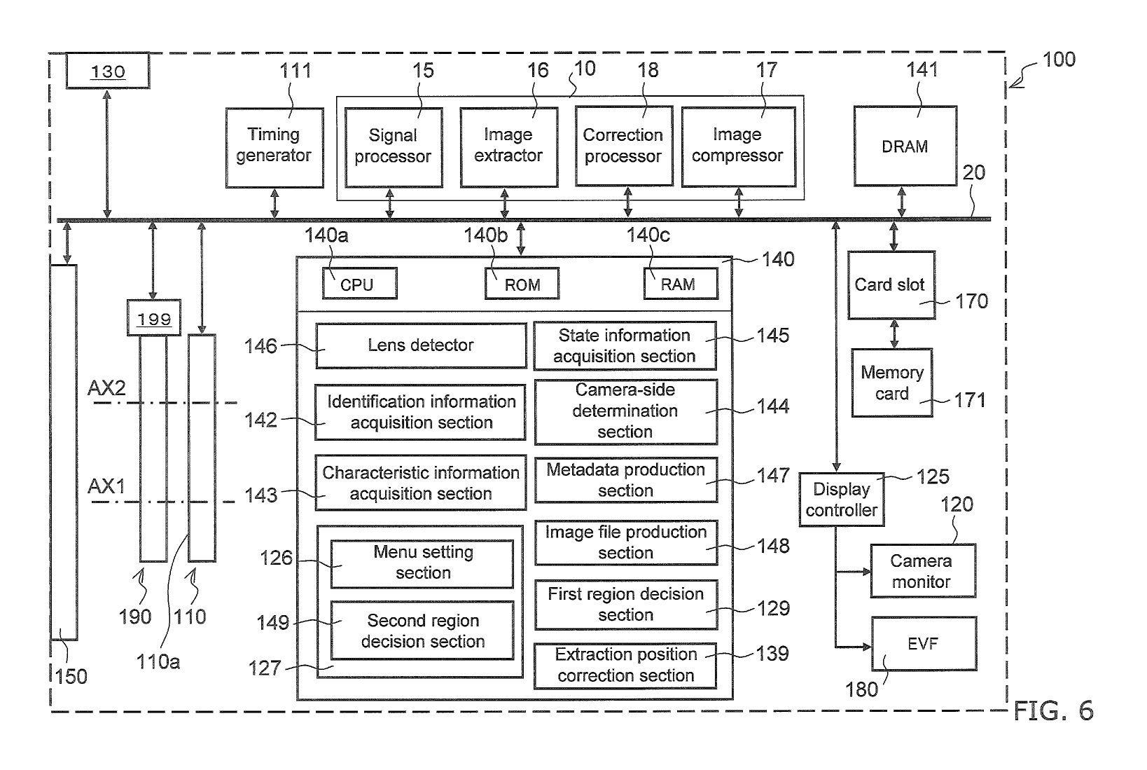

As shown in FIGS. 4 and 6, the camera body 100 comprises the CMOS image sensor 110, a camera monitor 120, an electronic viewfinder 180, a display controller 125, a manipulation unit 130, a card slot 170, a shutter unit 190, the body mount 150, a DRAM 141, an image processor 10, and the camera controller 140 (an example of a controller). These components are connected to a bus 20, allowing data to be exchanged between them via the bus 20.

(1) CMOS Image Sensor 110

The CMOS image sensor 110 converts an optical image of a subject (hereinafter also referred to as a subject image) formed by the interchangeable lens unit 200 into an image signal. As shown in FIG. 6, the CMOS image sensor 110 outputs an image signal on the basis of a timing signal produced by a timing generator 112. The image signal produced by the CMOS image sensor 110 is digitized and converted into image data by a signal processor 15 (discussed below). The CMOS image sensor 110 can acquire still picture data and moving picture data. The acquired moving picture data is also used for the display of a through-image.

The “through-image” referred to here is an image, out of the moving picture data, that is not recorded to a memory card 171. The through-image is mainly a moving picture, and is displayed on the camera monitor 120 or the electronic viewfinder (hereinafter also referred to as EVF) 180 in order to compose a moving picture or still picture.

As discussed above, the CMOS image sensor 110 has the light receiving face 110a (see FIGS. 6 and 9) that receives light that has passed through the interchangeable lens unit 200. An optical image of the subject is formed on the light receiving face 110a. As shown in FIG. 9, when viewed from the rear face side of the camera body 100, the first region 110L accounts for the left half of the light receiving face 110a, while the second region 110R accounts for the right half. When imaging is performed with the interchangeable lens unit 200, a left-eye optical image is formed in the first region 110L, and a right-eye optical image is formed in the second region 110R.

The CMOS image sensor 110 is an example of an imaging element that converts an optical image of a subject into an electrical image signal. “Imaging element” is a concept that encompasses the CMOS image sensor 110 as well as a CCD image sensor or other such opto-electric conversion element.

(2) Camera Monitor 120

The camera monitor 120 is a liquid crystal display, for example, and displays display-use image data as an image. This display-use image data is image data that has undergone image processing, data for displaying the imaging conditions, operating menu, and so forth of the digital camera 1, or the like, and is produced by the camera controller 140. The camera monitor 120 is capable of selectively displaying both moving and still pictures. As shown in FIG. 5, in this embodiment the camera monitor 120 is disposed on the rear face of the camera body 100, but the camera monitor 120 may be disposed anywhere on the camera body 100.

The camera monitor 120 is an example of a display section provided to the camera body 100. The display section could also be an organic electroluminescence component, an inorganic electroluminescence component, a plasma display panel, or another such device that allows images to be displayed.

(3) Electronic Viewfinder 180

The electronic viewfinder 180 displays as an image the display-use image data produced by the camera controller 140. The EVF 180 is capable of selectively displaying both moving and still pictures. The EVF 180 and the camera monitor 120 may both display the same content, or may display different content. They are both controlled by the display controller 125.

(4) Display Controller 125

The display controller 125 controls the camera monitor 120 and the electronic viewfinder 180. More specifically, the display controller 125 produces display-use image data that will serve as the basis for the image displayed on the camera monitor 120 and the electronic viewfinder 180, and displays the image on the camera monitor 120 and the electronic viewfinder 180 on the basis of this display-use image data. The display controller 125 adjusts the size of the image data after correction processing, and produces display-use image data. Also, the display controller 125 can display on the camera monitor 120 and the electronic viewfinder 180 a menu screen formed by a menu setting section 126.

(5) Manipulation Unit 130

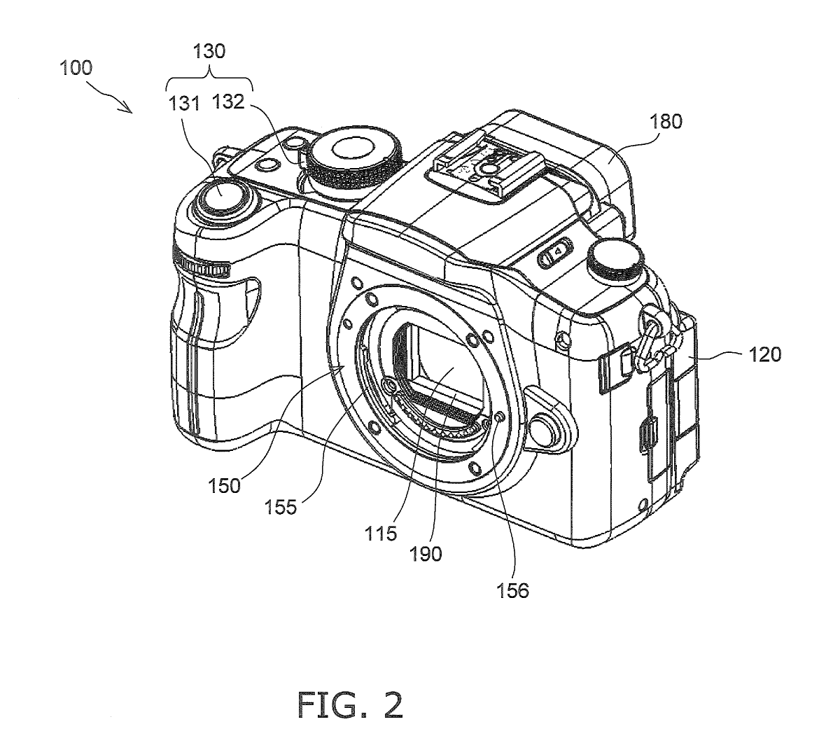

As shown in FIGS. 1 and 2, the manipulation unit 130 has a release button 131, a power switch 132, a cross key 135, an enter button 136, a display button 137, and a touch panel 138. The release button 131 is used for shutter operation by the user. The power switch 132 is a rotary lever switch provided to the top face of the camera body 100, and is provided to turn the power on and off to the camera body 100. When the power switch 132 is switched on in a state in which the interchangeable lens unit 200 has been mounted to the camera body 100, power is supplied to the camera body 100 and the interchangeable lens unit 200.

The cross key 135 includes four buttons (up, down, left, and right), and is used in selecting a function on the menu screen, for example. The enter button 136 is used to make a final decision in selecting a function by using the cross key 135. The enter button 136 also has the function of switching the display state of the camera monitor 120 or the electronic viewfinder 180 to a menu screen. For example, when the enter button 136 is pressed in a state of live-view display, a menu screen is displayed on the camera monitor 120. Various functions can be selected, switched, and so forth on the menu screens.

The display button 137 is used to switch the display state of the camera monitor 120 and the electronic viewfinder 180. More specifically, for example, when the display button 137 is pressed, a highlighted display, imaging conditions, or the like is displayed superposed over the image that is being reproduced and displayed. A “highlighted display” refers to when a region overexposed with image data is displayed flashing in black and white. Examples of “imaging conditions” include the date and time of imaging, the aperture value, and the shutter speed.

The touch panel 138 is disposed on the display face of the camera monitor 120. Functions can be selected on the menu screen not only with the cross key 135, but also with the touch panel 138. Also, the final decision in selecting a function can be made not only with the enter button 136, but also with the touch panel 138.

The various components of the manipulation unit 130 may be made up of buttons, levers, dials, or the like, as long as they can be operated by the user.

(6) Card Slot 170

The card slot 170 allows the memory card 171 to be inserted. The card slot 170 controls the memory card 171 on the basis of control from the camera controller 140. More specifically, the card slot 170 stores image data on the memory card 171 and outputs image data from the memory card 171. For example, the card slot 170 stores moving picture data on the memory card 171 and outputs moving picture data from the memory card 171.

The memory card 171 is able to store the image data produced by the camera controller 140 in image processing. For instance, the memory card 171 can store uncompressed raw image files, compressed JPEG image files, or the like. Furthermore, the memory card 171 can store stereo image files in multi-picture format (MPF).

Also, image data that have been internally stored ahead of time can be outputted from the memory card 171 via the card slot 170. The image data or image files outputted from the memory card 171 are subjected to image processing by the camera controller 140. For example, the camera controller 140 produces display-use image data by subjecting the image data or image files acquired from the memory card 171 to expansion or the like.

The memory card 171 is further able to store moving picture data produced by the camera controller 140 in image processing. For instance, the memory card 171 can store moving picture files compressed according to H.264/AVC, which is a moving picture compression standard. Stereo moving picture files can also be stored. The memory card 171 can also output, via the card slot 170, moving picture data or moving picture files internally stored ahead of time. The moving picture data or moving picture files outputted from the memory card 171 are subjected to image processing by the camera controller 140. For example, the camera controller 140 subjects the moving picture data or moving picture files acquired from the memory card 171 to expansion processing and produces display-use moving picture data.

(7) Shutter Unit 190

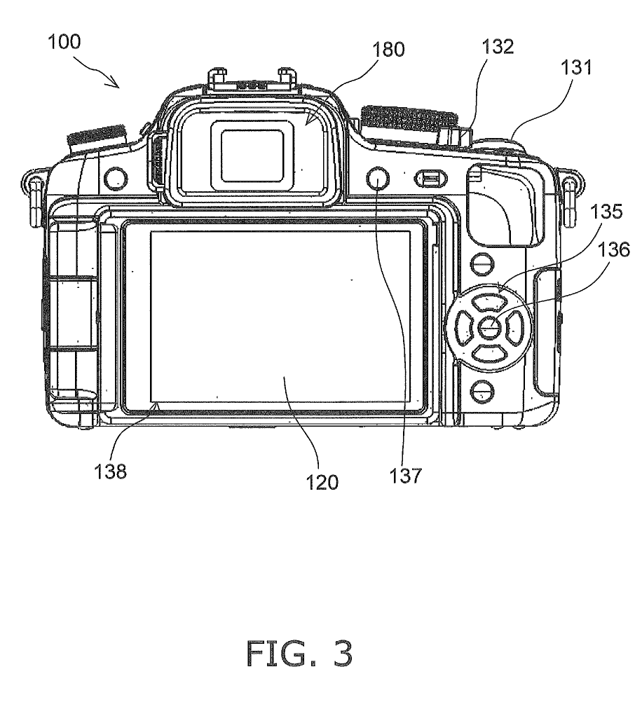

The shutter unit 190 is what is known as a focal plane shutter, and is disposed between the body mount 150 and the CMOS image sensor 110, as shown in FIG. 3. The charging of the shutter unit 190 is performed by a shutter motor 199. The shutter motor 199 is a stepping motor, for example, and is controlled by the camera controller 140.

(8) Body Mount 150

The body mount 150 allows the interchangeable lens unit 200 to be mounted, and holds the interchangeable lens unit 200 in a state in which the interchangeable lens unit 200 is mounted. The body mount 150 can be mechanically and electrically connected to the lens mount 250 of the interchangeable lens unit 200. Data and/or control signals can be sent and received between the camera body 100 and the interchangeable lens unit 200 via the body mount 150 and the lens mount 250. More specifically, the body mount 150 and the lens mount 250 send and receive data and/or control signals between the camera controller 140 and the lens controller 240.

(9) Camera Controller 140

The camera controller 140 controls the entire camera body 100. The camera controller 140 is electrically connected to the manipulation unit 130. Manipulation signals from the manipulation unit 130 are inputted to the camera controller 140. The camera controller 140 uses the DRAM 141 as a working memory during control operation or image processing operation.

Also, the camera controller 140 sends signals for controlling the interchangeable lens unit 200 through the body mount 150 and the lens mount 250 to the lens controller 240, and indirectly controls the various components of the interchangeable lens unit 200. The camera controller 140 also receives various kinds of signal from the lens controller 240 via the body mount 150 and the lens mount 250.

The camera controller 140 has a CPU (central processing unit) 140a, a ROM (read only memory) 140b, and a RAM (random access memory) 140c, and can perform various functions by reading the programs stored in the ROM 140b (an example of a computer-readable storage medium) into the CPU 140a.

Details of Camera Controller 140

The functions of the camera controller 140 will now be described in detail.

First, the camera controller 140 detects whether or not the interchangeable lens unit 200 is mounted to the camera body 100 (more precisely, to the body mount 150). More specifically, as shown in FIG. 6, the camera controller 140 has a lens detector 146. When the interchangeable lens unit 200 is mounted to the camera body 100, signals are exchanged between the camera controller 140 and the lens controller 240. The lens detector 146 determines whether or not the interchangeable lens unit 200 has been mounted on the basis of this exchange of signals.

Also, the camera controller 140 has various other functions, such as the function of determining whether or not the interchangeable lens unit mounted to the body mount 150 is compatible with three-dimensional imaging, and the function of acquiring information related to three-dimensional imaging from the interchangeable lens unit. The camera controller 140 has an identification information acquisition section 142, a characteristic information acquisition section 143, a camera-side determination section 144, the menu setting section 126, a state information acquisition section 145, an extraction position correction section 139, a first region decision section 129, a second region decision section 149, a metadata production section 147, and an image file production section 148. In this embodiment, a function restrictor 127 (an example of a function restrictor), with which the use of one or more imaging functions that can be used in two-dimensional imaging is restricted, is constituted by the menu setting section 126 and the second region decision section 149.

Here, the term “imaging function” in the first embodiment may encompass a function that can be used before, during, and/or after imaging. Therefore, the phrase “one or more imaging functions that can be used in two-dimensional imaging” means a function that can be used before two-dimensional imaging, during two-dimensional imaging, or after two-dimensional imaging.

The identification information acquisition section 142 (an example of an identification information acquisition section) acquires the lens identification information F1, which indicates whether or not the interchangeable lens unit 200 is compatible with three-dimensional imaging, from the interchangeable lens unit 200 mounted to the body mount 150. As shown in FIG. 7A, the lens identification information F1 is information indicating whether or not the interchangeable lens unit mounted to the body mount 150 is compatible with three-dimensional imaging, and is stored in the flash memory 242 of the lens controller 240, for example. The lens identification information F1 is a three-dimensional imaging determination flag stored at a specific address in the flash memory 242. The identification information acquisition section 142 temporarily stores the acquired lens identification information F1 in the DRAM 141, for example.

The camera-side determination section 144 determines whether or not the interchangeable lens unit 200 mounted to the body mount 150 is compatible with three-dimensional imaging on the basis of the lens identification information F1 acquired by the identification information acquisition section 142. Further, the determination result of the camera-side determination section 144 is temporarily stored at a specific address in the RAM 240c. The determination result stored in the RAM 240c may be information indicating whether or not the interchangeable lens unit 200 is compatible with three-dimensional imaging, or may be information indicating either two-dimensional imaging mode or three-dimensional imaging mode. Whether the imaging mode is the two-dimensional imaging mode or the three-dimensional imaging mode can be decided on the basis of the determination result of the camera-side determination section 144. More specifically, if it is determined by the camera-side determination section 144 that the interchangeable lens unit 200 mounted to the body mount 150 is compatible with three-dimensional imaging, the imaging mode of the camera controller 140 is automatically set to the three-dimensional imaging mode. On the other hand, if it is determined by the camera-side determination section 144 that the interchangeable lens unit 200 mounted to the body mount 150 is not compatible with three-dimensional imaging, the imaging mode of the camera controller 140 is automatically set to the two-dimensional imaging mode.

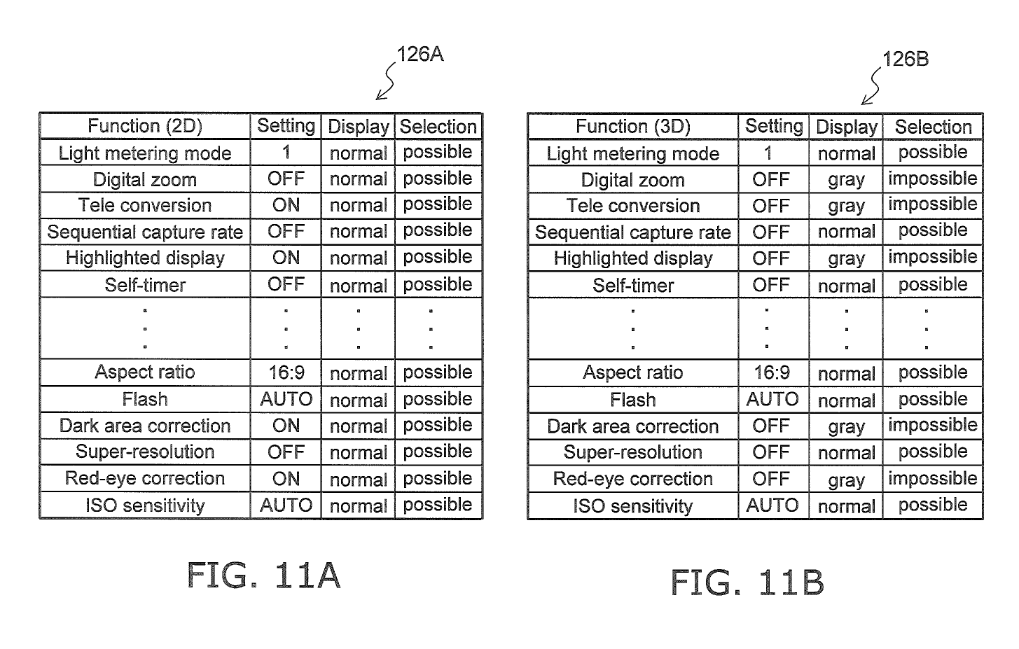

The menu setting section 126 (an example of a menu setting section) sets the menu screen displayed on the camera monitor 120 and the electronic viewfinder 180. More specifically, as shown in FIGS. 11A and 11B, the menu setting section 126 has first menu information 126A that gives a list of functions that can be used in two-dimensional imaging, and second menu information 126B that gives a list of functions that can be used in three-dimensional imaging. The first menu information 126A and the second menu information 126B are stored ahead of time in the ROM 140b of the camera controller 140, for example. The first menu information 126A and the second menu information 126B are lists of four kinds of information: function, setting, display, and selection, for example. “Setting” indicates the setting state of that function. In this embodiment, basically the first menu information 126A and second menu information 126B share their settings with each other. Therefore, if a setting is changed during two-dimensional imaging, that changed setting will be reflected in the settings in three-dimensional imaging. “Display” shows the state when the display is a menu screen. If the “display” is “normal,” that function will be displayed on the menu screen in an ordinary color such as white. If the “display” is “gray,” that function is grayed out on the menu screen. “Selection” shows whether or not that function can be selected (whether or not it can be used). If the “selection” is “possible,” that function can be selected. If the “selection” is “impossible,” it means that that function cannot be selected (cannot be used). A function that cannot be selected may be displayed in a different color from that of functions that can be selected, without any display category being present.

As shown in FIG. 11A, with the first menu information 126A, all of the functions are in normal display and can be selected.

On the other hand, as shown in FIG. 11B, with the second menu information 126B, for example, the digital zoom function, conversion function, highlighted display function, dark area correction function, and red-eye correction function are grayed out and cannot be selected. Here, functions that cannot be selected are forcibly switched to “off” by the menu setting section 126 with the second menu information 126B, even though they are “on” with the first menu information 126A. For example, the tele conversion function, highlighted display function, dark area correction function, and red-eye correction function are set to “on” with the first menu information 126A, but are set to “off” with the second menu information 126B. Thus, the menu setting section 126 forcibly sets predetermined imaging functions to “off” regardless of their setting for two-dimensional imaging in order to restrict the use of these predetermined imaging functions in three-dimensional imaging.

The menu setting section 126 decides whether to display the first menu information 126A or the second menu information 126B as menu information on the basis of the determination result of the camera-side determination section 144 stored in the RAM 240c. More specifically, if the determination result of the camera-side determination section 144 is that the interchangeable lens unit is compatible with three-dimensional imaging, then the menu setting section 126 displays the second menu information 126B on the camera monitor 120 or the electronic viewfinder 180. On the other hand, if the determination result of the camera-side determination section 144 is that the interchangeable lens unit is not compatible with three-dimensional imaging, then the menu setting section 126 displays the first menu information 126A on the camera monitor 120 or the electronic viewfinder 180.

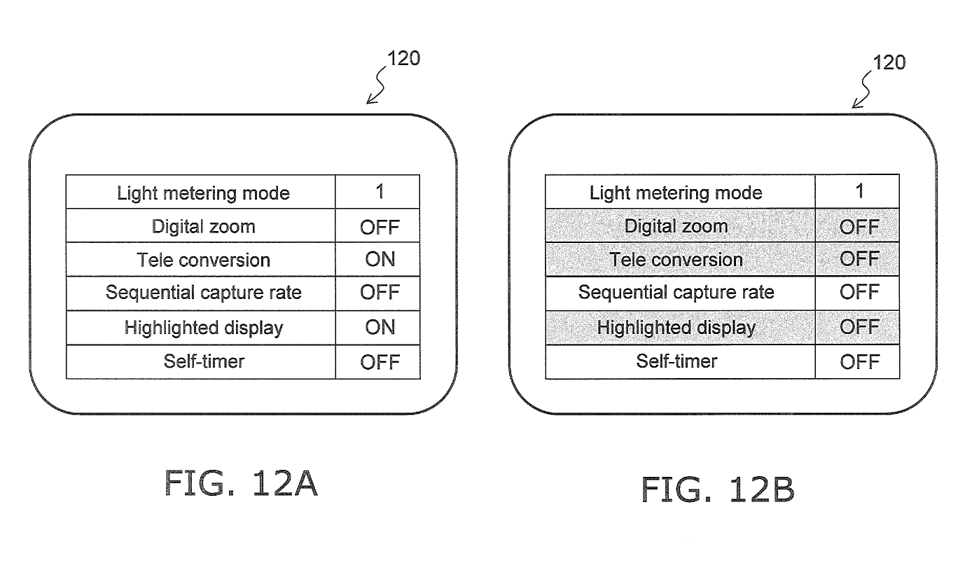

FIGS. 12A and 12B show examples of the screens displayed on the basis of the first menu information 126A and second menu information 126B. As shown in FIG. 12A, the light metering mode, digital zoom, tele conversion, sequential capture rate, highlighted display, and auto-timer included in the first menu information 126A, for example, are displayed as functions that can be selected on the menu screen in two-dimensional imaging mode.

Meanwhile, as shown in FIG. 12B, the light metering mode, digital zoom, tele conversion, sequential capture rate, highlighted display, and auto-timer included in the second menu information 126B, for example, are displayed on the menu screen in three-dimensional imaging mode, but of these, the categories for digital zoom, tele conversion, and highlighted display are grayed out. As discussed above, a function that is grayed out cannot be selected by the user.

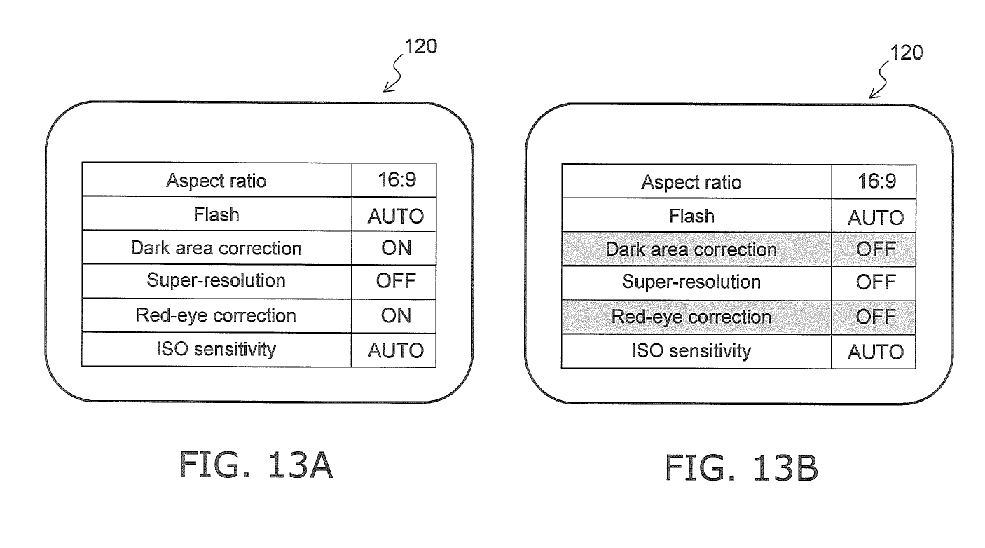

Also, as shown in FIG. 13A, the aspect ratio, flash, dark area correction, super-resolution, red-eye correction, and ISO sensitivity included in the first menu information 126A are displayed on the menu screen in the two-dimensional imaging mode.

Meanwhile, as shown in FIG. 13B, the aspect ratio, flash, dark area correction, super-resolution, red-eye correction, and ISO sensitivity included in the second menu information 126B are displayed on the menu screen in the three-dimensional imaging mode, but of these, the categories of dark area correction and red-eye correction are grayed out. A function that is grayed out cannot be selected by the user.

As discussed above, if the camera-side determination section 144 has determined that the interchangeable lens unit is compatible with three-dimensional imaging, the menu setting section 126 restricts the use of the five functions that can be used in two-dimensional imaging (an example of imaging functions) in three-dimensional imaging.

The characteristic information acquisition section 143 (an example of a correction information acquisition section) acquires lens characteristic information F2, which indicates the characteristics of the optical system installed in the interchangeable lens unit 200, from the interchangeable lens unit 200. More specifically, the characteristic information acquisition section 143 acquires the above-mentioned lens characteristic information F2 from the interchangeable lens unit 200 when the camera-side determination section 144 has determined that the interchangeable lens unit 200 is compatible with three-dimensional imaging. The characteristic information acquisition section 143 temporarily stores the acquired lens characteristic information F2 in the DRAM 141, for example.

The state information acquisition section 145 acquires the lens state information F3 (imaging possibility flag) produced by the state information production section 243. This lens state information F3 is used in determining whether or not the interchangeable lens unit 200 is in a state that allows imaging. The state information acquisition section 145 temporarily stores the acquired lens state information F3 in the DRAM 141, for example.

The extraction position correction section 139 corrects the center positions of the extraction regions AL0 and AR0 on the basis of the extraction position correction amount L11. In the initial state, the center of the extraction region AL0 is set to the center ICL of the image circle IL, and the center of the extraction region AR0 is set to the center ICR of the image circle IR. The extraction position correction section 139 moves the extraction centers horizontally by the extraction position correction amount L11 from the centers ICL and ICR, and sets them to new extraction centers ACL2 and ACR2 (examples of recommended image extraction positions) as a reference for extracting left-eye image data and right-eye image data. The extraction regions using the extraction centers ACL2 and ACR2 as a reference are the extraction regions AL2 and AR2 shown in FIG. 9. Thus using the extraction position correction amount L11 to correct the positions of the extraction centers allows the extraction regions to be set according to the characteristics of the interchangeable lens unit, and allows a better stereo image to be obtained.

In this embodiment, since the interchangeable lens unit 200 has a zoom function, if the focal length changes as a result of zooming, the recommended convergence point distance L10 changes, and this is accompanied by a change in the extraction position correction amount L11. Therefore, the extraction position correction amount L11 may be recalculated by computation according to the zoom position.

More specifically, the lens controller 240 can ascertain the zoom position on the basis of the detection result of a zoom position sensor (not shown). The lens controller 240 sends the zoom position information to the camera controller 140 at a specific period. The zoom position information is temporarily stored in the DRAM 141.

Meanwhile, the extraction position correction section 139 calculates the extraction position correction amount suited to the focal length on the basis of the zoom position information, the recommended convergence point distance L10, the extraction position correction amount L11, for example. At this point, for example, information indicating the relation between the zoom position information, the recommended convergence point distance L10, and the extraction position correction amount L11 (such as a computational formula or a data table) may be stored in the camera body 100, or may be stored in the flash memory 242 of the interchangeable lens unit 200. Updating of the extraction position correction amount is carried out at a specific period. The updated extraction position correction amount is stored at a specific address in the DRAM 141. In this case, the extraction position correction section 139 corrects the center positions of the extraction regions AL0 and AR0 on the basis of the newly calculated extraction position correction amount, just as with the extraction position correction amount L11.

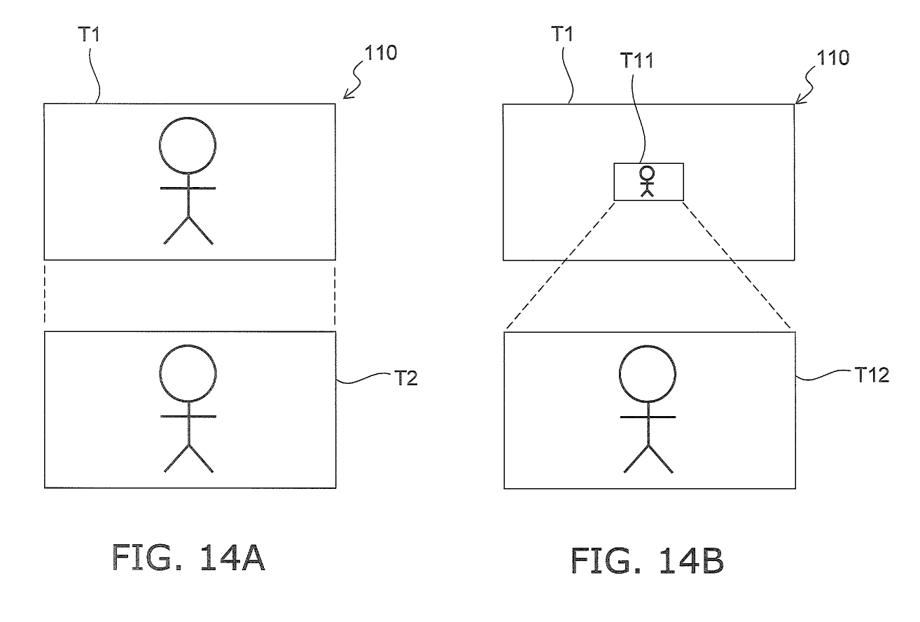

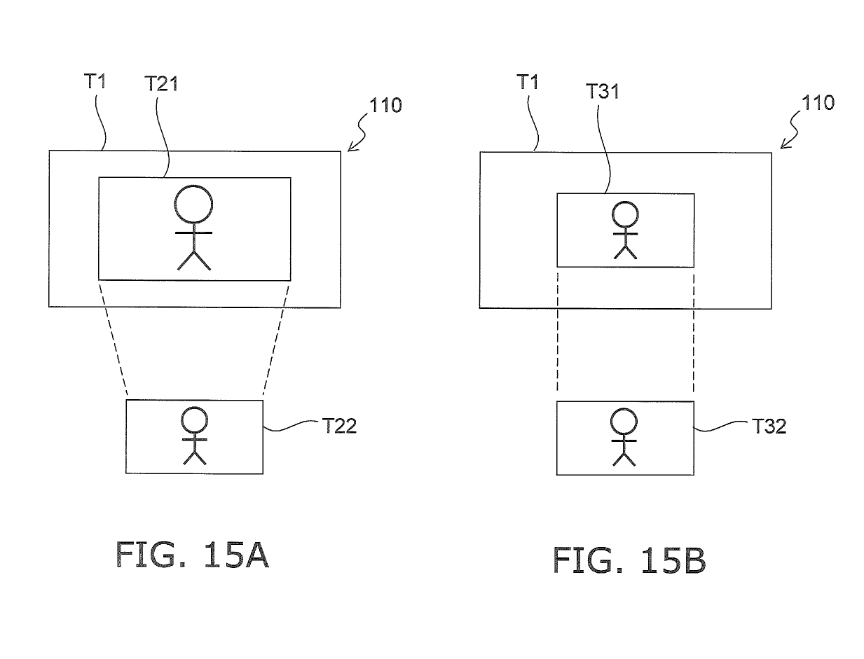

The camera monitor first region decision section 129 decides the extraction region for image data during two-dimensional imaging. More specifically, the first region decision section 129 decides the size and position of the extraction region used in extracting image data with the image extractor 16. For example, in the case of normal imaging, the first region decision section 129 sets the above-mentioned basic image region T1 (FIG. 14A) as the extraction region. On the other hand, when the digital zoom function is used, the first region decision section 129 sets the extracted image region T11 (FIG. 14B) as the extraction region. Furthermore, when the tele conversion function is used, the first region decision section 129 sets the extracted image region T21 or T31 (FIG. 15A or 15B) as the extraction region. The centers of the extracted image regions T11, T21, and T31 are set to the same position as the center of the basic image region T1.

The second region decision section 149 decides the extraction region for image data during three-dimensional imaging. More specifically, the second region decision section 149 decides the size and position of the extraction regions AL3 and AR3 used in extracting left-eye image data and right-eye image data with the image extractor 16. More specifically, the second region decision section 149 decides the size and position of the extraction regions AL3 and AR3 of the left-eye image data and the right-eye image data on the basis of the extraction centers ACL2 and ACR2 calculated by the extraction position correction section 139, the radius r of the image circles IL and IR, and the left-eye deviation amount DL and right-eye deviation amount DR included in the lens characteristic information F2.

Unlike the first region decision section 129, the second region decision section 149 is not compatible with a digital zoom function or tele conversion function. Therefore, the second region decision section 149 does not set the size of the extraction regions AL3 and AR3 within a range that is smaller than the normal image size as with the extracted image regions T11, T21, and T31. That is, it could also be said that the second region decision section 149 restricts the use of the digital zoom function and tele conversion function that can be used in two-dimensional imaging. It could also be said that the second region decision section 149 constitutes part of the function restrictor 127.

The second region decision section 149 may also decide the starting point for extraction processing on the image data, so that the left-eye image data and right-eye image data can be properly extracted, on the basis of a 180-degree rotation flag indicating whether or not the left-eye optical system and the right-eye optical system are rotated, a layout change flag indicating the left and right layout of the left-eye optical system and right-eye optical system, and a mirror inversion flag indicating whether or not the left-eye optical system and right-eye optical system have undergone mirror inversion.

The metadata production section 147 produces metadata with set stereo base and angle of convergence. The stereo base and angle of convergence are used in displaying a stereo image.

The image file production section 148 produces MPF stereo image files by combining left- and right-eye image data compressed by an image compressor 17 (discussed below). The image files thus produced are sent to the card slot 170 and stored in the memory card 171, for example.

(10) Image Processor 10

The image processor 10 has the signal processor 15, the image extractor 16, the correction processor 18, and the image compressor 17.

The signal processor 15 digitizes the image signal produced by the CMOS image sensor 110, and produces basic image data for the optical image formed on the CMOS image sensor 110. More specifically, the signal processor 15 converts the image signal outputted from the CMOS image sensor 110 into a digital signal, and subjects this digital signal to digital signal processing such as noise elimination or contour enhancement. The image data produced by the signal processor 15 is temporarily stored as raw data in the DRAM 141. Herein, the image data produced by the signal processor 15 shall be called basic image data.

The image extractor 16 extracts left-eye image data and right-eye image data from the basic image data produced by the signal processor 15. The left-eye image data corresponds to part of the left-eye optical image QL1 formed by the left-eye optical system OL. The right-eye image data corresponds to part of the right-eye optical image QR1 formed by the right-eye optical system OR. The image extractor 16 extracts left-eye image data and right-eye image data from the basic image data held in the DRAM 141, on the basis of the extraction regions AL3 and AR3 decided by the second region decision section 149. The left-eye image data and right-eye image data extracted by the image extractor 16 are temporarily stored in the DRAM 141.

The correction processor 18 performs distortion correction, shading correction, and other such correction processing on the image data during two-dimensional imaging. Also, if the dark area correction function and red-eye correction function are “on,” the correction processor 18 also performs dark area correction and red-eye correction are on the two-dimensional image. Meanwhile, shading correction and other such correction processing are performed on the left-eye image data and right-eye image data extracted during three-dimensional imaging. After this correction processing, the corrected two-dimensional image data, left-eye image data, and right-eye image data are temporarily stored in the DRAM 141.

The image compressor 17 performs compression processing on the corrected left- and right-eye image data stored in the DRAM 141, on the basis of a command from the camera controller 140. This compression processing reduces the image data to a smaller size than that of the original data. An example of the method for compressing the image data is the JPEG (Joint Photographic Experts Group) method in which compression is performed on the image data for each frame. The compressed left-eye image data and right-eye image data are temporarily stored in the DRAM 141.

Description of Imaging Functions

The digital camera 1 has the functions shown in FIGS. 12A, 12B, 13A, and 13B. A category is selected with the cross key 135 and the touch panel 138 on the menu screen, and then entered with the enter button 136. In three-dimensional imaging, the use of the digital zoom function, the tele conversion function, the highlighted display function, and the red-eye correction function is restricted.

The various functions whose use is restricted in three-dimensional imaging will now be briefly described.

(1) Digital Zoom Function

The digital zoom function is a function that zooms up on a subject by extracting and enlarging a partial region of the image data. In other words, with the digital zoom function, part of the image is cropped out to reduce the field angle. More specifically, as shown in FIG. 14A, in normal two-dimensional imaging, for example, captured image data T2 is obtained from the basic image region T1. The number of pixels in the basic image region T1 is the same as the number of pixels in the captured image data T2.

However, when the digital zoom function is used, as shown in FIG. 14B, the extracted image region T11, which is smaller in size than the captured image data T2, is cropped out from the basic image data of the basic image region T1, and the extracted image region T11 is enlarged to the same size as the captured image data T2 to obtain captured image data T12. The size of the extracted image region T11 is decided by the size of the captured image data T12 and the digital zoom ratio.

Thus, with the digital zoom function, a subject that cannot be completely zoomed in on with the optical zoom can be zoomed in on with the image data, allowing an image to be obtained in which a distant subject is enlarged. When the digital zoom function is used, however, the small extracted image region T11 is enlarged, so the resolution of the captured image data T12 is lower than the resolution of the captured image data T2.

(2) Teleconversion Function

The tele conversion function is a function that zooms up on a subject by extracting a partial region of the image data. In other words, with the tele conversion function, the field angle is reduced by cropping out part of the image data.

More specifically, as shown in FIG. 15A, when the field angle of the interchangeable lens unit 200 is relatively large, for example, an extracted image region T21 that is smaller than the basic image region T1 and larger than the captured image data T2 is cropped out from the basic image region T1 to reduce the extracted image region T21 and obtain a captured image data T22. The captured image data T22 is smaller in size than the captured image data T2.

Also, as shown in FIG. 15B, when the field angle of the interchangeable lens unit 200 is relatively small, an extracted image region T31 that is the same size as the captured image data T22 is cropped out from the basic image region T1, and a captured image data T32 is obtained without enlarging or reducing the extracted image region T31.

Thus, with the tele conversion function, the resolution of the image can be maintained while zooming up on a subject.

The difference between the tele conversion function and the digital zoom function is whether or not the extracted image data is enlarged. With the digital zoom function, the extracted image region T11 is enlarged, whereas with the tele conversion function, the extracted image regions T21 and T31 are not enlarged. This aspect clearly reveals the difference between the digital zoom function and the tele conversion function.

(3) Highlighted Display Function

The highlighted display function is a function that displays an image so that the region having brightness at or over a specific value is emphasized. More specifically, with the highlighted display function, a region that is overexposed in the confirmation display of a captured image, for example, is displayed flashing in black and white in order to make it easier to pinpoint the overexposed region in the captured image. An overexposed region is, for example, a region in which the brightness has reached the maximum value, or a region in which the brightness is at or over a threshold close to the maximum value. The highlighted display function can be utilized not only for the confirmation display of a captured image, but also in reproducing a captured image after recording.

(4) Dark Area Correction Function

The dark area correction function is a function that corrects a region of low brightness so that the brightness is increased. More precisely, with the dark area correction function, a region in which the brightness is low and gradation has been lost is corrected so that a certain amount of gradation is ensured. For example, the image data is divided into a plurality of unit regions, and whether or not the brightness is low is determined for each of the unit regions. In unit regions of low brightness, the brightness data for each of the pixels is corrected so that the brightness is increased. This improves the gradation of regions of low brightness.

This dark area correction processing can also be performed on all of the basic image data, and furthermore it can be performed on a partial region extracted from the basic image data. For example, dark area correction processing can be performed on the extracted image regions T11, T21, and T31 and the captured image data T22 and T32 shown in FIGS. 14B, 15A, and 15B.

(5) Red-Eye Correction Function

The red-eye correction function is a function that corrects eyes that appear red to the proper color. More specifically, with the red-eye correction function, a region corresponding to the face of a person (facial region) is detected by facial recognition technology. A red dot is detected as red-eye from the detected facial region. Furthermore, the detected red-eye is corrected to the proper color. This allows red-eye to be corrected to the proper color even though an eye appears red due to a flash.

Operation of Digital Camera

(1) When Power is on

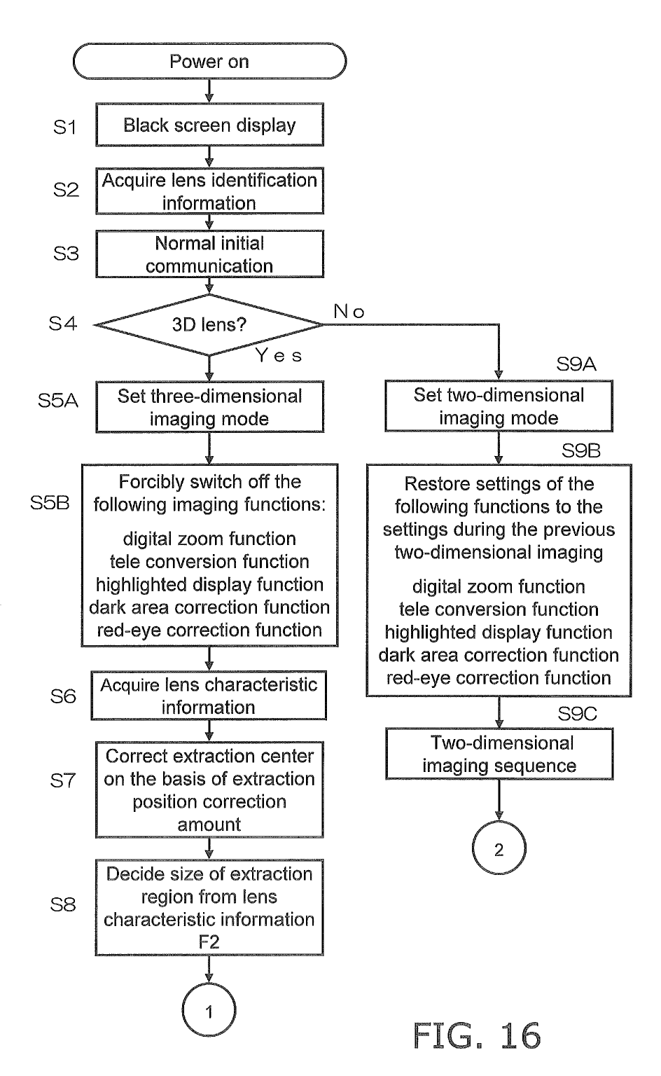

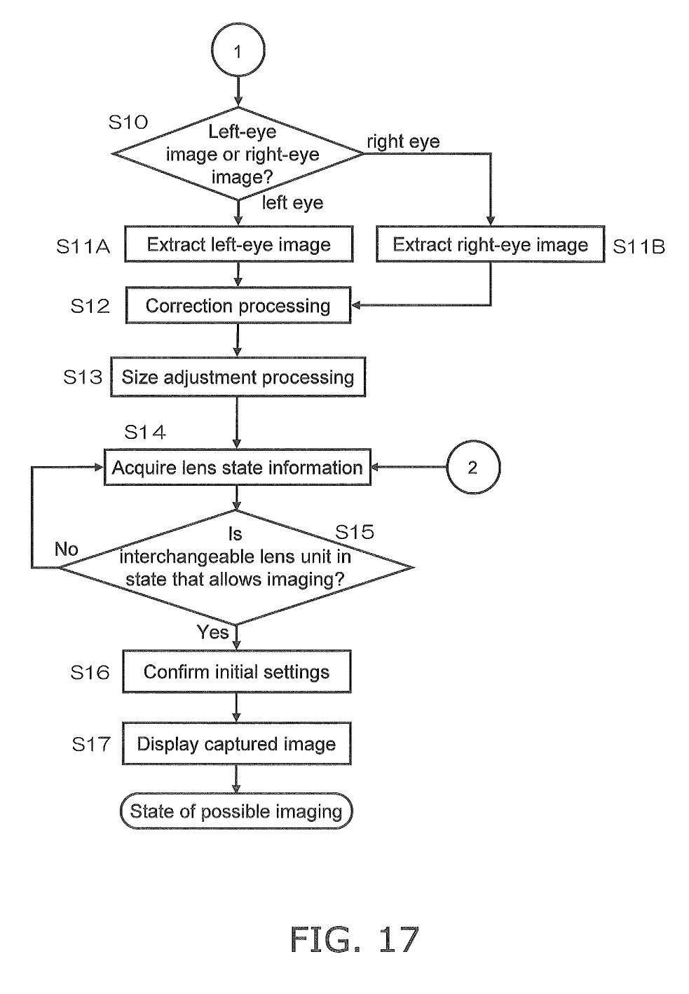

Determination of whether or not the interchangeable lens unit 200 is compatible with three-dimensional imaging is possible either when the interchangeable lens unit 200 is mounted to the camera body 100 in a state in which the power to the camera body 100 is on, or when the power is turned on to the camera body 100 in a state in which the interchangeable lens unit 200 has been mounted to the camera body 100. Here, the latter case will be used as an example to describe the operation of the digital camera 1 through reference to the flowcharts in FIGS. 8A, 8B, 16, and 17. Of course, the same operation may also be performed in the former case.

When the power is turned on, a black screen is displayed on the camera monitor 120 under control of the display controller 125, and the blackout state of the camera monitor 120 is maintained (step S1). Next, the identification information acquisition section 142 of the camera controller 140 acquires the lens identification information F1 from the interchangeable lens unit 200 (step S2). More specifically, as shown in FIGS. 8A and 8B, when the mounting of the interchangeable lens unit 200 is detected by the lens detector 146 of the camera controller 140, the camera controller 140 sends a model confirmation command to the lens controller 240. This model confirmation command is a command that requests the lens controller 240 to send the status of a three-dimensional imaging determination flag for the lens identification information F1. As shown in FIG. 8B, since the interchangeable lens unit 200 is compatible with three-dimensional imaging, upon receiving the model confirmation command, the lens controller 240 sends the lens identification information F1 (three-dimensional imaging determination flag) to the camera body 100. The identification information acquisition section 142 temporarily stores the status of this three-dimensional imaging determination flag in the DRAM 141.

Next, normal initial communication is executed between the camera body 100 and the interchangeable lens unit 200 (step S3). This normal initial communication is also performed between the camera body and an interchangeable lens unit that is not compatible with three-dimensional imaging. For example, information related to the specifications of the interchangeable lens unit 200 (its focal length, F stop value, etc.) is sent from the interchangeable lens unit 200 to the camera body 100.

After this normal initial communication, the camera-side determination section 144 determines whether or not the interchangeable lens unit 200 mounted to the body mount 150 is compatible with three-dimensional imaging (step S4). More specifically, the camera-side determination section 144 determines whether or not the mounted interchangeable lens unit 200 is compatible with three-dimensional imaging on the basis of the lens identification information F1 (three-dimensional imaging determination flag) acquired by the identification information acquisition section 142.

If the mounted interchangeable lens unit is not compatible with three-dimensional imaging, information indicating that the interchangeable lens unit is not compatible with three-dimensional imaging is stored by the camera-side determination section 144 at a specific address of the RAM 240c, and the imaging mode is set to two-dimensional imaging mode (step S9A). At this point, if the five functions comprising the digital zoom function, the tele conversion function, the highlighted display function, the dark area correction function, and the red-eye correction function have been forcibly set to “off” by the menu setting section 126 (discussed below), then the five functions comprising the digital zoom function, the tele conversion function, the highlighted display function, the dark area correction function, and the red-eye correction function are restored by the menu setting section 126 to the same state as during the previous two-dimensional imaging (step S9B). The setting during the previous two-dimensional imaging is temporarily stored in the DRAM 141, for example. Then, the normal sequence corresponding to two-dimensional imaging is executed, and the processing moves to step S14 (step S9C).

If the interchangeable lens unit 200 is removed from the camera body 100, the menu setting section 126 may automatically restore the five functions comprising the digital zoom function, the tele conversion function, the highlighted display function, the dark area correction function, and the red-eye correction function to the same state as during the previous two-dimensional imaging. That is, the above-mentioned five functions may be forcibly set to “off” only when an interchangeable lens unit 200 compatible with three-dimensional imaging has been mounted to the camera body 100.

Meanwhile, if the mounted interchangeable lens unit is compatible with three-dimensional imaging, information indicating that the interchangeable lens unit is compatible with three-dimensional imaging is stored by the camera-side determination section 144 at a specific address of the RAM 240c, and the imaging mode is set to the three-dimensional imaging mode (step S5A). At this point, the five functions comprising the digital zoom function, the tele conversion function, the highlighted display function, the dark area correction function, and the red-eye correction function are forcibly set to “off” by the menu setting section 126 (step S5B). The off state is maintained for those functions that have been set to off.

After the determination result of the camera-side determination section 144 has been stored in the RAM 240c, the characteristic information acquisition section 143 acquires the lens characteristic information F2 from the interchangeable lens unit 200 (step S6). More specifically, as shown in FIG. 8B, a characteristic information send command is sent from the characteristic information acquisition command 143 to the lens controller 240. This characteristic information acquisition command is a command that requests the transmission of the lens characteristic information F2. When it receives this command, the camera controller 140 sends the lens characteristic information F2 to the camera controller 140. The characteristic information acquisition section 143 stores the lens characteristic information F2 in the DRAM 141, for example.

After acquisition of the lens characteristic information F2, the positions of the extraction centers of the extraction regions AL0 and AR0 are corrected by the extraction position correction section 139 on the basis of the lens characteristic information F2 (step S7). More specifically, the extraction positions of the extraction regions AL0 and AR0 are corrected by the extraction position correction section 139 on the basis of the extraction position correction amount L11 (or an extraction position correction amount newly calculated from the extraction position correction amount L11). The extraction position correction section 139 sets new extraction centers ACL2 and ACR2 as references for exacting the left-eye image data and right-eye image data, by moving the extraction centers horizontally by the extraction position correction amount L11 (or an extraction position correction amount newly calculated from the extraction position correction amount L11) from the centers ICL and ICR.

Furthermore, the second region decision section 149 decides the size and extraction method for the extraction regions AL3 and AR3 on the basis of the lens characteristic information F2 (step S8). For example, as discussed above, the second region decision section 149 decides the size of the extraction regions AL3 and AR3 on the basis of the optical axis position, the effective imaging area (radius r), the left-eye deviation amount DL, the right-eye deviation amount DR, and the size of the CMOS image sensor 110. For example, the size of the extraction regions AL3 and AR3 is decided by the second region decision section 149 on the basis of the above-mentioned information so that the extraction regions AL3 and AR3 will fit within the lateral imaging-use extractable range AL11.

Furthermore, a critical convergence point distance L12 and an extraction point critical correction amount L13 may be used when the second region decision section 149 decides the size of the extraction regions AL3 and AR3.

The second region decision section 149 may also decide the extraction method, that is, which of the images of the extraction regions AL3 and AR3 will be extracted as the right-eye image data, whether the image will be rotated, and whether the image will be mirror-inverted.

Furthermore, an image for live view display is selected from the left- and right-eye image data (step S10). For example, the user may be prompted to select from left- and right-eye image data, or one may be predetermined in the camera controller 140 and set for display use. The selected image data is set as a display-use image, and extracted by the image extractor 16 (step S11A or 11B).

Then, the extracted image data is subjected to shading correction or other such correction processing by the correction processor 18 (step S12). The corrected image data is then subjected to size adjustment processing by the display controller 125, and display-use image data is produced (step S13). This display-use image data is temporarily stored in the DRAM 141.

After this, whether or not the interchangeable lens unit is in a state that allows imaging is confirmed by the state information acquisition section 145 (step S14). More specifically, with the interchangeable lens unit 200, when the lens-side determination section 244 receives the above-mentioned characteristic information transmission command, the lens-side determination section 244 determines that the camera body 100 is compatible with three-dimensional imaging (see FIG. 8B). Meanwhile, the lens-side determination section 244 determines that the camera body is not compatible with three-dimensional imaging if no characteristic information transmission command has been sent from the camera body within a specific period of time (see FIG. 8A).

The state information production section 243 sets the status of an imaging possibility flag (an example of standby information) indicating whether or not the three-dimensional optical system G is in the proper imaging state, on the basis of the determination result of the lens-side determination section 244. The state information production section 243 sets the status of the imaging possibility flag to “possible” upon completion of the initialization of the various components if the lens-side determination section 244 has determined that the camera body is compatible with three-dimensional imaging (FIG. 8B). On the other hand, the state information production section 243 sets the status of the imaging possibility flag to “impossible,” regardless of whether or not the initialization of the various components has been completed, if the lens-side determination section 244 has determined that the camera body is not compatible with three-dimensional imaging (see FIG. 8A). In step S14, if a command is sent that requests the transmission of status information about the imaging possibility flag from the state information acquisition section 145 to the lens controller 240, the state information production section 243 sends status information about the imaging possibility flag to the camera controller 140. The status information about the imaging possibility flag is sent to the camera controller 140. With the camera body 100, the state information acquisition section 145 temporarily stores the status information about the imaging possibility flag sent from the lens controller 240 at a specific address in the DRAM 141.

Further, the state information acquisition section 145 determines whether or not the interchangeable lens unit 200 is in a state that allows imaging, on the basis of the stored imaging possibility flag (step S15). If the interchangeable lens unit 200 is not in a state that allows imaging, the processing of steps S14 and S15 is repeated for a specific length of time. On the other hand, if the interchangeable lens unit 200 is in a state that allows imaging, the display-use image data produced in step S9C or the display-use image data produced in step S13 is displayed as a visible image on the camera monitor 120 after confirmation of the initial settings (steps S16 and S17). From step S17 onward, if the interchangeable lens unit is not compatible with three-dimensional imaging, for example, a two-dimensional image is displayed in live view on the camera monitor 120. On the other hand, if the interchangeable lens unit is compatible with three-dimensional imaging, a left-eye image, a right-eye image, an image that is a combination of a left-eye image and a right-eye image, or a three-dimensional display using a left-eye image and a right-eye image is displayed in live view on the camera monitor 120.

(2) Menu Screen Setting

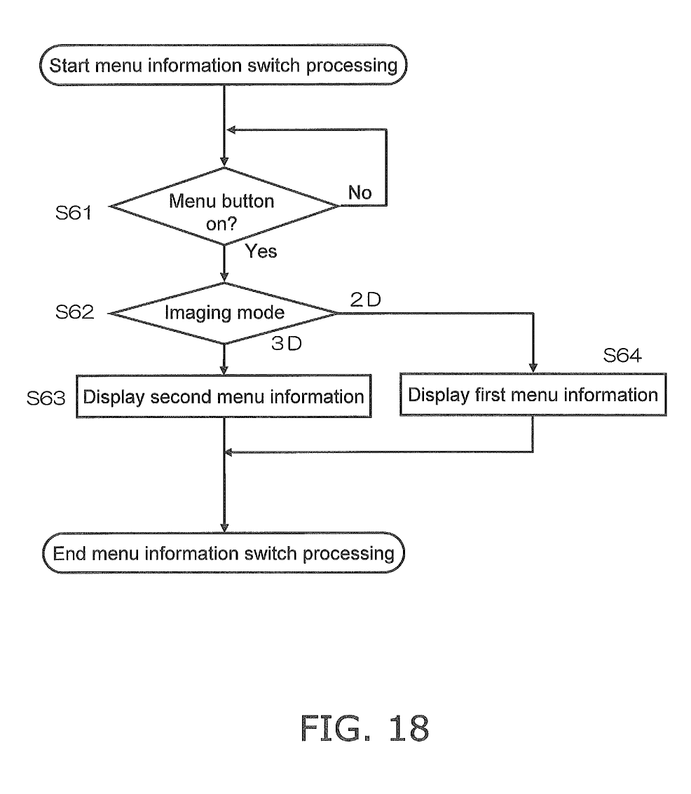

Menu screen setting during two-dimensional imaging and three-dimensional imaging will now be described through reference to FIG. 18.

As shown in FIG. 18, when the menu button (the enter button 136) is pressed, the imaging mode is confirmed by the menu setting section 126 (steps S61 and S62). More specifically, the menu setting section 126 checks the determination result of the camera-side determination section 144 stored at a specific address in the RAM 240c. If the determination result indicates the three-dimensional imaging mode (or if it indicates that the interchangeable lens unit is compatible with three-dimensional imaging), the second menu information is selected by the menu setting section 126, and the selected second menu information is displayed on the camera monitor 120 (step S63). At this point, as shown in FIGS. 12B and 13B, the digital zoom function, the tele conversion function, the highlighted display function, the dark area correction function, and the red-eye correction function are grayed out, and these five functions cannot be selected even if the user attempts to select them with the cross key 135 or the touch panel 138.

Meanwhile, if the determination result indicates two-dimensional imaging mode (or if it indicates that the interchangeable lens unit is compatible with three-dimensional imaging), the first menu information is selected by the menu setting section 126, and the selected first menu information is displayed on the camera monitor 120 (step S64). In this case, as shown in FIGS. 12A and 12B, the user can select the digital zoom function, the tele conversion function, the highlighted display function, the dark area correction function, and the red-eye correction function.

(3) Two-Dimensional Still Picture Imaging

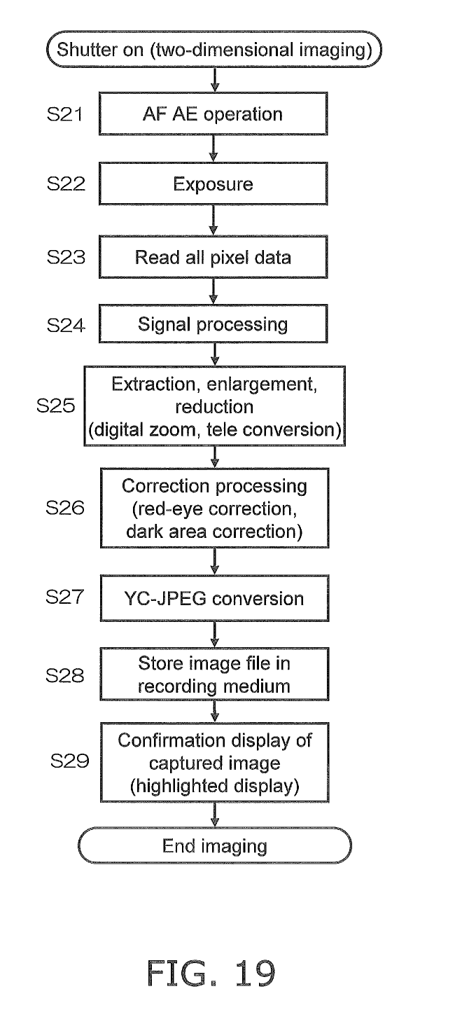

Next, the operation during two-dimensional still picture imaging will be described through reference to FIG. 19.

When the user presses the release button 131, autofocusing (AF) and automatic exposure (AE) are executed, and then exposure is commenced (steps S21 and S22). An image signal from the CMOS image sensor 110 (full pixel data) is taken in by the signal processor 15, and the image signal is subjected to AD conversion or other such signal processing by the signal processor 15 (steps S23 and S24). The basic image data produced by the signal processor 15 is temporarily stored in the DRAM 141.

Next, the captured image data is extracted from the basic image data by the image extractor 16 (step S25). For example, if the digital zoom function is on, as shown in FIG. 14B, the image data for the extracted image region T11 is extracted from the basic image region T1, and the image data for the extracted image region T11 is enlarged to the captured image data T12.

Also, if the tele conversion function is on, as shown in FIG. 15A, the image data for the extracted image region T21 is extracted from the basic image region T1, and the image data for the extracted image region T21 is reduced to the captured image data T22. As shown in FIG. 15B, depending on the focal length of the interchangeable lens unit, the image data for the extracted image region T31 is extracted from the basic image region T1, and the image data for the extracted image region T31 is directly outputted as the captured image data T32.

The correction processor 18 then subjects the captured image data T2, T12, T22, or T32 to correction processing. More specifically, the correction processor 18 subjects the captured image to distortion correction, and shading correction, and also subjects it to red-eye correction, dark area correction, or other such optional correction processing according to the settings on the menu screen shown in FIG. 13A (step S26). The corrected image data is subjected to JPEG compression or other such compression processing by the image compressor 17 (step S27). The image files produced by compression processing are sent to the card slot 170 and stored in the memory card 171, for example (step S28).

After the image files have been stored in the memory card 171, the captured images are displayed for a predetermined length of time on the camera monitor 120 to check the captured images (step S29). At this point, for example, if highlighted display is set to “on” on the menu screen shown in FIG. 12B, then any region that is overexposed is displayed flashing black and white in the display of the captured image on the camera monitor 120. This makes it easy for the user to recognize the there is an overexposed region.

(4) Three-Dimensional Still Picture Imaging

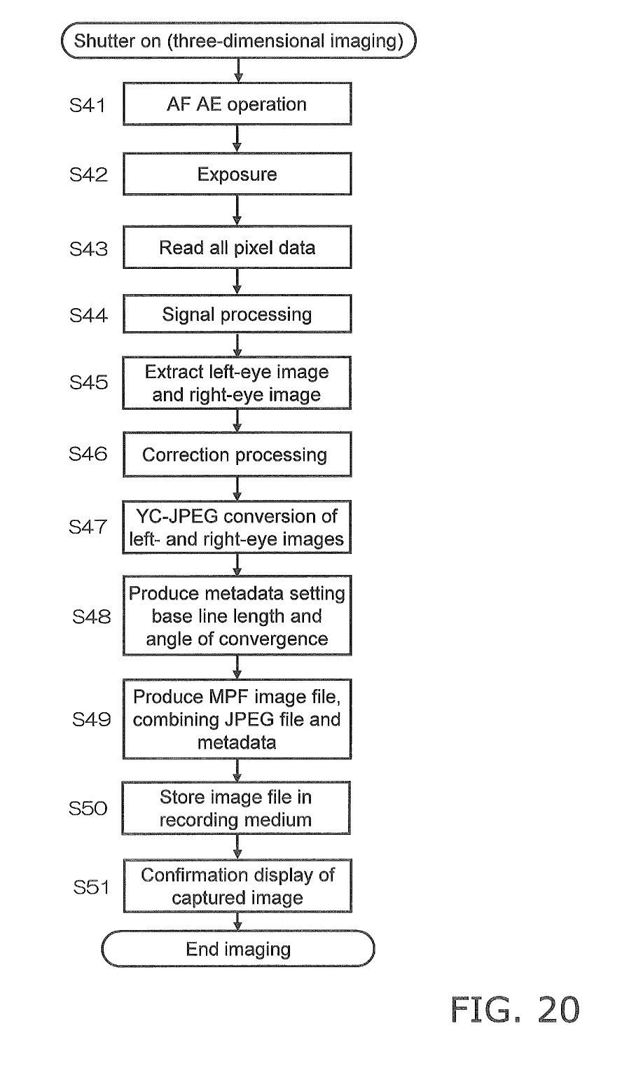

The operation during three-dimensional still picture imaging will now be described through reference to FIG. 20.

When the user presses the release button 131, autofocusing (AF) and automatic exposure (AE) are executed, and then exposure is commenced (steps S41 and S42). An image signal from the CMOS image sensor 110 (full pixel data) is taken in by the signal processor 15, and the image signal is subjected to AD conversion or other such signal processing by the signal processor 15 (steps S43 and S44). The basic image data produced by the signal processor 15 is temporarily stored in the DRAM 141.

Next, left-eye image data and right-eye image data are extracted from the basic image data by the image extractor 16 (step S45). The sizes, positions, and extraction method of the extraction regions AL3 and AR3 at this point are what was decided in steps S6 and S7.

The correction processor 18 subjects the extracted left-eye image data and right-eye image data to correction processing, and the image compressor 17 performs JPEG compression or other such compression processing on the left-eye image data and right-eye image data (steps S46 and S47).

After compression, the metadata production section 147 of the camera controller 140 produces metadata setting the stereo base and the angle of convergence (step S48).

After metadata production, the compressed left- and right-eye image data are combined with the metadata, and MPF image files are produced by the image file production section 148 (step S49). The produced image files are sent to the card slot 170 and stored in the memory card 171, for example (step S50). If these image files are displayed in 3D using the stereo base and the angle of convergence, the displayed image can be seen in 3D view using special glasses or the like.

After an image file has been stored in the memory card 171, a captured image is displayed on the camera monitor 120 for a predetermined length of time in order to check the captured image (step S51). At this point, the left-eye image, the right-eye image, or the three-dimensional image obtained using the left-eye image and right-eye image is displayed on the camera monitor 120.

Features of Camera Body

The features of the camera body 100 described above are compiled below.

(1) With the camera body 100, if the camera-side determination section 144 has determined that the interchangeable lens unit is compatible with three-dimensional imaging, the function restrictor 127 restricts the functions that can be used in two-dimensional imaging from being used in three-dimensional imaging, so by restricting the use of any functions that would affect the production of a proper stereo image or the obtaining of a good 3D view, it is less likely that the production of a proper stereo image or the obtaining of a good 3D view will be affected by these functions. Accordingly, using this configuration provides the camera body 100 that is better suited to three-dimensional imaging.

The phrase “affect the obtaining of a good 3D view” here means, for example, that the 3D view looks extremely unnatural to the user.

(2) If the camera-side determination section 144 has determined that the interchangeable lens unit is compatible with three-dimensional imaging, the menu setting section 126 selects the second menu information as the menu screen to be displayed on the camera monitor 120 or the electronic viewfinder 180 on the basis of the determination result of the camera-side determination section 144.

On the other hand, if the camera-side determination section 144 has determined that the interchangeable lens unit is not compatible with three-dimensional imaging, the menu setting section 126 selects the first menu information as the menu screen to be displayed on the camera monitor 120 or the electronic viewfinder 180 on the basis of the determination result of the camera-side determination section 144.

Thus using different menu information for two-dimensional imaging and three-dimensional imaging allows imaging functions that can be used in two-dimensional imaging to be easily restricted from being used in three-dimensional imaging.

(3) When the second menu information is displayed on the camera monitor 120 or the electronic viewfinder 180, the imaging functions are displayed on the camera monitor 120 or the electronic viewfinder 180, but cannot be selected by the user. More specifically, the menu setting section 126 permits the display of imaging functions, but only displays them and does not include imaging functions in the functions that can be selected. Therefore, this prevents the user from accidentally selecting an imaging function during three-dimensional imaging.

Also, as shown in FIGS. 12B and 13B, when the second menu information is displayed on the camera monitor 120 or the electronic viewfinder 180, imaging functions are displayed in a different color from that of other functions included in the second menu information, which makes it easier for the user to recognize functions that cannot be selected.

(4) When the digital zoom function is used during three-dimensional imaging, there is the possibility that the amount of deviation in the left-eye image and right-eye image will be amplified during enlargement processing. Furthermore, if a stereo image captured using the digital zoom function is displayed three-dimensionally, the amount of deviation in the left-eye image and right-eye image is further amplified as compared to when the digital zoom function is not used. If the amount of deviation in the left-eye image and right-eye image is amplified, the proper stereo image cannot be produced, and the 3D view will also be unfavorably affected.

With this camera body 100, however, since the use of the digital zoom function is restricted in three-dimensional imaging, there is no amplification of the amount of deviation in the left-eye image and right-eye image, and a proper stereo image can be produced.

(5) When the tele conversion function is used in three-dimensional imaging, since the extracted image regions T21 and T31 are smaller than the basic image region T1, in the three-dimensional display of a stereo image, the amount of deviation between the left-eye image and right-eye image on the display is amplified over that when the tele conversion function is not used. It is undesirable for the amount of deviation between the left-eye image and right-eye image to be amplified because it hinders obtaining a proper 3D view.

With this camera body 100, however, since the use of the tele conversion function is restricted in three-dimensional imaging, there is no amplification of the amount of deviation between the left-eye image and right-eye image, and a proper 3D view can be obtained.

(6) Since there is parallax between the left-eye image and right-eye image, if the highlighted display function is used during three-dimensional imaging, there is the possibility that the position of the overexposed region will be different between the left-eye image and right-eye image. If the position of the overexposed region is different on the left and right, a proper highlighted display may be impossible. In particular, when three-dimensional display is performed on the camera monitor 120, it is conceivable that the region in highlighted display cannot be correctly viewed in 3D.

With this camera body 100, however, the above problem is eliminated since the use of the highlighted display function is restricted in three-dimensional imaging.

(7) Since there is parallax between the left-eye image and right-eye image, if the dark area correction function is used during three-dimensional imaging, there is the possibility that the position of the region in which dark area correction is performed will be different between the left-eye image and right-eye image. If the position of the region in which dark area correction is performed is different on the left and right, there is the possibility that obtaining a good 3D view will be hindered in performing three-dimensional display on the camera monitor 120.

With this camera body 100, however, the above problem is eliminated since the use of the dark area correction function is restricted in three-dimensional imaging.

(8) Since there is parallax between the left-eye image and right-eye image, if the red-eye correction function is used during three-dimensional imaging, there is the possibility that the position of the region in which red-eye correction is performed (more precisely, the position of the red-eye) will be different between the left-eye image and right-eye image. If the position of the region in which red-eye correction is performed is different on the left and right, there is the possibility that obtaining a good 3D view will be hindered in performing three-dimensional display on the camera monitor 120.

With this camera body 100, however, the above problem is eliminated since the use of the red-eye correction function is restricted in three-dimensional imaging.

### Modification Examples

The present invention is not limited to the embodiment given above, and various modifications and changes are possible without departing from the scope of the invention.

(A) An imaging device and a camera body were described using as an example the digital camera 1 having no mirror box, but compatibility with three-dimensional imaging is also possible with a digital single lens reflex camera having a mirror box. The imaging device may be one that is capable of capturing not only of still pictures, but also moving pictures.

(B) An interchangeable lens unit was described using the interchangeable lens unit 200 as an example, but the constitution of the three-dimensional optical system is not limited to that in the above embodiment. As long as imaging can be handled with a single imaging element, the three-dimensional optical system may have some other constitution.

(C) The three-dimensional optical system G is not limited to a side-by-side imaging system, and a time-division imaging system may instead be employed as the optical system for the interchangeable lens unit, for example. Also, in the above embodiment, an ordinary side-by-side imaging system was used as an example, but a horizontal compression side-by-side imaging system in which left- and left-eye images are compressed horizontally, or a rotated side-by-side imaging system in which left- and right-eye images are rotated 90 degrees may be employed.

(D) In the first embodiment above, the camera-side determination section 144 determines whether or not the interchangeable lens unit is compatible with three-dimensional imaging on the basis of the three-dimensional imaging determination flag for the lens identification information F1. That is, the camera-side determination section 144 performs its determination on the basis of information to the effect that the interchangeable lens unit is compatible with three-dimensional imaging.

However, the determination of whether or not the interchangeable lens unit is compatible with three-dimensional imaging may be performed using some other information. For instance, if information indicating that the interchangeable lens unit is compatible with two-dimensional imaging is included in the lens identification information F1, it may be concluded that the interchangeable lens unit is not compatible with three-dimensional imaging.

Also, whether or not the interchangeable lens unit is compatible with three-dimensional imaging may be determined on the basis of a lens ID stored ahead of time in the lens controller 240 of the interchangeable lens unit. The lens ID may be any information with which the interchangeable lens unit can be identified. An example of a lens ID is the model number of the interchangeable lens unit product. If a lens ID is used to determine whether or not the interchangeable lens unit is compatible with three-dimensional imaging, then a list of lens ID's is stored ahead of time in the camera controller 140, for example. This list indicates which interchangeable lens units are compatible with three-dimensional imaging, and the camera-side determination section 144 compares this list with the lens ID acquired from the interchangeable lens unit to determine whether or not the interchangeable lens unit is compatible with three-dimensional imaging. Thus, a lens ID can also be used to determine whether or not an interchangeable lens unit is compatible with three-dimensional imaging. Furthermore, this list can be updated to the most current version by software updating of the camera controller 140, for example.

(E) The above-mentioned interchangeable lens unit 200 may be a single focus lens. In this case, the extraction centers ACL2 and ACR2 can be found by using the above-mentioned extraction position correction amount L11. Furthermore, if the interchangeable lens unit 200 is a single focus lens, then zoom lenses 210L and 210R may be fixed, for example, and this eliminates the need for a zoom ring 213 and zoom motors 214L and 214R.

(F) In the above embodiment, the use of the five functions comprising the digital zoom function, the tele conversion function, the highlighted display function, the dark area correction function, and the red-eye correction function was restricted, but the use of one or more of these functions may be restricted in three-dimensional imaging. Also, the use of some function other than these five may be restricted.

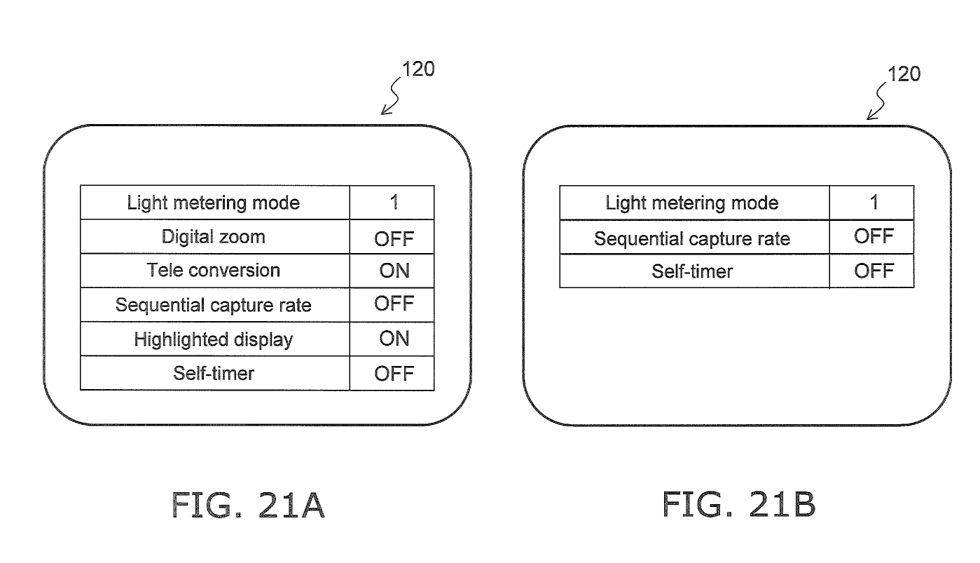

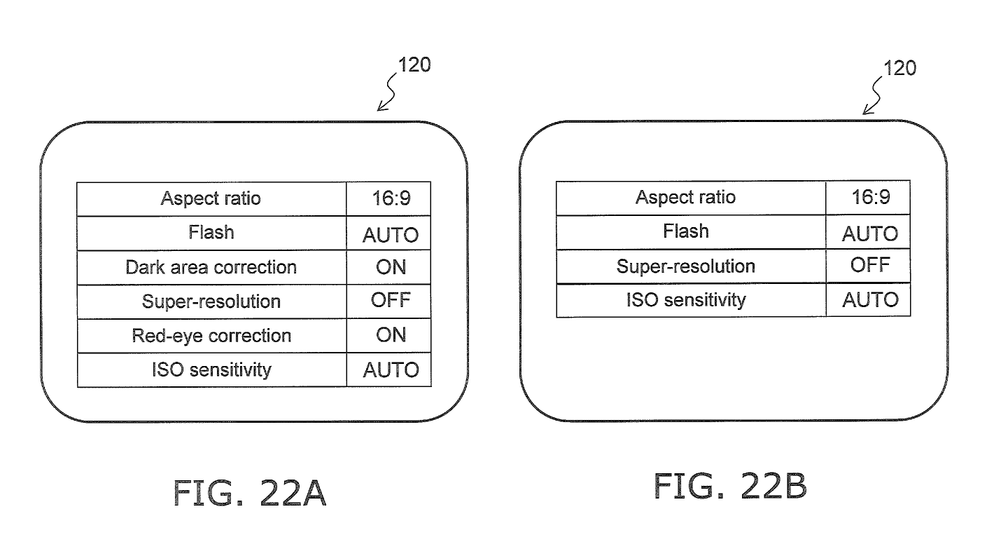

(G) In the above embodiment, as shown in FIGS. 12B and 13B, the functions whose use was restricted in three-dimensional imaging mode were grayed out in display, but as shown in FIGS. 21B and 22B, a constitution is also possible in which functions whose use is restricted in three-dimensional imaging mode are not displayed on the display section. In this case, the functions whose use is restricted are included in the first menu information 126A, but are excluded from the second menu information 126B. With the menu screen shown in FIGS. 21B and 22B, functions whose use is restricted are just not displayed on the menu screen, but along with not displaying these functions, the layout of the functions displayed on one screen may also be modified.

Furthermore, a situation is possible in which the menu screen does not change between two-dimensional imaging and three-dimensional imaging. In this case, the menu screen may be the same for both two-dimensional imaging and three-dimensional imaging, but the user cannot select certain functions during three-dimensional imaging. More specifically, the system may be designed so that the above-mentioned digital zoom function, tele conversion function, highlighted display function, dark area correction function, and red-eye correction function cannot be selected by the user in three-dimensional imaging mode even though they are displayed on the menu screen as shown in FIGS. 21A and 22A.

FIGS. 21A and 22AS correspond to FIGS. 12A and 13A.

With this camera body, when the camera-side determination section has determined that the interchangeable lens unit is compatible with three-dimensional imaging, the use of one or more imaging functions that can be used in two-dimensional imaging is restricted by the function restrictor in three-dimensional imaging, so the use of functions that might affect the production of a suitable stereo image or the obtaining of a suitable 3D view is restricted, which makes it less likely that the production of a stereo image or the obtaining of a 3D view will be affected by these functions.

In addition, it is less likely that the production of a stereo image or the obtaining of a 3D view will be affected by these functions with an imaging device having this camera body.

### Second Embodiment

In the first embodiment above, the use of the five functions comprising the digital zoom function, the tele conversion function, the highlighted display function, the dark area correction function, and the red-eye correction function was restricted, but it is also possible that the use of some function other than these five is restricted in three-dimensional imaging. A camera body 400 pertaining to a second embodiment will now be described.

Those components having substantially the same function as the components in the first embodiment above will be numbered the same and will not be described again in detail.

Configuration of Camera Body

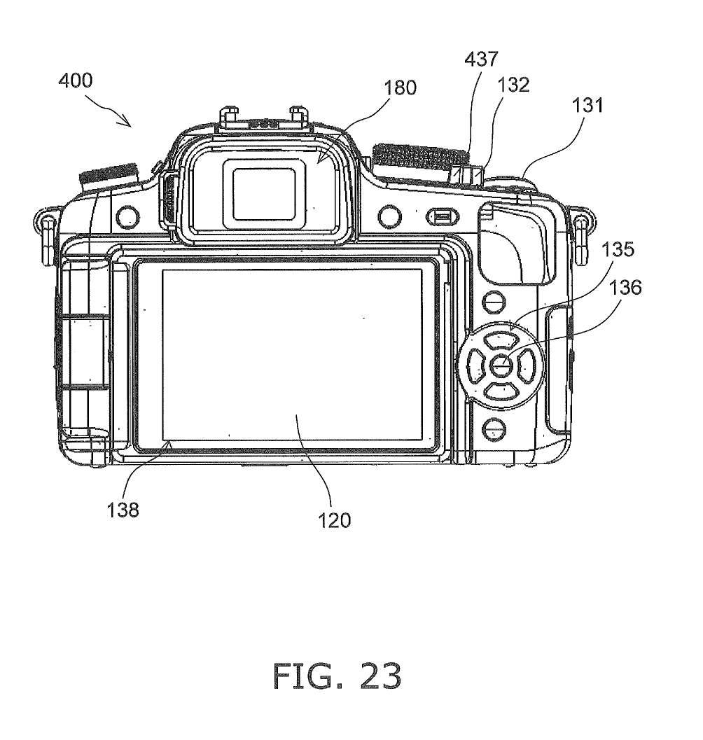

As shown in FIGS. 23 to 25, the camera body 400 has the same basic configuration as the above-mentioned camera body 100, but a few components are different. More specifically, a manipulation unit 430 (an example of a manipulation unit) has a release button 131, a power switch 132, a cross key 135, an enter button 136, an imaging selection lever 437, and a touch panel 138.

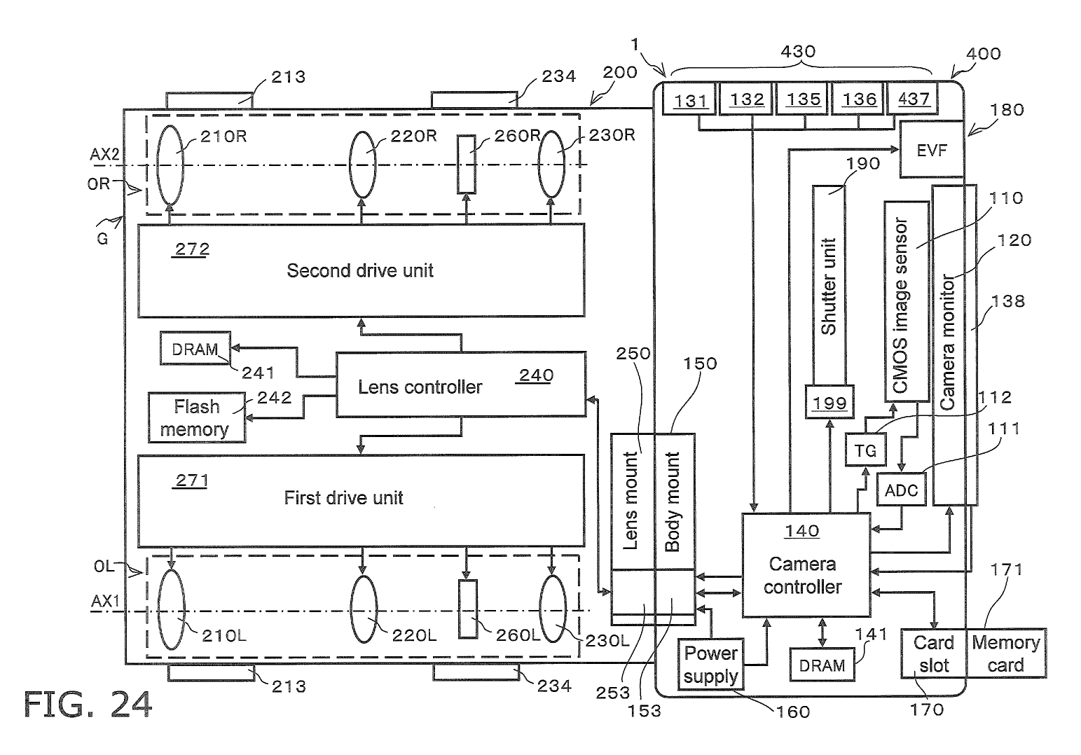

The imaging selection lever 437 (see FIGS. 23 and 24) is used to switch between a single capture mode, a sequential capture mode, and a bracket imaging mode. The imaging selection lever 437 is electrically connected to a camera controller 440. In single capture mode, a single image (a single stereo image in the case of three-dimensional imaging) can be acquired when the release button 131 is pressed once. In sequential capture mode, a plurality of images (a plurality of stereo images in the case of three-dimensional imaging) can be acquired when the release button 131 is pressed once. In bracket imaging mode, a plurality of images (a plurality of stereo images in the case of three-dimensional imaging) can be acquired while the imaging conditions are varied in stages when the release button 131 is pressed once (exposure bracket imaging, ISO sensitivity bracket imaging, etc.). Also, in bracket imaging mode, a plurality of images that have been processed under different image processing conditions (white balance, aspect ratio) can be acquired all at once when the release button 131 is pressed once (white balance bracket imaging, aspect ratio bracket imaging, etc.). The sequential capture function and bracket imaging function can be defined as imaging functions with which a plurality of images can be acquired all at once. These imaging functions will be described in detail below.

Here, the phrase “function with which a plurality of images are acquired all at once” means a function with which a plurality of images are acquired within a relatively short time, and a case in which a plurality of images are acquired when the release button 131 is pressed once is included, for example, in these imaging functions. Therefore, a moving picture imaging function is not included in the “function with which a plurality of images are acquired all at once.”

The various components of the manipulation unit 430 may be made up of buttons, levers, dials, or the like, as long as they can be operated by the user.

The camera controller 440 controls the entire camera body 100. The camera controller 440 is electrically connected to the manipulation unit 430. Manipulation signals from the manipulation unit 430 are inputted to the camera controller 440. The camera controller 440 uses the DRAM 141 as a working memory during control operation or image processing operation.

Also, the camera controller 440 sends signals for controlling the interchangeable lens unit 200 through the body mount 150 and the lens mount 250 to the lens controller 240, and indirectly controls the various components of the interchangeable lens unit 200. The camera controller 440 also receives various kinds of signal from the lens controller 240 via the body mount 150 and the lens mount 250.

The camera controller 440 has a CPU 140a, a ROM 140b, and a RAM 140c just like the above-mentioned camera controller 140, and can perform various functions by reading the programs stored in the ROM 140b into the CPU 140a.

Details of Camera Controller 440

The functions of the camera controller 440 will now be described in detail.

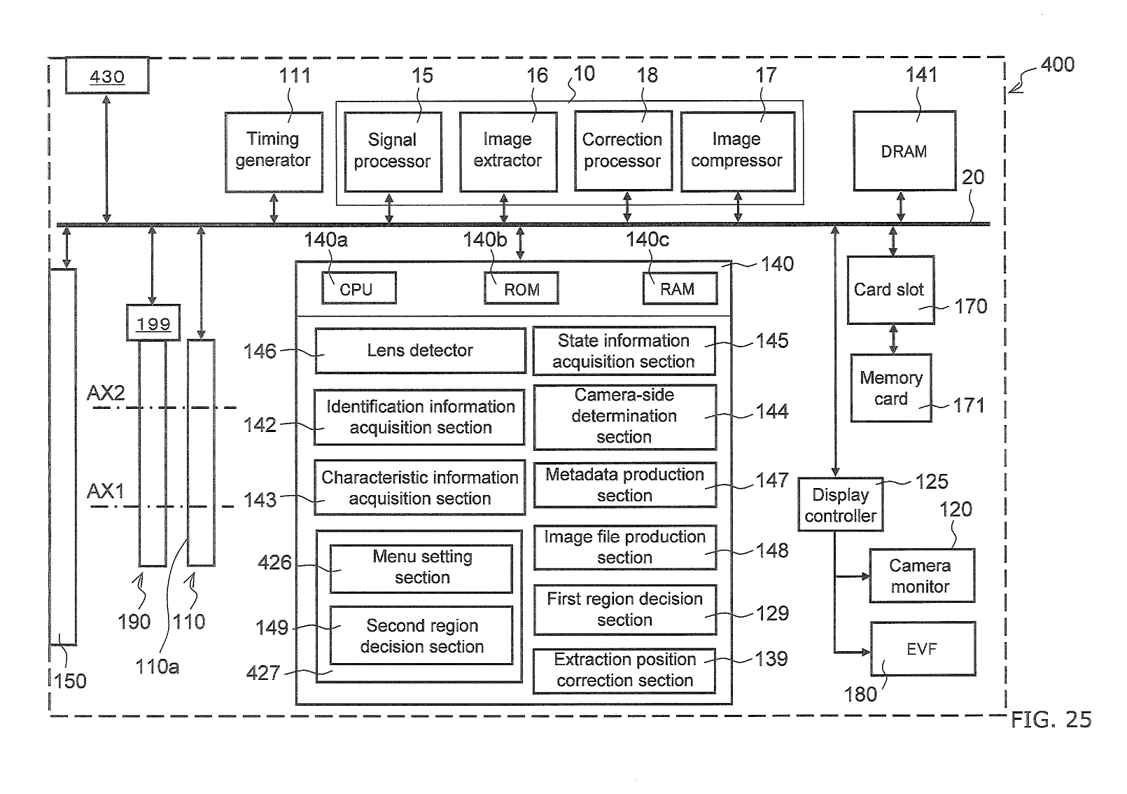

First, the camera controller 440 detects whether or not the interchangeable lens unit 200 is mounted to the camera body 100 (more precisely, to the body mount 150), just as with the camera controller 140 in the first embodiment. More specifically, as shown in FIG. 25, the camera controller 440 has a lens detector 146. When the interchangeable lens unit 200 is mounted to the camera body 100, signals are exchanged between the camera controller 440 and the lens controller 240. The lens detector 146 determines whether or not the interchangeable lens unit 200 has been mounted on the basis of this exchange of signals.

The camera controller 440 is similar to the camera controller 140 in the first embodiment in that it has various other functions, such as the function of determining whether or not the interchangeable lens unit mounted to the body mount 150 is compatible with three-dimensional imaging, and the function of acquiring information related to three-dimensional imaging from the interchangeable lens unit. The camera controller 440 has an identification information acquisition section 142, a characteristic information acquisition section 143, a camera-side determination section 144, menu setting section 426, a state information acquisition section 145, an extraction position correction section 139, a first region decision section 129, a second region decision section 149, a metadata production section 147, and an image file production section 148. In this embodiment, a function restrictor 427 (an example of a function restrictor), which restricts in three-dimensional imaging the use of one or more functions that can acquire a plurality of images all at once, is constituted by the menu setting section 426 and the second region decision section 149.

The “imaging functions” in the second embodiment here include a sequential capture function and a bracket imaging function, for example.

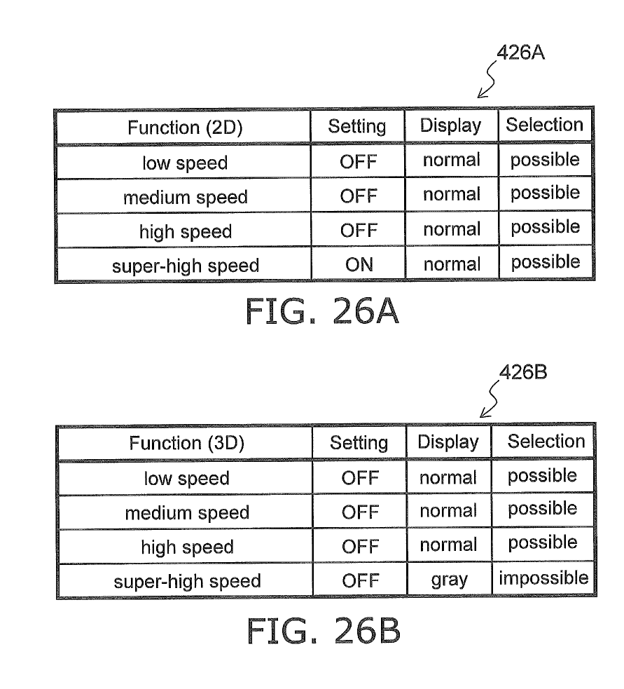

The menu setting section 426 (an example of a sequential capture menu setting section, and an example of a bracket menu setting section) sets the menu screen to be displayed on the camera monitor 120 or the electronic viewfinder 180. More specifically, as shown in FIGS. 26A and 26B, the menu setting section 426 has first sequential capture menu information 426A (an example of sequential capture menu information) that gives a list of sequential capture functions that can be used in two-dimensional imaging, and a second sequential capture menu information 426B (an example of second sequential capture menu information) that gives a list of sequential capture functions that can be used in three-dimensional imaging.

The first sequential capture menu information 426A and second sequential capture menu information 426B are stored ahead of time in the ROM 140b of the camera controller 440, for example. The first sequential capture menu information 426A and second sequential capture menu information 426B are lists of four categories, namely, the various sequential capture modes, settings, display, and selection, for example. In this embodiment, four kinds of sequential capture mode are used: low speed, medium speed, high speed, and super-high speed. Each of these sequential capture mode will be discussed below.

“Setting” shows the setting state of these functions. In this embodiment, the first sequential capture menu information 426A and second sequential capture menu information 426B share the contents of their “settings” with each other. More specifically, the contents of the “settings” of the first sequential capture menu information 426A and second sequential capture menu information 426B are stored in a flash memory (not shown) that is part of the ROM 140b. The contents of the stored “settings” are managed by the function restrictor 427 (more precisely, the menu setting section 426), and stored information (more precisely, “settings”) is updated by the menu setting section 426 according to operation by the user. Therefore, basically, if a setting is changed during two-dimensional imaging, that changed setting will be reflected in the setting contents of the three-dimensional imaging. The contents of the “settings” of the first sequential capture menu information 426A and second sequential capture menu information 426B may instead be managed separately by the menu setting section 426.

“Display” shows the state when displayed on the menu screen. If the “display” is “normal,” then that function is displayed on the menu screen in a normal color such as white. If the “display” is “gray,” then that function is grayed out on the menu screen. “Selection” shows whether or not that function can be selected (can be used). If the “selection” is “possible,” it means that function can be selected. If the “selection” is “impossible,” that function cannot be selected (cannot be used). If there is no category called “display” in the first sequential capture menu information 426A and second sequential capture menu information 426B, then the display color may be decided by the contents of the “selection.” For example, a function that cannot be selected may be displayed in a different color from that of a function that can be selected.

The menu setting section 426 forcibly sets the “settings” of the super-high speed sequential capture mode in which “selection” is “impossible” to “off.” Accordingly, regardless of any operation on the part of the user, the use of the super-high speed sequential capture mode in three-dimensional imaging is restricted by the menu setting section 426. At this point, for example, the menu setting section 426 temporarily stores the settings from before the settings were changed (the setting for two-dimensional imaging) at a specific address, and the stored setting contents are returned to the setting contents during two-dimensional imaging on the basis of the stored setting contents prior to the change.

More specifically, as shown in FIG. 26A, with the first sequential capture menu information 426A, all sequential capture modes are in normal display and can be selected. For example, if the medium speed sequential capture mode is selected on the touch panel 138, the medium speed sequential capture mode is switched on, and the other sequential capture modes are switched off. At this point, the setting contents for the medium speed sequential capture mode stored at a specific address are switched from off to on by the menu setting section 426, and the setting contents of the other sequential capture modes are switched off.

Meanwhile, as shown in FIG. 26B, with the second sequential capture menu information 426B, the super-high speed sequential capture mode is grayed out and cannot be selected. Therefore, a function that cannot be selected is forcibly switched to “off” by the menu setting section 426 with the second sequential capture menu information 426B even if it is “on” with the first sequential capture menu information 426A. For example, even if the super-high speed sequential capture mode is switched on during two-dimensional imaging, the super-high speed sequential capture mode will be automatically switched off during three-dimensional imaging. More specifically, the setting contents for the super-high speed sequential capture mode stored at a specific address will be switched from on to off by the menu setting section 426.

Conversely, if the imaging mode is switched from three-dimensional imaging mode to two-dimensional imaging mode on the basis of the determination result of the camera-side determination section 144, the setting contents of the super-high speed sequential capture mode is returned by the menu setting section 426 to the setting contents during two-dimensional imaging. As shown in FIGS. 26A and 26B, the setting contents of the super-high speed sequential capture mode are switched from off to on by the menu setting section 426.

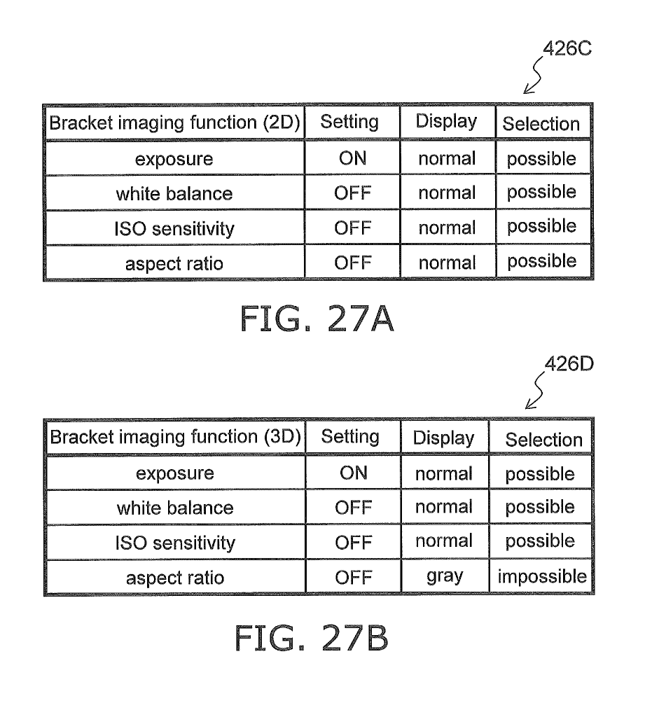

Also, as shown in FIGS. 27A and 27B, the menu setting section 426 has first bracket menu information 426C (an example of first bracket menu information) that gives a list of bracket imaging functions that can be used in two-dimensional imaging, and second bracket menu information 426D (an example of second bracket menu information) that gives a list of bracket imaging functions that can be used in three-dimensional imaging.

The first bracket menu information 426C and second bracket menu information 426D are stored ahead of time in the ROM 140b of the camera controller 440, for example. The first bracket menu information 426C and second bracket menu information 426D are lists of four categories of information: bracket imaging function, setting, display, and selection, for example. There are four possible types of bracket imaging function: an exposure bracket imaging function for capturing a plurality of images while varying the exposure in stages, a white balance bracket imaging function for acquiring a plurality of images of different white balance settings all at once, an ISO sensitivity bracket imaging function for capturing a plurality of images while varying the ISO sensitivity in stages, and an aspect bracket imaging function for acquiring a plurality of images having different aspect ratios all at once. In this embodiment, four different aspect ratios are used in aspect bracket imaging: 4:3, 3:2, 16:9, and 1:1. The aspect bracket imaging will be discussed below.

“Setting” indicates the setting state of that function. In this embodiment, basically the first bracket menu information 426C and second bracket menu information 426D share the contents of their “settings” with each other. More specifically, the contents of the “settings” for the first bracket menu information 426C and second bracket menu information 426D are stored in a flash memory (not shown) that is part of the ROM 140b. The contents of the stored “settings” are managed by the function restrictor 427 (more precisely, the menu setting section 426), and stored information (more precisely, “settings”) is updated by the menu setting section 426 according to operation by the user. Therefore, basically, if a setting is changed during two-dimensional imaging, for example, that changed setting will be reflected in the setting contents of the three-dimensional imaging. The contents of the “settings” of the first bracket menu information 426C and second bracket menu information 426D may instead be managed separately by the menu setting section 426.

“Display” shows the state when displayed on the menu screen. If the “display” is “normal,” then that function is displayed on the menu screen in a normal color such as white. If the “display” is “gray,” then that function is grayed out on the menu screen. “Selection” shows whether or not that function can be selected (can be used). If the “selection” is “possible,” that function can be selected. If the “selection” is “impossible,” it means that function cannot be selected (cannot be used). If there is no category called “display” in the first bracket menu information 426C and second bracket menu information 426D, then the display color may be decided by the contents of the “selection.” For example, a function that cannot be selected may be displayed in a different color from that of a function that can be selected.

The menu setting section 426 forcibly sets the “settings” of the aspect bracket imaging mode in which “selection” is “impossible” to “off” Accordingly, regardless of any operation on the part of the user, the use of the aspect bracket imaging mode in three-dimensional imaging is restricted by the menu setting section 426. At this point, for example, the menu setting section 426 temporarily stores the settings from before the settings were changed (the settings for two-dimensional imaging) at a specific address, and the settings are automatically returned to the original settings during two-dimensional imaging on the basis of the stored setting contents prior to the change.

More specifically, as shown in FIG. 27A, with the first bracket menu information 426C, all bracket imaging modes are in normal display and can be selected. Therefore, the user can select the desired functions from among all of the bracket imaging functions.

Meanwhile, as shown in FIG. 27B, with the second bracket menu information 426D, aspect bracket imaging (“aspect ratio”) is grayed out and cannot be selected. Here, a function that cannot be selected is forcibly switched to “off” by the menu setting section 426 with the second bracket menu information 426D even if it is “on” with the first bracket menu information 426C.

Thus, the menu setting section 426 forcibly sets a predetermined imaging function, regardless of the two-dimensional imaging settings, to restrict the use of predetermined imaging functions during three-dimensional imaging.

The menu setting section 426 decides whether to display the first sequential capture menu information 426A or the second sequential capture menu information 426B in sequential capture mode on the basis of the determination result of the camera-side determination section 144 stored in the RAM 240c. More specifically, if the determination result of the camera-side determination section 144 indicates that the interchangeable lens unit is compatible with three-dimensional imaging, the menu setting section 426 displays the second sequential capture menu information 426B on the camera monitor 120 or the electronic viewfinder 180. On the other hand, if the determination result of the camera-side determination section 144 indicates that the interchangeable lens unit is not compatible with three-dimensional imaging, the menu setting section 426 displays the first sequential capture menu information 426A on the camera monitor 120 or the electronic viewfinder 180.

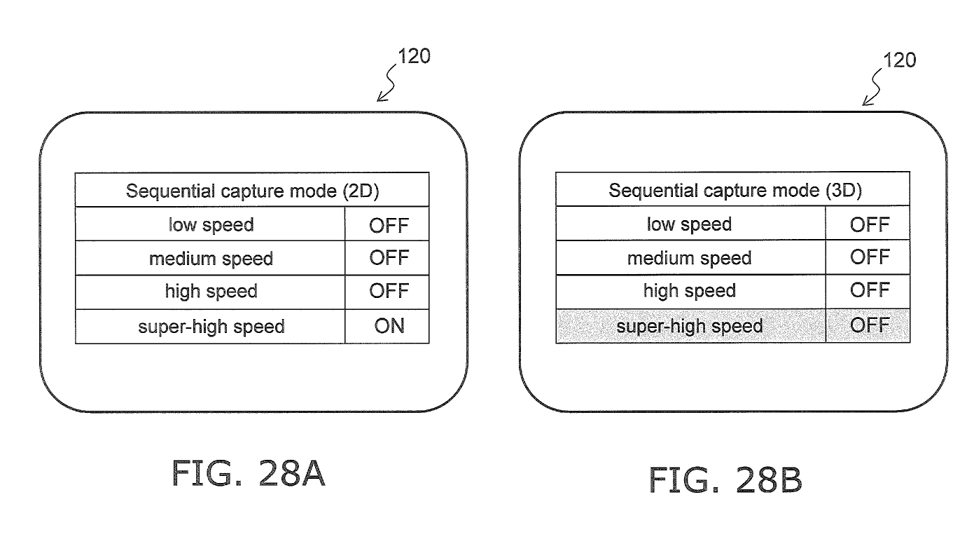

Examples of screens displayed on the basis of the first sequential capture menu information 426A and the second sequential capture menu information 426B are shown in FIGS. 28A and 28B. As shown in FIG. 28A, low speed, medium speed, high speed, and super-high speed sequential capture modes included in the first sequential capture menu information 426A are displayed as functions that can be selected on the menu screen in two-dimensional imaging mode, for example.

Meanwhile, as shown in FIG. 28B, low speed, medium speed, high speed, and super-high speed sequential capture modes included in the second sequential capture menu information 426B are displayed on the menu screen in three-dimensional imaging mode, for example, but of these, the super-high speed sequential capture mode is grayed out. As discussed above, a function that is grayed out cannot be selected by the user.

The menu setting section 426 decides whether to display the first bracket menu information 426C or the second bracket menu information 426D in bracket imaging mode on the basis of the determination result of the camera-side determination section 144 stored in the RAM 240c. More specifically, if the determination result of the camera-side determination section 144 indicates that the interchangeable lens unit is compatible with three-dimensional imaging, the menu setting section 426 displays the second bracket menu information 426D on the camera monitor 120 or the electronic viewfinder 180. On the other hand, if the determination result of the camera-side determination section 144 indicates that the interchangeable lens unit is not compatible with three-dimensional imaging, the menu setting section 426 displays the first bracket menu information 426C on the camera monitor 120 or the electronic viewfinder 180.

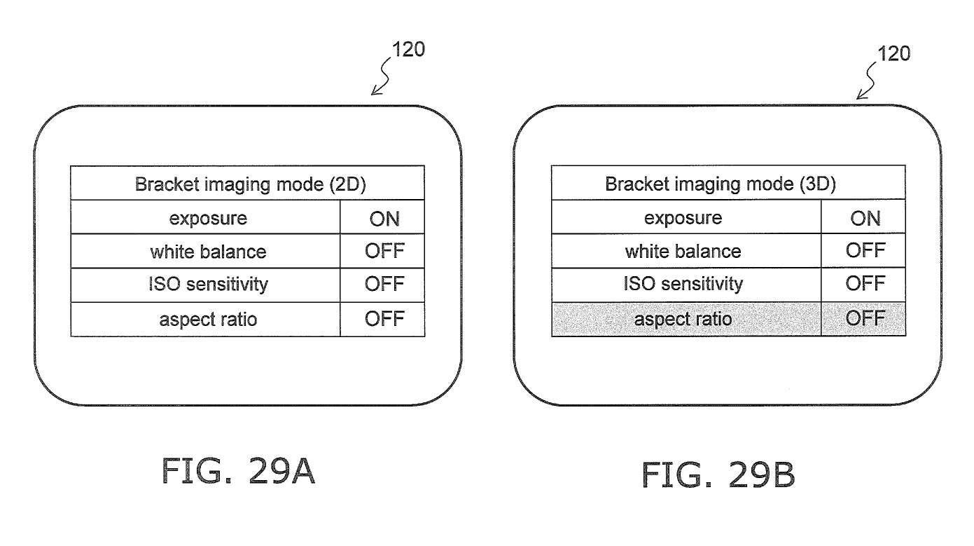

Examples of screens displayed on the basis of the first bracket menu information 426C and the second bracket menu information 426D are shown in FIGS. 29A and 29B. The four functions included in the first bracket menu information 426C, for example, are displayed on the menu screen in two-dimensional imaging mode as imaging functions that can be selected.

As discussed above, if the camera-side determination section 144 has determined that the interchangeable lens unit is compatible with three-dimensional imaging, the menu setting section 426 restricts the use in three-dimensional imaging of functions that can be used in two-dimensional imaging (an example of imaging functions).

Description of Imaging Functions

The digital camera 1 has a sequential capture function and a bracket imaging function, and in three-dimensional imaging mode, the use of the sequential capture function and bracket imaging function is restricted.

The functions whose use is restricted in three-dimensional imaging mode will now be briefly described.

(1) Sequential Capture Function

The sequential capture function is a function for acquiring a plurality of images at a specific frame rate while the release button 131 is held down. In the sequential capture mode for using the sequential capture function, imaging is possible at four different sequential capture speeds: low, medium, high, and super-high speed. The sequential capture speed is different for each of the low, medium, high, and super-high speed sequential capture functions, with the sequential capture speed increasing in the order of low, medium, high, and super-high speed. In the low speed sequential capture mode, two images per second can be acquired, for example. In the medium speed sequential capture mode, four images per second can be acquired, for example. In the high speed sequential capture mode, six images per second can be acquired, for example. In the low, medium, and high speed sequential capture modes, sequential capture is performed using a shutter unit 190, which is a mechanical shutter. In the low, medium, and high speed sequential capture modes, when the release button 131 is pressed once, a plurality of images can automatically be acquired at specific frame rates for the various speeds.

Meanwhile, in the super-high speed sequential capture mode, sequential capture is carried out using an electronic shutter function, so more images can be acquired per unit of time than in the low, medium, and high speed sequential capture modes. That is, the sequential capture speed of the super-high speed sequential capture function (an example of a second sequential capture function) is higher than the sequential capture speed in the low, medium, and high speed sequential capture modes. For example, 40 images per second can be acquired in the super-high speed sequential capture mode. In the super-high speed sequential capture mode, the number of acquired images is proportional to how long the release button 131 is held down. For instance, if the release button 131 is held down for one second, 40 images can be acquired, and if the release button 131 is held down for 0.5 second, 20 images can be acquired. The system may also be designed so that even if the release button 131 is held down for longer than one second, super-high speed sequential capture will end at the point when a specific number of images (such as 40) have been acquired, as dictated by the capacity of the DRAM 141.

(2) Aspect Bracket Imaging Function

The aspect bracket imaging function is a function for acquiring a plurality of images that have different aspect ratios all at once. In the aspect bracket imaging mode for using the aspect bracket imaging function, a plurality of images having different aspect ratios can be acquired all at once. As discussed above, in this embodiment four different aspect ratios are used in aspect bracket imaging: 4:3, 3:2, 16:9, and 1:1. Furthermore, in this embodiment, the aspect ratios in the aspect bracket imaging mode are predetermined, but the system may instead be such that the user can select the aspect ratio to be used in aspect bracket imaging.

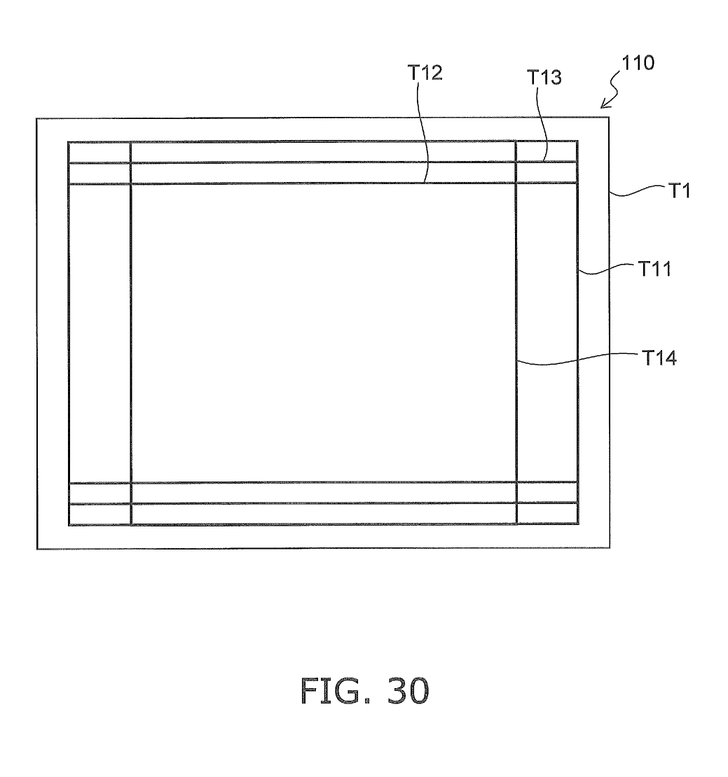

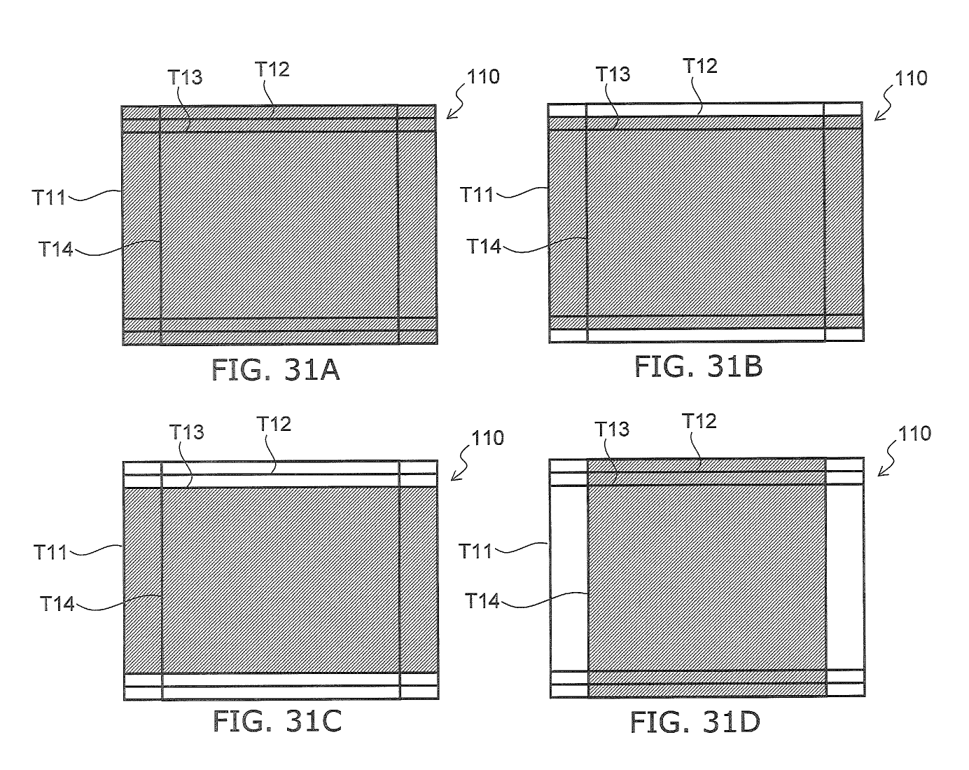

The aspect bracket imaging mode will now be described in greater detail. In the aspect bracket imaging mode, only one frame of image data taken in from the CMOS image sensor 110, but images are extracted in four different aspect ratios from this image data. More specifically, as shown in FIGS. 30 and 31A to 31D, image data for a single image is extracted in a first aspect region T11 with an aspect ratio of 4:3, a second aspect region T12 with an aspect ratio of 3:2, a third aspect region T13 with an aspect ratio of 16:9, and a fourth aspect region T14 with an aspect ratio of 1:1. Consequently, in the aspect bracket imaging mode, four images having four different aspect ratios can be acquired all at once.

Operation of Digital Camera

(1) When Power is On

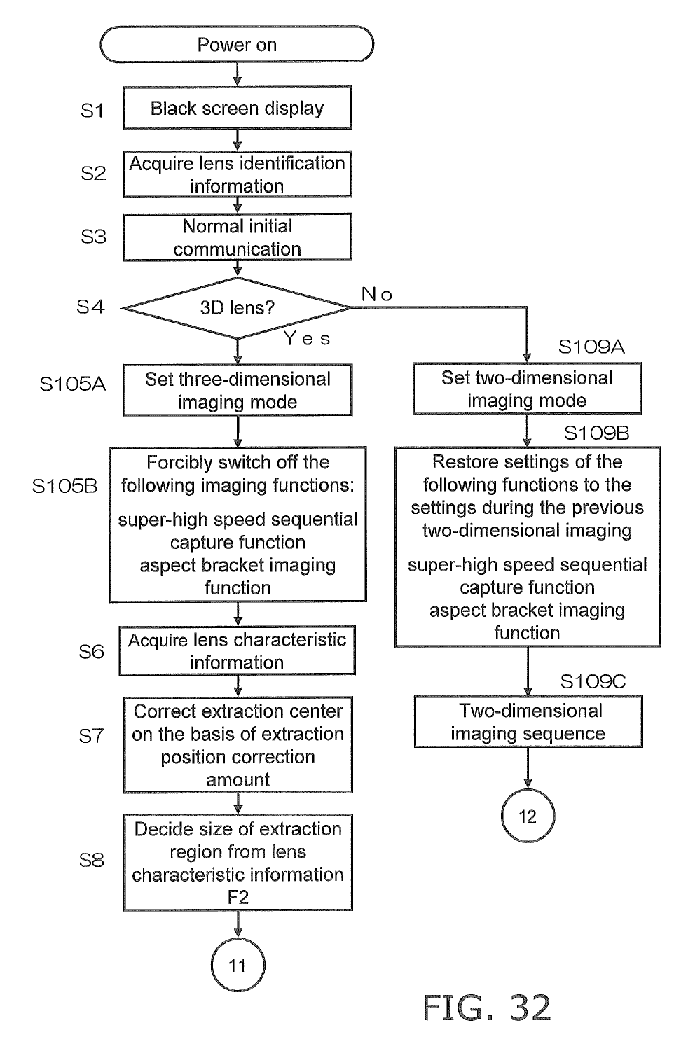

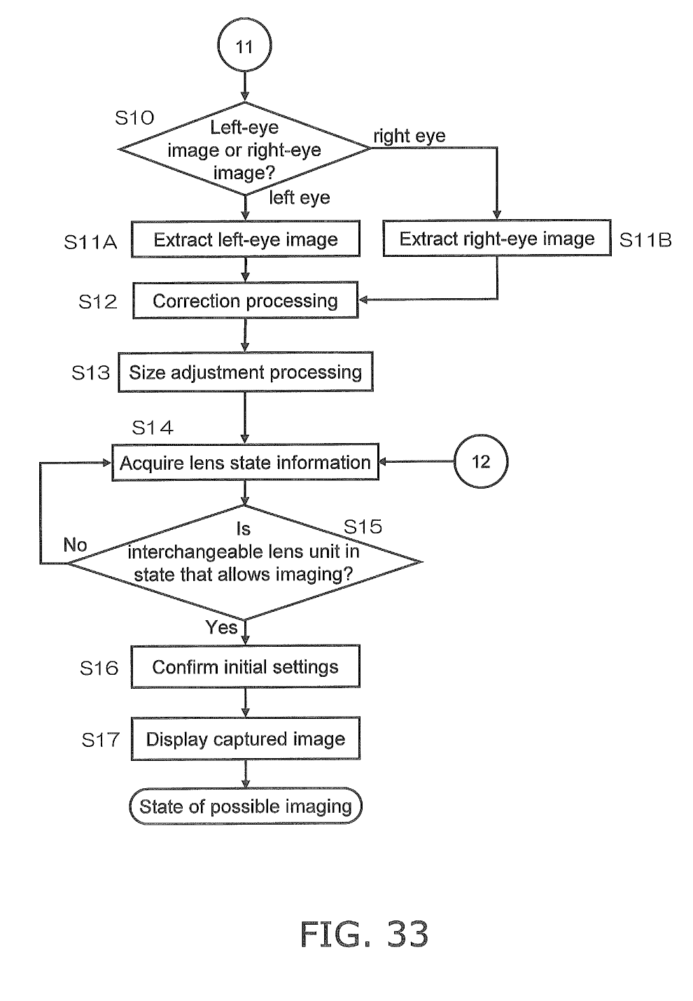

Determination of whether or not the interchangeable lens unit 200 is compatible with three-dimensional imaging is possible either when the interchangeable lens unit 200 is mounted to the camera body 400 in a state in which the power to the camera body 400 is on, or when the power is turned on to the camera body 400 in a state in which the interchangeable lens unit 200 has been mounted to the camera body 400. Here, the latter case will be used as an example to describe the operation of the digital camera 1 through reference to the flowcharts in FIGS. 8A, 8B, 32, and 33. Of course, the same operation may also be performed in the former case.

Just as in the first embodiment, when the power is switched on, a black screen is displayed on the camera monitor 120 under control of the display controller 125, and the blackout state of the camera monitor 120 is maintained (step S1). Next, the identification information acquisition section 142 of the camera controller 440 acquires the lens identification information F1 from the interchangeable lens unit 200 (step S2). More specifically, as shown in FIGS. 8A and 8B, when the mounting of the interchangeable lens unit 200 is detected by the lens detector 146 of the camera controller 440, the camera controller 440 sends a model confirmation command to the lens controller 240. This model confirmation command is a command that requests the lens controller 240 to send the status of a three-dimensional imaging determination flag for the lens identification information F1. As shown in FIG. 8B, since the interchangeable lens unit 200 is compatible with three-dimensional imaging, upon receiving the model confirmation command, the lens controller 240 sends the lens identification information F1 (three-dimensional imaging determination flag) to the camera body 400. The identification information acquisition section 142 temporarily stores the status of this three-dimensional imaging determination flag in the DRAM 141.

Next, ordinary initial communication is executed between the camera body 400 and the interchangeable lens unit 200 (step S3). This ordinary initial communication is also performed between the camera body and an interchangeable lens unit that is not compatible with three-dimensional imaging. For example, information related to the specifications of the interchangeable lens unit 200 (its focal length, F stop value, etc.) is sent from the interchangeable lens unit 200 to the camera body 400.

After this ordinary initial communication, the camera-side determination section 144 determines whether or not the interchangeable lens unit 200 mounted to the body mount 150 is compatible with three-dimensional imaging (step S4). More specifically, the camera-side determination section 144 determines whether or not the mounted interchangeable lens unit 200 is compatible with three-dimensional imaging on the basis of the lens identification information F1 (three-dimensional imaging determination flag) acquired by the identification information acquisition section 142.

If the mounted interchangeable lens unit is not compatible with three-dimensional imaging, information indicating that the interchangeable lens unit is not compatible with three-dimensional imaging is stored at a specific address in the RAM 240c by the camera-side determination section 144, and the imaging mode is set to two-dimensional imaging mode (step S109A). At this point, if the super-high speed sequential capture function and the aspect bracket imaging function have been forcibly set to “off” by the menu setting section 426 (discussed below), then the super-high speed sequential capture function and the aspect bracket imaging function are restored by the menu setting section 426 to the same state as during the previous two-dimensional imaging (step S109B). The setting contents during the previous two-dimensional imaging are temporarily stored in a flash memory that is part of the ROM 140b or the DRAM 141, for example. Then, the normal sequence corresponding to two-dimensional imaging is executed, and the processing moves to step S14 (step S109C).

When the interchangeable lens unit 200 is removed from the camera body 400, the super-high speed sequential capture function and the aspect bracket imaging function may be automatically restored by the menu setting section 426 to the same state as the previous two-dimensional imaging. That is, the above two functions are forcibly set to “off” only when a interchangeable lens unit 200 that is compatible with three-dimensional imaging has been mounted to the camera body 400.

On the other hand, if the mounted interchangeable lens unit is compatible with three-dimensional imaging, information indicating that the interchangeable lens unit is compatible with three-dimensional imaging is stored at a specific address in the RAM 240c by the camera-side determination section 144, and the imaging mode is set to three-dimensional imaging mode (step S105A). At this point, the super-high speed sequential capture function and the aspect bracket imaging function are forcibly set to “off” by the menu setting section 426. More precisely, the “setting” of the super-high speed sequential capture mode of the second sequential capture menu information 426B is forcibly switched to “off” by the menu setting section 426 (step S105B). Also, the “setting” of the aspect bracket imaging mode of the second bracket menu information 426D is forcibly switched to “off” by the menu setting section 426. Any function that has already been set to “off” is maintained in its off state.

After the determination result of the camera-side determination section 144 has been stored in the RAM 240c, the lens characteristic information F2 is acquired by the characteristic information acquisition section 143 from the interchangeable lens unit 200 (step S6). The processing in steps S6 to S17 is the same as in the first embodiment, and will therefore not be described again in detail.

(2) Sequential Capture Mode Selection Operation

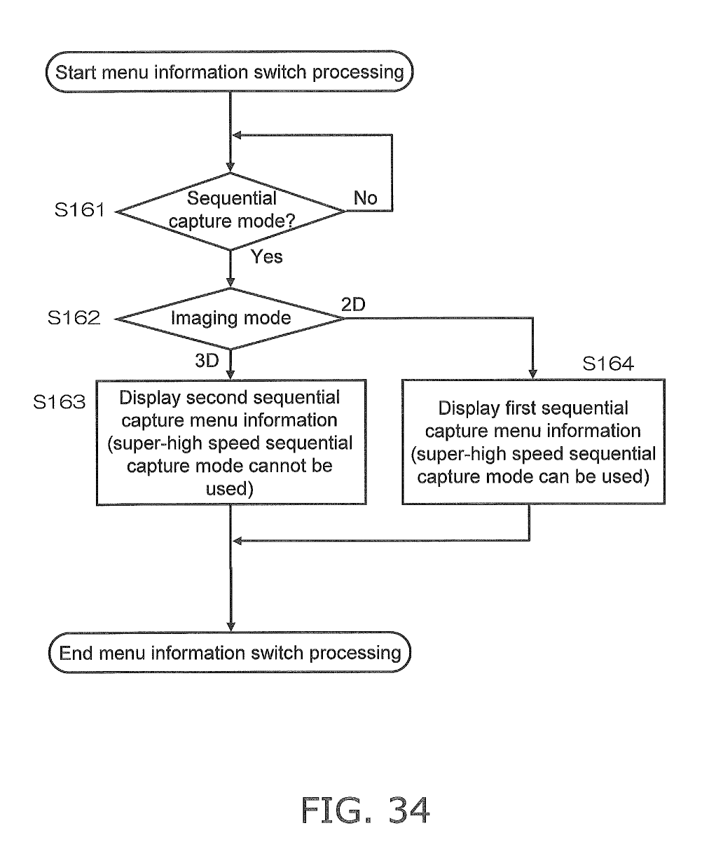

The sequential capture mode selection operation in two-dimensional imaging and three-dimensional imaging will now be described through reference to FIG. 34.

As shown in FIG. 34, when the imaging selection lever 437 is used to select the sequential capture mode, the imaging mode is confirmed by the menu setting section 426 (steps S161 and S162). More specifically, the menu setting section 426 confirms the determination result of the camera-side determination section 144 stored at a specific address of the RAM 240c. If the determination result indicates three-dimensional imaging mode (or if it indicates that the interchangeable lens unit is compatible with three-dimensional imaging), the menu setting section 426 selects the second sequential capture menu information 426B, and the selected second sequential capture menu information 426B is displayed on the camera monitor 120 (step S163). At this point, as shown in FIG. 28B, the low speed, medium speed, and high speed sequential capture modes can be selected by the user, but the super-high speed sequential capture mode is grayed out, and this imaging function cannot be selected even if the user attempts to do so with the cross key 135 or the touch panel 138.

On the other hand, if the determination result indicates two-dimensional imaging mode (or if it indicates that the interchangeable lens unit is not compatible with three-dimensional imaging), the menu setting section 426 selects the first sequential capture menu information 426A, and the selected first sequential capture menu information 426A is displayed on the camera monitor 120 (step S164). In this case, as shown in FIG. 28A, the low speed, medium speed, high speed, and super-high speed sequential capture modes can be selected by the user.

(3) Bracket Imaging Mode Selection Operation

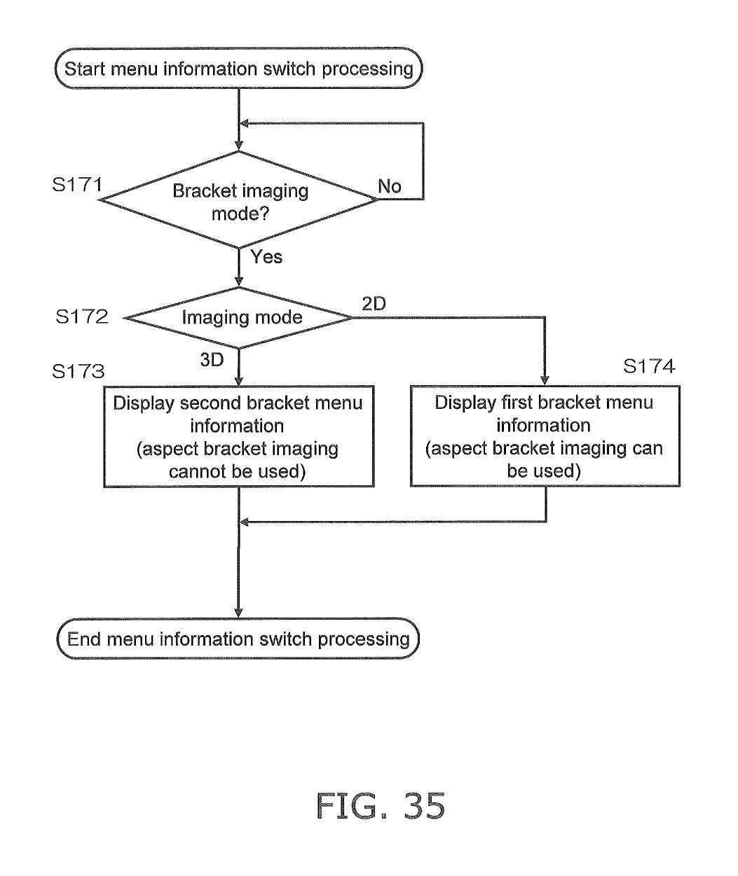

The bracket imaging mode selection operation during two-dimensional imaging and three-dimensional imaging will now be described through reference to FIG. 35.

As shown in FIG. 35, when the imaging selection lever 437 is used to select the bracket imaging mode, the imaging mode is confirmed by the menu setting section 426 (steps S171 and S172). More specifically, the menu setting section 426 confirms the determination result of the camera-side determination section 144 stored at a specific address of the RAM 240c. If the determination result indicates three-dimensional imaging mode (or if it indicates that the interchangeable lens unit is compatible with three-dimensional imaging), the menu setting section 426 selects the second bracket menu information 426D, and the selected second bracket menu information 426D is displayed on the camera monitor 120 (step S173). At this point, as shown in FIG. 29B, the exposure, white balance, and ISO sensitivity bracket imaging modes can be selected by the user, but the aspect bracket imaging mode is grayed out, and this imaging function cannot be selected even if the user attempts to do so with the cross key 135 or the touch panel 138.

Also, when the second bracket menu information 426D is selected by the menu setting section 426, just the setting for the aspect bracket imaging mode that is “cannot be selected” is forcibly switched to “off” by the menu setting section 426. More precisely, the setting contents of the aspect bracket imaging mode stored in the RAM 240c are forcibly switched to “off” by the menu setting section 426.

Meanwhile, if the determination result indicates two-dimensional imaging mode (or if it indicates that the interchangeable lens unit is not compatible with three-dimensional imaging), the menu setting section 426 selects the first bracket menu information 426C, and the selected first bracket menu information 426C is displayed on the camera monitor 120 (step S174). In this case, as shown in FIG. 29A, the exposure, white balance, ISO sensitivity, and aspect bracket imaging modes, in which the first bracket menu information 426C can be selected, can be selected by the user.

(4) Two-Dimensional Still Picture Imaging

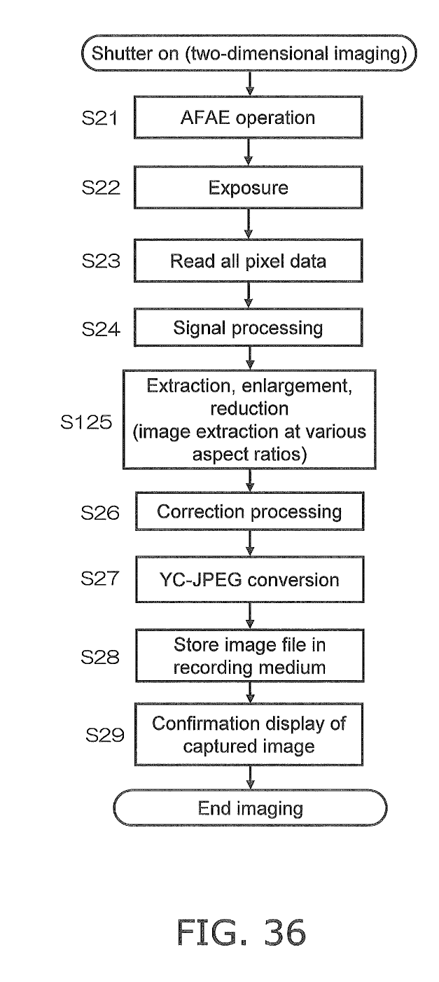

Next, the operation during two-dimensional still picture imaging will be described through reference to FIG. 36. Here, two-dimensional imaging in sequential capture mode and aspect bracket imaging mode will also be described, using two-dimensional imaging in single capture mode as a basis.

When the user presses the release button 131, autofocusing (AF) and automatic exposure (AE) are executed, and then exposure is commenced (steps S21 and S22). An image signal from the CMOS image sensor 110 (full pixel data) is taken in by the signal processor 15, and the image signal is subjected to AD conversion or other such signal processing by the signal processor 15 (steps S23 and S24). The basic image data produced by the signal processor 15 is temporarily stored in the DRAM 141.

Next, the captured image data is extracted from the basic image data by the image extractor 16 (step S125). In single capture mode or sequential capture mode, the captured image data is extracted from the basic image data in a single region according to the selected aspect ratio, but in the aspect bracket imaging mode, for example, as shown in FIGS. 31A and 31B, the image data of the first aspect region T11, the second aspect region T12, the third aspect region T13, and the fourth aspect region T14 is extracted in that order from the basic image region T1.

Furthermore, the captured image data is subjected to correction processing by the correction processor 18. More specifically, the captured image data is subjected to distortion correction and shading correction by the correction processor 18 (step S26). In the aspect bracket imaging mode, the four sets of image data extracted in step S125 are each subjected to correction processing by the correction processor 18.

After the correction processing, the corrected image data is subjected to PEG compression or other such compression processing (step S27). The image files produced by this compression processing are sent to the card slot 170 and stored in the memory card 171, for example (step S28). In aspect bracket imaging mode, four image files are stored in the memory card 171, for example.

After the image files have been stored in the memory card 171, the captured images are displayed for a predetermined length of time on the camera monitor 120 in order to check the captured images (step S29).

When two-dimensional imaging is performed in sequential capture mode, steps S22 to S28 are successively executed a specific number of times in parallel, for example. More specifically, in the low speed, medium speed, and high speed sequential capture modes, exposure by the shutter unit 190 is repeated under specific conditions, and image signals from the CMOS image sensor 110 (full pixel data) are successively taken in by the signal processor 15 in conjunction with the shutter unit 190 (steps S22 and S23). The image signals are subjected to image processing such as A/D conversion at the signal processor 15, and the basic image data produced by the signal processor 15 is temporarily stored in the DRAM 141 (step S24). At the DRAM 141, the basic image data is discarded according to the processing status in steps S125 to S28. Accordingly, if the processing from step S125 onward takes a long time, the period at which the basic image data is discarded from the DRAM 141 will be longer, and this may make it impossible for new basic image data produced by the signal processor 15 to be held in the DRAM 141. Therefore, the processing time from step S125 onward can affect the sequential capture rate.

(5) Three-Dimensional Still Picture Imaging

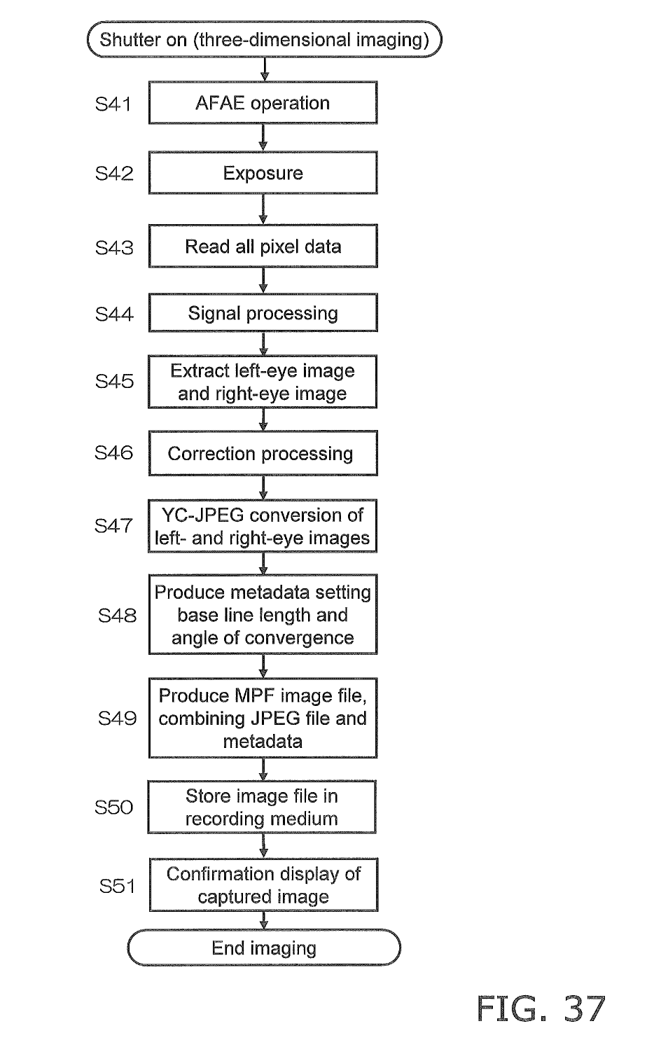

Next, the operation during three-dimensional still picture imaging will be described through reference to FIG. 37. Here, three-dimensional imaging in sequential capture mode will also be described using the three-dimensional imaging in single capture mode as a basis. As discussed above, in three-dimensional imaging, the use of the aspect bracket imaging function is restricted.

When the user presses the release button 131, autofocusing (AF) and automatic exposure (AE) are executed, and then exposure is commenced (steps S41 and S42). An image signal from the CMOS image sensor 110 (full pixel data) is taken in by the signal processor 15, and the image signal is subjected to A/D conversion or other such signal processing by the signal processor 15 (steps S43 and S44). The basic image data produced by the signal processor 15 is temporarily stored in the DRAM 141.

Next, the image extractor 16 extracts left-eye image data and right-eye image data from the basic image data (step S45). The size and position of the extraction regions AL2 and AR2 here, and the extraction method, depend on the values decided in steps S6 and S7.

The correction processor 18 then subjects the extracted left-eye image data and right-eye image data to correction processing, and the image compressor 17 performs JPEG compression or other such compression processing on the left-eye image data and right-eye image data (steps S46 and S47).

After compression, the metadata production section 147 of the camera controller 440 produces metadata setting the stereo base and the angle of convergence (step S48).

After metadata production, the compressed left- and right-eye image data are combined with the metadata, and MPF image files are produced by the image file production section 148 (step S49). The produced image files are sent to the card slot 170 and stored in the memory card 171, for example (step S50). If these image files are displayed three-dimensionally using the stereo base and the angle of convergence, the displayed image can be seen in 3D view using special glasses or the like.

After the image files have been stored in the memory card 171, the captured images are displayed for a predetermined length of time on the camera monitor 120 to check the captured images (step S51). At this point, for example, the left-eye image and right-eye image, or a three-dimensional image using the left-eye image and the right-eye image, is displayed on the camera monitor 120.

When three-dimensional imaging is performed in sequential capture mode (low speed, medium speed, and high speed sequential capture mode), steps S42 to S50 are successively executed a specific number of times in parallel, for example. More specifically, in the low speed, medium speed, and high speed sequential capture modes, exposure by the shutter unit 190 is repeated under specific conditions, and image signals from the CMOS image sensor 110 (full pixel data) are successively taken in by the signal processor 15 (steps S42 and S43). The image signals are subjected to image processing such as A/D conversion at the signal processor 15, and the basic image data produced by the signal processor 15 is temporarily stored in the DRAM 141 (step S44). The basic image data is discarded from the DRAM 141 according to the processing status in steps S45 to S50. Accordingly, if the processing from step S45 onward takes a long time, the period at which the basic image data is discarded from the DRAM 141 will be longer, and this may make it impossible for new basic image data produced by the signal processor 15 to be held in the DRAM 141. Therefore, the processing time from step S45 onward can affect the sequential capture rate.

Features of Camera Body

The features of the camera body 400 described above are compiled below.

(1) As discussed above, the imaging device is equipped with a function that allows a plurality of functions to be acquired all at once (such as sequential capture function and bracket imaging function).

In the case of three-dimensional imaging, however, image processing that is unique to three-dimensional imaging is required, so such functions may pose a problem in producing a stereo image.

In view of this, with the camera body 400, when the camera-side determination section 144 has determined that the interchangeable lens unit is compatible with three-dimensional imaging, the use of an imaging function that allows a plurality of images to be acquired all at once is restricted by the function restrictor 427. Therefore, this type of imaging function does not adversely affect three-dimensional imaging. In other words, using this constitution provides a camera body 400 that is better suited to three-dimensional imaging.

The phrase “affect the obtaining of a good 3D view” here means, for example, that the 3D view looks extremely unnatural to the user.

(2) For example, during three-dimensional imaging, image processing that is unique to three-dimensional imaging is required, so image processing takes longer than in two-dimensional imaging. More specifically, in image processing during three-dimensional imaging, the processing takes longer than two-dimensional imaging, and the increase is equivalent to at least steps S47 to S49 shown in FIG. 37. Therefore, if the use of sequential capture mode, which has a relatively high sequential capture rate, is permitted during three-dimensional imaging, the image processing may not be able to keep up with the sequential capture rate, and this may limit the number of sequential captures, make it difficult to attain the desired sequential capture rate, for example.

With the camera body 400, however, since the use of the super-high speed sequential capture mode (an example of a second sequential capture function) during three-dimensional imaging is restricted by the function restrictor 427, the above-mentioned problem is less likely to be encountered, so more enjoyable three-dimensional imaging is possible.

(3) If the camera-side determination section 144 has determined that the interchangeable lens unit is compatible with three-dimensional imaging, the function restrictor 427 restricts in three-dimensional imaging the use of imaging functions with which a plurality of images can be acquired all at once. More specifically, if the camera-side determination section 144 has determined that the interchangeable lens unit is compatible with three-dimensional imaging, the menu setting section 426 selects the second sequential capture menu information 426B as the menu screen displayed on the camera monitor 120 or the electronic viewfinder 180 in sequential capture mode, on the basis of the determination result of the camera-side determination section 144.

On the other hand, if the camera-side determination section 144 has determined that the interchangeable lens unit is not compatible with three-dimensional imaging, the menu setting section 426 selects the first sequential capture menu information 426A as the menu screen displayed on the camera monitor 120 or the electronic viewfinder 180 in sequential capture mode, on the basis of the determination result of the camera-side determination section.

Thus using different menu information for two-dimensional imaging and three-dimensional imaging allows the use of the super-high speed sequential capture function in three-dimensional imaging to be easily restricted.

(4) When the second sequential capture menu information 426B is displayed on the camera monitor 120 or the electronic viewfinder 180, the super-high speed sequential capture mode is displayed on the camera monitor 120 or the electronic viewfinder 180, but the user cannot select it. More specifically, the menu setting section 426 permits the display of the super-high speed sequential capture mode, but the super-high speed sequential capture mode is only displayed and is not included among the functions that can be selected. Therefore, this prevents the user from accidentally selecting the super-high speed sequential capture mode during three-dimensional imaging. Also, the user can easily recognize that the super-high speed sequential capture mode cannot be used in three-dimensional imaging.

As shown in FIG. 28B, when the second sequential capture menu information 426B is displayed on the camera monitor 120 or the electronic viewfinder 180, the super-high speed sequential capture mode is displayed in a different color from that of other sequential capture modes included in the second sequential capture menu information 426B (the low, medium, and high speed sequential capture modes), so the user can quickly recognize a sequential capture mode that cannot be selected.

(5) In the case of three-dimensional imaging, for example, as shown in FIG. 9, left- and right-eye optical images QL1 and QL2 are arranged on the CMOS image sensor 110, so the extraction regions AL2 and AR2 for cropping out the left- and right-eye images are smaller than those extraction regions in two-dimensional imaging. Therefore, depending on the aspect ratio, it may be difficult to ensure an extraction region of the desired size. As the extraction region becomes smaller, the quality of the stereo image suffers, and there may be a drop in the quality of the three-dimensional image.

With the camera body 400, however, since the use of the aspect bracket imaging mode (an example of an aspect bracket imaging function) during three-dimensional imaging is restricted by the function restrictor 427, the required quality for a three-dimensional image is more easily ensured.

(6) If the camera-side determination section 144 has determined that the interchangeable lens unit is compatible with three-dimensional imaging, the menu setting section 426 selects the second bracket menu information 426D as the menu screen displayed on the camera monitor 120 or the electronic viewfinder 180 on the basis of the determination result of the camera-side determination section 144.

On the other hand, if the camera-side determination section 144 has determined that the interchangeable lens unit is not compatible with three-dimensional imaging, the menu setting section 426 selects the first bracket menu information 426C as the menu screen displayed on the camera monitor 120 or the electronic viewfinder 180 on the basis of the determination result of the camera-side determination section.

Thus using different menu information for two-dimensional imaging and three-dimensional imaging allows the aspect bracket imaging function to be easily restricted from being used in three-dimensional imaging.

(7) When the second bracket menu information 426D is displayed on the camera monitor 120 or the electronic viewfinder 180, the category name of the aspect bracket imaging mode (“aspect ratio”) is displayed on the camera monitor 120 or the electronic viewfinder 180, but the user cannot select the aspect bracket imaging mode. More specifically, the menu setting section 426 permits the display of the aspect bracket imaging mode, but only displays it and does not include the aspect bracket imaging mode in the functions that can be selected. Therefore, this prevents the user from accidentally selecting an imaging function during three-dimensional imaging. Also, the user can quickly recognize that the aspect bracket imaging mode cannot be used in three-dimensional imaging.

Also, as shown in FIG. 29B, when the second bracket menu information 426D is displayed on the camera monitor 120 or the electronic viewfinder 180, the aspect bracket imaging mode is displayed in a different color from that of the other bracket imaging modes included in the second bracket menu information 426D (exposure, white balance, and ISO sensitivity bracket imaging modes), so the user can quickly recognize bracket imaging modes that cannot be selected.

### Modification Examples

As shown below, various changes and modifications to the constitution of the second embodiment are possible.

(A) An imaging device and camera body were described using as an example the digital camera 1 having no mirror box, but compatibility with three-dimensional imaging is also possible with a digital single lens reflex camera having a mirror box. The imaging device and camera body may also be one that is capable of capturing not only of still pictures, but also moving pictures.

(B) An interchangeable lens unit was described using the interchangeable lens unit 200 as an example, but the constitution of the three-dimensional optical system is not limited to that in the above embodiment. As long as imaging can be handled with a single imaging element, the three-dimensional optical system may have some other constitution.

(C) The three-dimensional optical system G is not limited to a side-by-side imaging system, and a time-division imaging system may instead be employed as the optical system for the interchangeable lens unit, for example. Also, in the above embodiment, an ordinary side-by-side imaging system was used as an example, but a horizontal compression side-by-side imaging system in which left- and left-eye images are compressed horizontally, or a rotated side-by-side imaging system in which left- and right-eye images are rotated 90 degrees may be employed.

(D) In the second embodiment above, the camera-side determination section 144 determines whether or not the interchangeable lens unit is compatible with three-dimensional imaging on the basis of the three-dimensional imaging determination flag for the lens identification information F1. That is, the camera-side determination section 144 performs its determination on the basis of information to the effect that the interchangeable lens unit is compatible with three-dimensional imaging.

However, the determination of whether or not the interchangeable lens unit is compatible with three-dimensional imaging may be performed using some other information. For instance, if information indicating that the interchangeable lens unit is compatible with two-dimensional imaging is included in the lens identification information F1, it may be concluded that the interchangeable lens unit is not compatible with three-dimensional imaging.

Also, whether or not the interchangeable lens unit is compatible with three-dimensional imaging may be determined on the basis of a lens ID stored ahead of time in the lens controller 240 of the interchangeable lens unit. The lens ID may be any information with which the interchangeable lens unit can be identified. An example of a lens ID is the model number of the interchangeable lens unit product. If a lens ID is used to determine whether or not the interchangeable lens unit is compatible with three-dimensional imaging, then a list of lens ID's is stored ahead of time in the camera controller 440, for example. This list indicates which interchangeable lens units are compatible with three-dimensional imaging, and the camera-side determination section 144 compares this list with the lens ID acquired from the interchangeable lens unit to determine whether or not the interchangeable lens unit is compatible with three-dimensional imaging. Thus, a lens ID can also be used to determine whether or not an interchangeable lens unit is compatible with three-dimensional imaging. Furthermore, this list can be updated to the most current version by software updating of the camera controller 440, for example.

(E) The above-mentioned interchangeable lens unit 200 may be a single focus lens. In this case, the extraction centers ACL2 and ACR2 can be found by using the above-mentioned extraction position correction amount L11. Furthermore, if the interchangeable lens unit 200 is a single focus lens, then zoom lenses 210L and 210R may be fixed, for example, and this eliminates the need for a zoom ring 213 and zoom motors 214L and 214R.

(F) In the above embodiment, the use of the super-high speed sequential capture function and the aspect bracket imaging function was restricted in three-dimensional imaging, but the use of other imaging functions may also be restricted if they are imaging functions that allow a plurality of images to be acquired all at once. Also, the use of just the aspect bracket imaging function may be restricted in three-dimensional imaging, or the use of just the super-high speed sequential capture mode may be restricted. Also, in three-dimensional imaging, the use of all sequential capture functions (low, medium, high speed, and super-high speed sequential capture functions) may be restricted, or the use of all bracket imaging functions (exposure, white balance, ISO sensitivity, and aspect ratio) may be restricted.

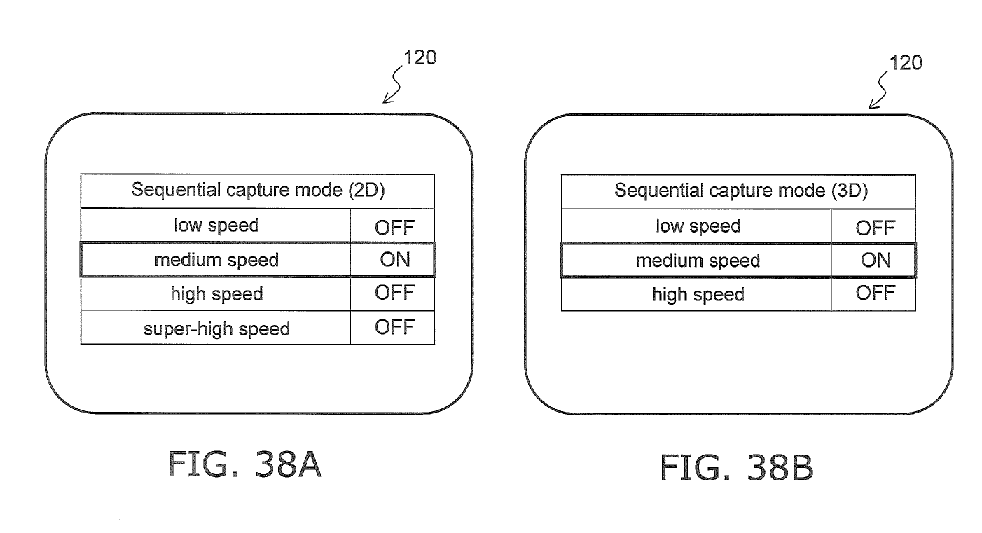

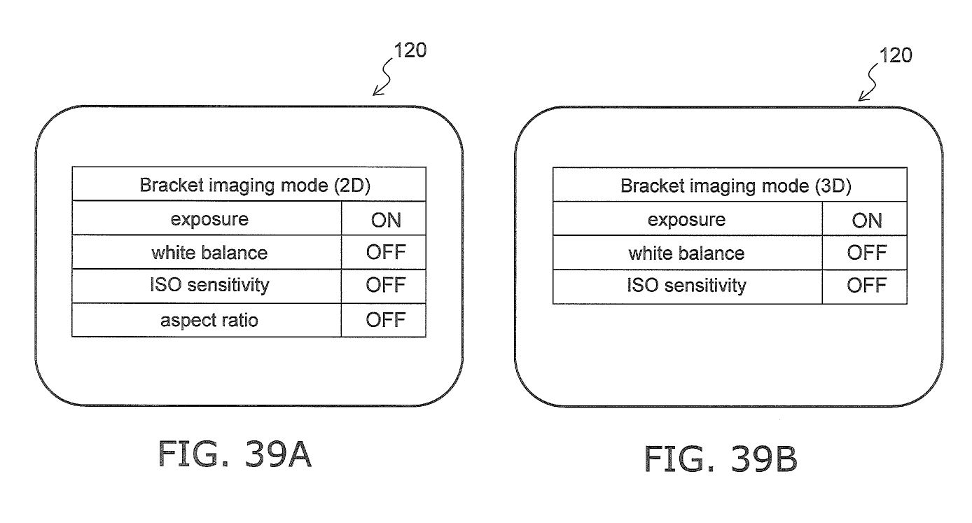

(G) In the above embodiment, as shown in FIGS. 28B and 29B, the functions whose use was restricted in three-dimensional imaging mode were grayed out in display, but as shown in FIGS. 38B and 39B, a constitution is also possible in which functions whose use is restricted are not displayed on the display section. In this case, the functions whose use is restricted are included in the first sequential capture menu information 426A, but are excluded from the second sequential capture menu information 426B. With the menu screen shown in FIGS. 38B and 39B, functions whose use is restricted are just not displayed on the menu screen, but along with not displaying these functions, the layout of the functions displayed on one screen may also be modified.

A situation is also possible in which the menu screen is not changed between two-dimensional imaging and three-dimensional imaging. In this case, the menu screen is the same in two-dimensional imaging and three-dimensional imaging, but the user may be prevented from selecting certain functions during three-dimensional imaging. More specifically, the system may be designed so that even if the above-mentioned super-high speed sequential capture function and aspect bracket imaging function are displayed on a menu screen as shown in FIGS. 38A and 39A, the user cannot select these functions in three-dimensional imaging mode. For example, the system may be designed so that if the user should select these functions, that operation is not accepted.

FIGS. 38A and 39A correspond to FIGS. 28A and 29A.

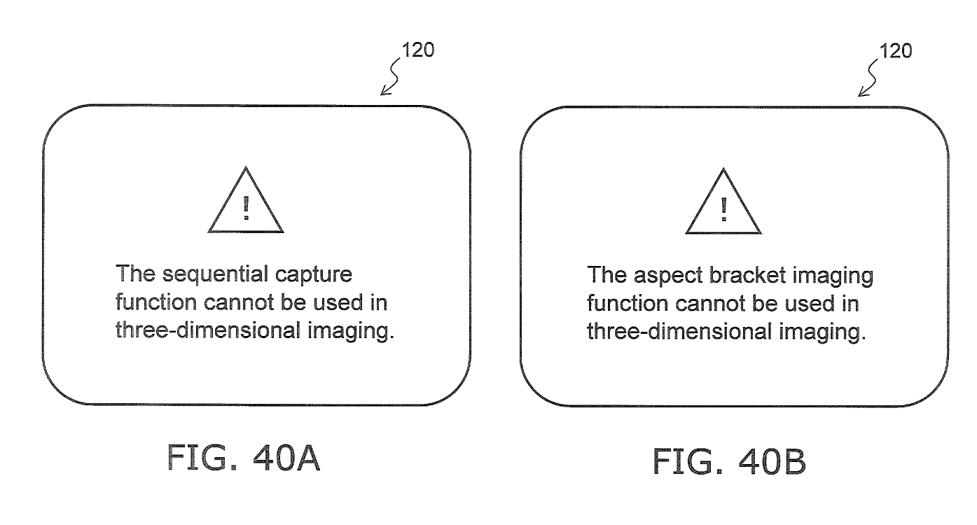

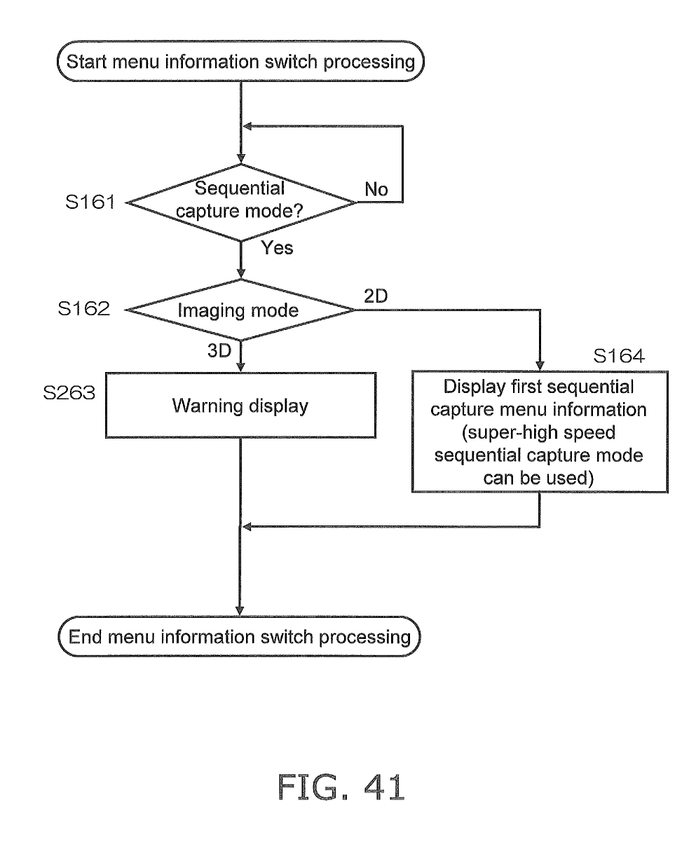

(H) If the user attempts to select a function whose use is restricted, a warning may be displayed on the camera monitor 120 or the electronic viewfinder 180. For example, if the use of all sequential capture functions (low, medium, high, and super-high speeds) is restricted during three-dimensional imaging, then when the user has selected a sequential capture mode with the imaging selection lever 437 during three-dimensional imaging, the warning shown in FIG. 40A may be displayed on the camera monitor 120 or the electronic viewfinder 180 (step S263 in FIG. 41, for example). This allows the user to quickly recognize that the use of a sequential capture function is restricted.

Also, if the use of all bracket imaging functions (exposure, white balance, ISO sensitivity, and aspect ratio) is restricted during three-dimensional imaging, then when the user has selected the bracket imaging mode with the imaging selection lever 437 during three-dimensional imaging, the warning shown in FIG. 40B may be displayed on the camera monitor 120 or the electronic viewfinder 180. This allows the user to quickly recognize that the use of a the bracket imaging function is restricted.

Addition

The camera body 400 according to the second embodiment above can also be expressed as follows.

(1) A camera body according to a first aspect is a camera body to which an interchangeable lens unit can be mounted, the camera body comprising:

a body mount to which the interchangeable lens unit can be mounted;

an identification information acquisition section with which lens identification information indicating whether or not the interchangeable lens unit is compatible with three-dimensional imaging can be acquired from the interchangeable lens unit mounted to the body mount;

a camera-side determination section that determines whether or not the interchangeable lens unit mounted to the body mount is compatible with three-dimensional imaging on the basis of the lens identification information; and

a function restrictor that restricts in three-dimensional imaging the use of one or more imaging functions with which a plurality of images can be obtained all at once, when the camera-side determination section has determined that the interchangeable lens unit is compatible with three-dimensional imaging.

(2) A camera body according to a second aspect is the camera body according to the first aspect, further comprising

a manipulation unit for accepting the input of manipulation information, wherein the function restrictor restricts the use of the imaging functions in three-dimensional imaging regardless of the manipulation information inputted to the manipulation unit.

(3) A camera body according to a third aspect is the camera body according to the second aspect, wherein

the one or more imaging functions include one or more sequential capture functions with which a plurality of images can be acquired all at once at a specific frame rate.

(4) A camera body according to a fourth aspect is the camera body according to the third aspect, wherein

the one or more sequential capture functions have a first sequential capture function and a second sequential capture function having a different sequential capture rate from that of the first sequential capture function, and

the function restrictor restricts the use of at least the second sequential capture function when the camera-side determination section has determined that the interchangeable lens unit is compatible with three-dimensional imaging.

(5) A camera body according to a fifth aspect is the camera body according to the fourth aspect, wherein

the first sequential capture function is a sequential capture function that makes use of a mechanical shutter, and

the second sequential capture function is a sequential capture function that makes use of an electronic shutter.

(6) A camera body according to a sixth aspect is the camera body according to the fourth or fifth aspect, wherein

the sequential capture rate of the second sequential capture function is higher than the sequential capture rate of the first sequential capture function.

(7) A camera body according to a seventh aspect is the camera body according to any of the first to sixth aspects, further comprising

an image production section that produces image data on the basis of an optical image formed by the interchangeable lens unit, and

a display section that displays the image data, wherein

the function restrictor has a sequential capture menu setting section for setting a menu screen displayed on the display section, and

the sequential capture menu setting section has first sequential capture menu information showing a list of functions that can be used in two-dimensional imaging and second sequential capture menu information showing a list of functions that can be used in three-dimensional imaging.

(8) A camera body according to an eighth aspect is the camera body according to the seventh aspect, wherein,

if the camera-side determination section has determined that the interchangeable lens unit is compatible with three-dimensional imaging, the sequential capture menu setting section selects the second sequential capture menu information as the menu screen displayed on the display section on the basis of the determination result of the camera-side determination section, and

if the camera-side determination section has determined that the interchangeable lens unit is not compatible with three-dimensional imaging, the sequential capture menu setting section selects the first sequential capture menu information as the menu screen displayed on the display section on the basis of the determination result of the camera-side determination section.

(9) A camera body according to a ninth aspect is the camera body according to the seventh or eighth aspect, wherein

the first and second sequential capture menu information are included in the imaging functions, and

when the second sequential capture menu information is displayed on the display section, the imaging functions are displayed on the display section but cannot be selected by the user.

(10) A camera body according to a tenth aspect is the camera body according to the eighth aspect, wherein,

when the second sequential capture menu information is displayed on the display section, the imaging functions are displayed in a different color from that of the other sequential capture functions included in the second sequential capture menu information.

(11) A camera body according to an eleventh aspect is the camera body according to the seventh aspect, wherein

the imaging functions are included in the first sequential capture menu information, but excluded from the second sequential capture menu information.

(12) A camera body according to a twelfth aspect is the camera body according to the eleventh aspect, wherein,

when the second sequential capture menu information is displayed on the display section, the imaging functions are not displayed on the display section.

(13) A camera body according to a thirteenth aspect is the camera body according to any of the first to twelfth aspects, wherein

the one or more imaging functions include an aspect bracket imaging function with which a plurality of images having different aspect ratios can be acquired all at once.

(14) A camera body according to a fourteenth aspect is the camera body according to any of the first to thirteenth aspects, wherein

the function restrictor has a bracket menu setting section for setting the menu screen displayed on the display section, and

the bracket menu setting section has first bracket menu information that gives a list of bracket imaging functions for two-dimensional imaging, and second bracket menu information that gives a list of bracket imaging functions for three-dimensional imaging.

(15) A camera body according to a fifteenth aspect is the camera body according to the fourteenth aspect, wherein,

if the camera-side determination section has determined that the interchangeable lens unit is compatible with three-dimensional imaging, the bracket menu setting section selects the second bracket menu information as the menu screen to be displayed on the display section, on the basis of the determination result of the camera-side determination section, and

if the camera-side determination section has determined that the interchangeable lens unit is not compatible with three-dimensional imaging, the bracket menu setting section selects the first bracket menu information as the menu screen to be displayed on the display section, on the basis of the determination result of the camera-side determination section.

(16) A camera body according to a sixteenth aspect is the camera body according to the fourteenth or fifteenth aspect, wherein

the imaging functions are included in the first and second bracket menu information, and

when the second bracket menu information is displayed on the display section, the imaging functions are displayed on the display section, but cannot be selected by the user.

(17) A camera body according to a seventeenth aspect is the camera body according to the sixteenth aspect, wherein,

when the second bracket menu information is displayed on the display section, the imaging functions are displayed in a different color from that of the other functions included in the second bracket menu information.

(18) A camera body according to an eighteenth aspect is the camera body according to the fourteenth aspect, wherein

the imaging functions are included in the first bracket menu information, and are excluded from the second bracket menu information.

(19) A camera body according to a nineteenth aspect is the camera body according to the eighteenth aspect, wherein,

when the second bracket menu information is displayed on the display section, the imaging functions are not displayed on the display section.

(20) A imaging device according to a twentieth aspect comprises:

an interchangeable lens unit; and

the camera body according to any of the first to nineteenth aspects.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

The term “imaging function” as used here can include functions that can be used in one or more situations before, during, or after imaging. Therefore, the phrase “one or more imaging functions that can be used in two-dimensional imaging” means a function that can be used before, during, and after two-dimensional imaging.

The term “imaging function” as used here can include functions that can be used in one or more situations before, during, or after imaging. Therefore, the phrase “one or more imaging functions that can be used in two-dimensional imaging” means a function that can be used before, during, and after two-dimensional imaging.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

### General Interpretation of Terms

In understanding the scope of the present disclosure, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

The term “configured” as used herein to describe a component, section, or part of a device implies the existence of other unclaimed or unmentioned components, sections, members or parts of the device to carry out a desired function.

The terms of degree such as “substantially”, “about” and “approximately” as used herein mean a reasonable amount of deviation of the modified term such that the end result is not significantly changed.

The term “imaging function” as used here can include functions that can be used in one or more situations before, during, or after imaging. Therefore, the phrase “one or more imaging functions that can be used in two-dimensional imaging” means a function that can be used before, during, and after two-dimensional imaging.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A camera body comprising:
a body mount configured to support an interchangeable lens unit;
an identification information acquisition section configured to acquire lens identification information from the interchangeable lens unit, the lens identification information indicating whether the interchangeable lens unit is compatible with three-dimensional imaging;
a camera-side determination section configured to determine whether the interchangeable lens unit is compatible with three-dimensional imaging based on the lens identification information acquired by the identification information acquisition section; and
a function restrictor configured to restrict in three-dimensional imaging the use of one or more imaging functions used in two-dimensional imaging when the camera-side determination section has determined that the interchangeable lens unit is compatible with three-dimensional imaging.

2. The camera body according to claim 1, further comprising:
an image production section configured to produce image data based on an optical image formed by the interchangeable lens unit; and
a display section configured to display the image data, wherein
the function restrictor includes a menu setting section configured to display a menu screen on the display section, the menu setting section having first menu information that displays a list of functions used in two-dimensional imaging and second menu information that displays a list of functions used in three-dimensional imaging.

3. The camera body according to claim 2, wherein
if the camera-side determination section has determined that the interchangeable lens unit is compatible with three-dimensional imaging, then the menu setting section selects the second menu information as the menu screen displayed on the display section, and
if the camera-side determination section has determined that the interchangeable lens unit is not compatible with three-dimensional imaging, then the menu setting section selects the first menu information as the menu screen displayed on the display section.

4. The camera body according to claim 2, wherein
the one or more imaging functions used in two-dimensional imaging are included in the first and second menu information, and
when the second menu information is displayed on the display section, the imaging functions are displayed on the display section, but cannot be selected by the user.

5. The camera body according to claim 4, wherein
when the second menu information is displayed on the display section, the imaging functions are displayed in a different color from that of other functions included in the second menu information.

6. The camera body according to claim 2, wherein
the one or more imaging functions used in two-dimensional imaging are included in the first menu information but excluded from the second menu information.

7. The camera body according to claim 6, wherein
when the second menu information is displayed on the display section, the imaging functions are not displayed on the display section.

8. The camera body according to claim 1, wherein
the imaging functions include at least one of a digital zoom function and a tele conversion function, the digital zoom function being configured to extract and enlarge a partial region out of the image data, and the tele conversion function being configured to extract a partial region out of the image data.

9. An imaging device comprising:
an interchangeable lens unit; and
the camera body according to claim 1.

10. A method for controlling a camera body comprising:
acquiring lens identification information from an interchangeable lens unit mounted to the camera body using an identification information acquisition section coupled to the camera body, the lens identification information indicating whether the interchangeable lens unit is compatible with three-dimensional imaging;
determining whether the interchangeable lens unit is compatible with three-dimensional imaging using a camera-side determination section coupled to the camera body and using the lens identification information acquired by the identification information acquisition section; and
restricting in three-dimensional imaging the use of one or more imaging functions used in two-dimensional imaging via a function restrictor coupled to the camera body when the camera-side determination section has determined that the interchangeable lens unit is compatible with three-dimensional imaging.

11. A program configured to cause a camera body to execute the processes of:
acquiring lens identification information from an interchangeable lens unit mounted to the camera body using an identification information acquisition section coupled to the camera body, the lens identification information indicating whether the interchangeable lens unit is compatible with three-dimensional imaging;
determining whether the interchangeable lens unit is compatible with three-dimensional imaging using a camera-side determination section coupled to the camera body and using the lens identification information acquired by the identification information acquisition section; and
restricting in three-dimensional imaging the use of one or more imaging functions used in two-dimensional imaging via a function restrictor coupled to the camera body when the camera-side determination section has determined that the interchangeable lens unit is compatible with three-dimensional imaging.

12. A computer-readable storage medium having a computer-readable program stored thereon, the computer-readable storage medium being coupled to a camera body to cause the camera body to perform the processes of:
acquiring lens identification information from an interchangeable lens unit mounted to the camera body using an identification information acquisition section coupled to the camera body, the lens identification information indicating whether the interchangeable lens unit is compatible with three-dimensional imaging;
determining whether the interchangeable lens unit is compatible with three-dimensional imaging using a camera-side determination section coupled to the camera body and using the lens identification information acquired by the identification information acquisition section; and
restricting in three-dimensional imaging the use of one or more imaging functions used in two-dimensional imaging via a function restrictor coupled to the camera body when the camera-side determination section has determined that the interchangeable lens unit is compatible with three-dimensional imaging.

13. The computer-readable storage medium according to claim 12, wherein the computer-readable storage medium is a removable disk drive.

14. The computer-readable storage medium according to claim 12, wherein the computer-readable storage medium is a hard disk drive.
